(19) United States
(12) Patent Application Publication
(10) Pub. No.: US 2008/0140749 A1
(43) Pub. Date: Jun. 12, 2008

(54) Method and device for performing a quantum algorithm to simulate a genetic algorithm

(75) Inventors: Paolo Amato, Limbiate (IT); Domenico Massimilano Porto, Catania (IT); Marco Branciforte, Catania (IT); Antonino Calabro, Villa San Giovanni (IT); Sergei Viktorovitch Ulyanov, Hamamatsu (JP); Kazuki Takahashi, Hamamatsu (JP); Sergey Alexandrovich Panfilov, Iwata (JP); Ilya Sergeevitch Ulyanov, Moscow (RU); Liudmila Vasilievna Litvintseva, Hamamatsu (JP)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignees: STMicroelectronics S.r.l., Agrate Brianza (IT); Yamaha Motor Co., Ltd., Iwata-shi (JP)

(21) Appl. No.: 11/313,077

(22) Filed: Dec. 20, 2005

(30) Foreign Application Priority Data
Dec. 20, 2004 (EP) 04106715.8

(51) Int. Cl. G06F 7/38

(52) U.S. Cl. 708/490

(57) ABSTRACT

A method and device for performing a quantum algorithm where the superposition, entanglement with interference operators determined for performing selection, crossover, and mutation operations based upon a genetic algorithm. Moreover, entanglement vectors generated by the entanglement operator of the quantum algorithm may be processed by a wise controller implementing a genetic algorithm before being input to the interference operator. This algorithm may be implemented with a hardware quantum gate or with a software computer program running on a computer. Further, the algorithm can be used in a method for controlling a process and a relative control device of a process which is more robust, requires very little initial information about dynamic behavior of control objects in the design process of an intelligent control system, or random noise insensitive (invariant) in a measurement system and in a control feedback loop.

### FIELD OF THE INVENTION

The invention relates to quantum algorithms and genetic algorithms, and more precisely, to a method of performing a quantum algorithm for simulating a genetic algorithm, a relative hardware quantum gate and a relative genetic algorithm, and a method of designing quantum gates.

### BACKGROUND OF THE INVENTION

Computation, based on the laws of classical physics, leads to different constraints on information processing than computation based on quantum mechanics. Quantum computers promise to address many intractable problems, but, unfortunately, no algorithms for “programming” a quantum computer currently exist. Calculation in a quantum computer, like calculation in a conventional computer, can be described as a marriage of quantum hardware (the physical embodiment of the computing machine itself, such as quantum gates and the like), and quantum software (the computing algorithm implemented by the hardware to perform the calculation). To date, quantum software algorithms, such as Shor's algorithm, used to address problems on a quantum computer have been developed on an ad hoc basis without any real structure or programming methodology.

This situation is somewhat analogous to attempting to design a conventional logic circuit without the use of a Karnaugh map. A logic designer, given a set of inputs and corresponding desired outputs, could design a complicated logic circuit using NAND gates without the use of a Karnaugh map. However, the unfortunate designer would be forced to design the logic circuit more or less by intuition, and trial and error. The Karnaugh map provides a structure and an algorithm for manipulating logical operations (AND, OR, etc.) in a manner that allows a designer to quickly design a logic circuit that will perform a desired logic calculation.

The lack of a programming or program design methodology for quantum computers severely limits the usefulness of the quantum computer. Moreover, it limits the usefulness of the quantum principles, such as superposition, entanglement, and interference that give rise to the quantum logic used in quantum computations. These quantum principles suggest, or lend themselves, to problem-solving methods that are not typically used in conventional computers.

These quantum principles can be used with conventional computers in much the same way that genetic principles of evolution are used in genetic optimizers today. Nature, through the process of evolution, has devised a useful method for optimizing large-scale nonlinear systems. A genetic optimizer running on a computer efficiently addresses many previously difficult optimization problems by simulating the process of natural evolution.

Nature also uses the principles of quantum mechanics to solve problems, including optimization-type problems, searching-type problems, selection-type problems, etc. through the use of quantum logic. However, the quantum principles, and quantum logic, have not been used with conventional computers because no method existed for programming an algorithm using the quantum logic.

Quantum algorithms are also used in quantum soft computing algorithms for controlling a process. The documents WO 01/67186; WO 2004/012139; U.S. Pat. No. 6,578,018; and U.S. 2004/0024750 disclose methods for controlling a process, in particular for optimizing a shock absorber or for controlling an internal combustion engine.

In particular, the documents U.S. Pat. No. 6,578,018 and WO 01/67186 disclose methods that use quantum algorithms and genetic algorithms for training a neural network that control a fuzzy controller which generates a parameter setting signal for a classical PID controller of the process. The quantum algorithms implemented in these methods process a teaching signal generated with a genetic algorithm, and provide it to the neural network to be trained.

Actually, quantum algorithms and genetic algorithms are used as substantially separate entities in these control methods. It would be desirable to have an algorithm obtained as a merging of quantum algorithms and genetic algorithms in order to have the advantage of both the quantum computing and GAs parallelism, as the partial components of general Quantum Evolutionary Programming.

### SUMMARY OF THE INVENTION

A Quantum Genetic Algorithm (QGA) for merging genetic algorithms and quantum algorithms is provided. QGA (as the component of general Quantum Evolutionary Programming) starts from this idea, which can take advantage of both quantum computing and GAs paradigms.

The general idea is to explore the quantum effects of superposition and entanglement operators to possibly create a generalized coherent state with the increased diversity of quantum population that store individuals and their fitness of successful solutions. Using the complementarity between entanglement and interference operators with a quantum searching process (based on interference and measurement operators) successful solutions from a designed state may be extracted. In particular, a major advantage for a QGA may comprise using the increased diversity of a quantum population (due to superposition of possible solutions) in optimal searching of successful solutions in a non-linear stochastic optimization problem for control objects with uncertainty/fuzzy dynamic behavior.

It is an object of the invention to provide a method for performing a quantum algorithm. A difference between this method and other well known quantum algorithms may include that the superposition, entanglement and interference operators are determined for performing selection, crossover and mutation operations according to a genetic algorithm. Moreover, entanglement vectors generated by the entanglement operator of the quantum algorithm may be processed by a wise controller implementing a genetic algorithm, before being input to the interference operator.

This algorithm may be easily implemented with a hardware quantum gate or with a software computer program running on a computer. Moreover, it may be used in a method for controlling a process and a relative control device of a process which is more robust, requires very little initial information about dynamic behavior of control objects in design process of intelligent control system, or random noise insensitive (invariant) in a measurement system and in a control feedback loop.

Another innovative aspect of this invention may comprise a method of performing a genetic algorithm, wherein the selection, crossover and mutation operations are performed by the quantum algorithm or means of the quantum algorithm of this invention.

According to another innovative aspect of this invention, a method of designing quantum gates may be provided. The method may provide a standard procedure to be followed for designing quantum gates. By following this procedures it may be easy to understand how basic gates, such as the well known two-qubits gates for performing a Hadamard rotation or an identity transformation, may be coupled together to realize a hardware quantum gate for classically performing a desired quantum algorithm.

One embodiment may include a software system and method for designing quantum gates. The quantum gates may be used in a quantum computer or a simulation of a quantum computer. In one embodiment, a quantum gate may be used in a global optimization of Knowledge Base (KB) structures of intelligent control systems that may be based on quantum computing and on a quantum genetic search algorithm (QGSA). In another embodiment, an efficient quantum simulation system may be used to simulate a quantum computer for optimization of intelligent control system structures based on quantum soft computing.

### BRIEF DESCRIPTION OF THE DRAWINGS

The different aspects and advantages of this invention may be even more evident through a detailed description referring to the attached drawings, wherein:

FIG. 1 shows a prior art structure of a quantum control system;

FIG. 2 shows a general structure of self organizing intelligent control system in accordance with the invention based on quantum soft computing;

FIG. 3 illustrates another embodiment of the SSCQ shown in FIG. 2;

FIG. 4 is a schematic block diagram of the intelligent QSA wise control system 2000 of FIG. 3;

FIG. 5 shows one embodiment of structure for QA simulation software in accordance with the invention;

FIG. 6 summarizes the method of designing quantum gates in accordance with the invention;

FIG. 7 shows how to encode bit strings to be processed with the quantum genetic algorithm in accordance with the invention;

FIG. 8 shows a crossover operation on the bit strings encoded as shown in FIG. 7;

FIG. 9 shows how to perform a mutation operation on the bit strings encoded as shown in FIG. 7;

FIG. 10 is a basic scheme of Quantum Algorithms in accordance with the invention;

FIG. 11 is a sample quantum circuit in accordance with the invention;

FIG. 12 is a flowchart of Quantum Algorithms in accordance with the invention;

FIG. 13 illustrates an exemplary structure of a quantum block in accordance with the invention;

FIGS. 14 and 15 show logic circuits for calculating components of a vector rotated with a Hadamard rotation in accordance with the invention;

FIGS. 16 and 17 show logic circuits for performing tensor products in accordance with the invention;

FIG. 18 illustrates the effect of any entanglement operator in accordance with the invention;

FIG. 19 depicts a PROM matrix for performing entanglement operations in accordance with the invention;

FIG. 20 defines the problem solved by the Deutsch-Jozsa's quantum algorithm in accordance with the invention;

FIG. 21 defines the process steps for designing a quantum gate performing the Deutsch-Jozsa's quantum algorithm in accordance with the invention;

FIG. 22a-22d illustrates how to design a quantum gate for performing the Deutsch-Jozsa's algorithm in accordance with the invention;

FIGS. 23 to 27 show five quantum circuits according to the Deutsch-Jozsa's quantum algorithm for a constant function with value 1 in accordance with the invention;

FIG. 28 shows the final quantum circuit according to the Deutsch-Jozsa's quantum algorithm for a constant function with value 0 in accordance with the invention;

FIG. 29 is a magnified view of the circuit in FIG. 22c;

FIG. 30 shows a Deutsch-Jozsa's quantum gate in accordance with the invention;

FIGS. 31a to 31d illustrate sample probability amplitudes in a Deutsch-Jozsa's algorithm in accordance with the invention;

FIG. 32 shows the initial constant function encoding of the Deutsch-Jozsa's quantum algorithm in accordance with the invention;

FIG. 33 shows the initial balanced function encoding of the Deutsch-Jozsa's quantum algorithm in accordance with the invention;

FIG. 34 shows the step of preparation for the superposition operator in a Deutsch-Jozsa's quantum algorithm in accordance with the invention;

FIGS. 35 to 38 show the step of preparation of the entanglement operator in a Deutsch-Jozsa's quantum algorithm in accordance with the invention;

FIG. 39 shows the step of preparation of the interference operator in a Deutsch-Jozsa's quantum algorithm in accordance with the invention;

FIG. 40 shows the superposition and interference operators in a Deutsch-Jozsa's quantum algorithm in accordance with the invention;

FIG. 41 described the quantum gates for the Deutsch-Jozsa's quantum algorithm in accordance with the invention;

FIG. 42 illustrates the execution of the Deutsch-Jozsa's quantum algorithm for constant functions in accordance with the invention;

FIG. 43 illustrates the execution of the Deutsch-Jozsa's quantum algorithm for balanced functions in accordance with the invention;

FIG. 44 illustrates the interpretation of results of the Deutsch-Jozsa's quantum algorithm in accordance with the invention;

FIG. 45 shows XOR gates implementing Deutsch-Jozsa's entanglement in accordance with the invention;

FIG. 46 illustrates the problem addressed by the prior art Shor's quantum algorithm;

FIG. 47 shows the process steps for designing a Shor's quantum gate in accordance with the invention;

FIG. 48 illustrates schematically how to design a quantum gate for performing the Shor's algorithm in accordance with the invention;

FIG. 49 shows the preparation of the superposition operator of the Shor's algorithm in accordance with the invention;

FIG. 50 shows the preparation of the entanglement operator of the Shor's algorithm in accordance with the invention;

FIG. 51 shows the real and imaginary parts of the interference operator of the Shor's quantum algorithm in accordance with the invention;

FIG. 52 shows the amplitude and phase of the interference operator of the Shor's quantum algorithm in accordance with the invention;

FIG. 53 shows the real and imaginary parts of the Shor's quantum gate with a single iteration in accordance with the invention;

FIG. 54 shows the amplitude and phase of the Shor's quantum gate with a single iteration in accordance with the invention;

FIG. 55 shows the real and imaginary parts of the Shor's quantum gate with two iterations in accordance with the invention;

FIG. 56 shows the real and imaginary parts of the Shor's quantum gate with three iterations in accordance with the invention;

FIG. 57 illustrates the problem addressed by the prior art Grover's quantum algorithm;

FIG. 58 shows the process steps for designing a Grover's quantum gate in accordance with the invention;

FIG. 59 illustrates schematically how to design a quantum gate for performing the Grover's algorithm in accordance with the invention;

FIG. 60 shows the initial constant function encoding of the Grover's quantum algorithm in accordance with the invention;

FIG. 61 shows the initial balanced function encoding of the Grover's quantum algorithm in accordance with the invention;

FIG. 62 shows the step of preparation of the superposition operator in a Grover's quantum algorithm in accordance with the invention;

FIG. 63 show the step of preparation of the entanglement operator in a Grover's quantum algorithm with a single iteration in accordance with the invention;

FIG. 64 show the step of preparation of the entanglement operator in a Grover's quantum algorithm with two and three iterations in accordance with the invention;

FIG. 65 shows the step of preparation of the interference operator in a Grover's quantum algorithm in accordance with the invention;

FIG. 66 shows the superposition and interference operators in a Grover's quantum algorithm in accordance with the invention;

FIG. 67 shows XOR gates implementing Grover's entanglement in accordance with the invention.

FIG. 68a illustrates the result interpretation step in a Grover's quantum algorithm in accordance with the invention;

FIG. 68b shows sample results of the Grover's quantum algorithm in accordance with the invention;

FIG. 68c shows a general scheme of a hardware for performing the Grover's quantum algorithm in accordance with the invention;

FIG. 69 shows a hardware prototype for performing the Grover's quantum algorithm in accordance with the invention;

FIGS. 70 to 75 shows the evolution of the probability of finding an element in a database using the hardware prototyped FIG. 69; and

FIG. 76 summarizes the probability evolution of FIGS. 70 to 75.

### DETAILED DESCRIPTION OF THE PREFERRED EMBODIMENTS

A new approach in intelligent control system design is considered using a global optimization problem (GOP) approach based on a quantum soft computing optimizer. This approach is the background for hardware (HW) design of a QGA. In order to better explain the various aspects of this invention, the ensuing description is organized in chapters.

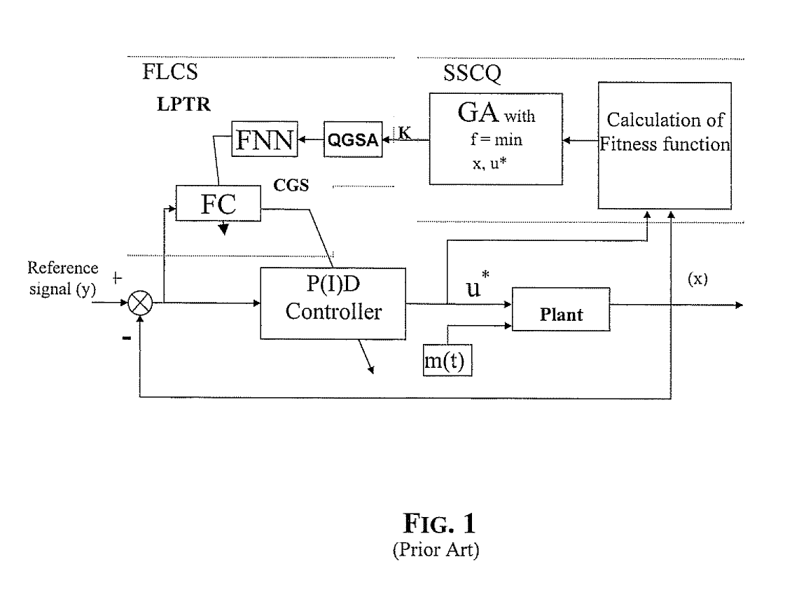

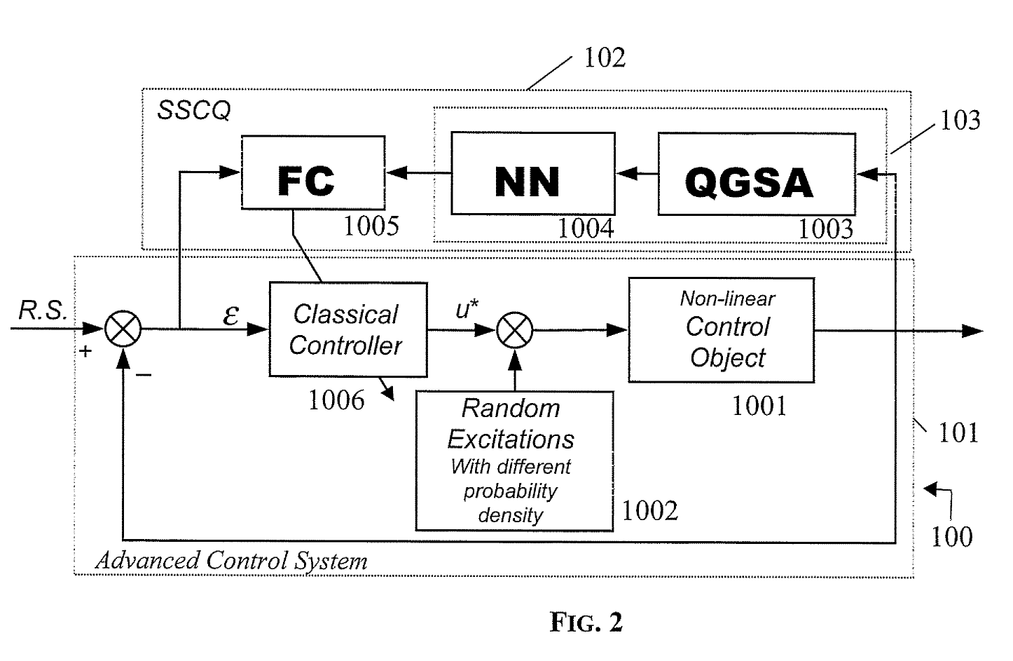

1. OVERVIEW OF INTELLIGENT CONTROL SYSTEM BASED ON QUANTUM SOFT COMPUTING FIG. 1 shows the structure of intelligent control system based on quantum soft computing described in patents U.S. Pat. No. 6,578,018 B1 and in the document WO 01/67186 A1. FIG. 2 shows an intelligent control system 100 based on quantum soft computing that includes a Simulation System of Control Quality (SSCQ) 102 and an Advanced Control System 101. The SSCQ 102 includes a Quantum Soft Computing Optimizer (QSCO) 103. The QSCO 103 includes a Quantum Genetic Search Algorithm 1003 that provides a teaching signal to a Neural Network (NN) 1004. Control information from the NN 1004 is provided to a Fuzzy Controller (FC) 1005. The SSCQ 102 provides a simulation system of control laws of coefficient gains for a classical controller 1006 in the advanced control system 101. The QGSA 1003 provides an optimization process based on quantum soft computing. The QGSA 1003 can be implemented on a quantum computer or simulated as described below using classical efficient simulation methods of quantum algorithms (QA's) on computers with classical (von Neumann) architecture.

Structure of quantum genetic search algorithm The mathematical structure of the QGSA 1003 can be described as a logical set of operations:

$$QGSA = \{ C , Ev , {P}^{0} , L , \underbrace{Ω , χ , μ}_{GA \text{-} operators} , \underbrace{Sup , Ent , Int}_{QA \text{-} operators} , \} \qquad ( 1 )$$

where C is the genetic coding scheme of individuals for a given problem; Ev is the evaluation function to compute the fitness values of individuals; P⁰ is the initial population; L is the size of the population; Ω is the selection operator; χ is the crossover operator; μ is the mutation operator; Sup is the quantum linear superposition operator; Ent is the quantum entanglement operator (quantum super-correlation); Int is the interference operator. The operator Λ represents termination conditions that include the stopping criteria as a minimum of Shannon/von Neumann entropy, the optimum of the fitness functions, and/or minimum risk. Structure of Quantum Evolutionary Programming is a partial case of Eq. (1) and briefly is described hereinafter in chapter 3 about Quantum Evolutionary Programming (QEP).

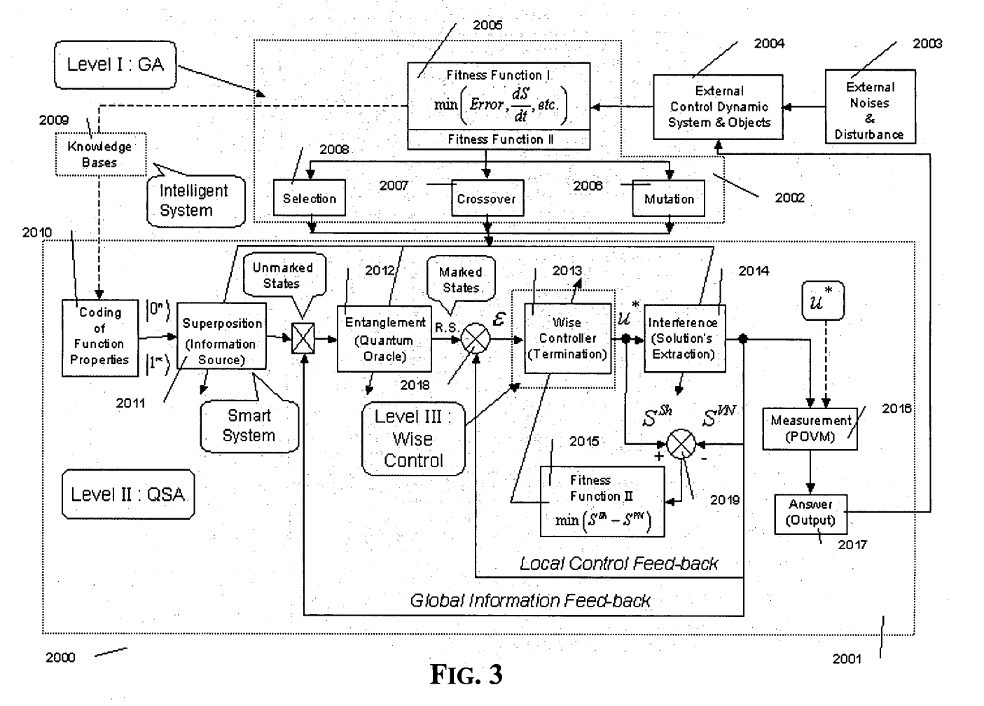

FIG. 3 is a block diagram of one embodiment of the QGSA 1003 as a QGSA 2000 that provides global optimization of a KB of an intelligent smart control systems based on quantum computing. The structure of the QGSA 2000 shown in FIG. 3 can be described as a logical set of operations from Eq. (1). Logical combinations of operators from Eq. (1) represent different models of QGSA. According to Eq. (1), the QGSA 1003 (and thus the QGSA 2000) is realized using the three genetic algorithm operations of selection-reproduction, crossover, and mutation, and the three quantum search algorithm operations of superposition, entanglement and interference.

On control physical level, in the system 2000, a disturbance block 2003 produces external disturbances (e.g., noise) on a control object model 2004 (the model 2004 includes a model of the controlled object). An output of the model block 2004 is the response of the controlled object and is provided to an input of a GA block 2002.

The GA block 2002 includes GA operators (mutation in a mutation block 2006, crossover in a crossover block 2007 and selection in a selection block 2008) and two fitness functions: a Fitness Function I 2005 for the GA; and a Fitness Function II 2015 for a wise controller 2013 of QSA (Quantum Search Algorithm) termination. Output of the GA block 2002 is input for a KB block 2009 that represents the Knowledge Bases of fuzzy controllers for different types of external excitations from block 2003. An output of block 2009 is provided to a coding block 2010 that provides coding of function properties in look-up tables of fuzzy controllers.

Thus, outputs from the coding block 2010 are provided to a superposition block 2011. An output of the superposition block 2011 (after applying the superposition operator) represents a joint Knowledge Base for fuzzy control. The output from the superposition block 2011 is provided to an entanglement block 2012 that realizes the entanglement operator and chooses marked states using an oracle model. An output of the entanglement block 2012 includes marked states that are provided to a comparator 2018. The output of the comparator 2018 is an error signal that is provided to the wise controller 2013. The wise controller 2013 solves the termination problem of the QSA. Output from the wise controller 2013 is provided to an interference block 2014 that describes the interference operator of the QSA. The interference block 2014 extracts the solutions. Outputs of the wise controller 2013 and the interference block 2014 are used to calculate the corresponding values of Shannon and von Neumann entropies.

The differences of Shannon and von Neumann entropies are calculated by a comparator 2019 and provided to the Fitness Function II 2015. The wise controller 2013 provides an optimal signal for termination of the QSA with measurement in a measurement block 2016 with “good” solutions as answers in an output of Block 2017.

On gate level, in the QGSA 2000, a superposition block 2011 provides a superposition of classical states to an entanglement block 2012. The entanglement block 2012 provides the entangled states to an interference block 2014. In one embodiment, the interference block 2014 uses a Quantum Fast Fourier Transform (QFFT) to generate interference. The interference block 2014 provides transformed states to a measurement and observation/decision block 2013 as wise controller. The observation block 2013 provides observations (control signal u*) to a measurement block 2016. The observation/decision block 2013 includes a fitness function to configure the interference provided in the interference block 2014. Decision data from the decision block 2013 is decoded in a decoding block 2017 and using stopping information criteria 2015, a decision regarding the termination of the algorithm is made. If the algorithm does not terminate, then decision data are provided to the superposition block 2011 to generate a new superposition of states.

Therefore, the superposition block 2011 creates a superposition of states from classical states obtained from the soft computing simulation. The entanglement block 2012 creates entanglement states controlled by the GA 2002. The interference block 2014 applies the interference operations described by the fitness function in the decision block 2005. The decision block 2013 and the stopping information block 2015 determine the QA's stopping problem based on criteria of minimum Shannon/Von Neumann entropy. An example of how the GA 2002 modifies the superposition, entanglement and interference operators, as schematically represented in FIG. 3 is shown.

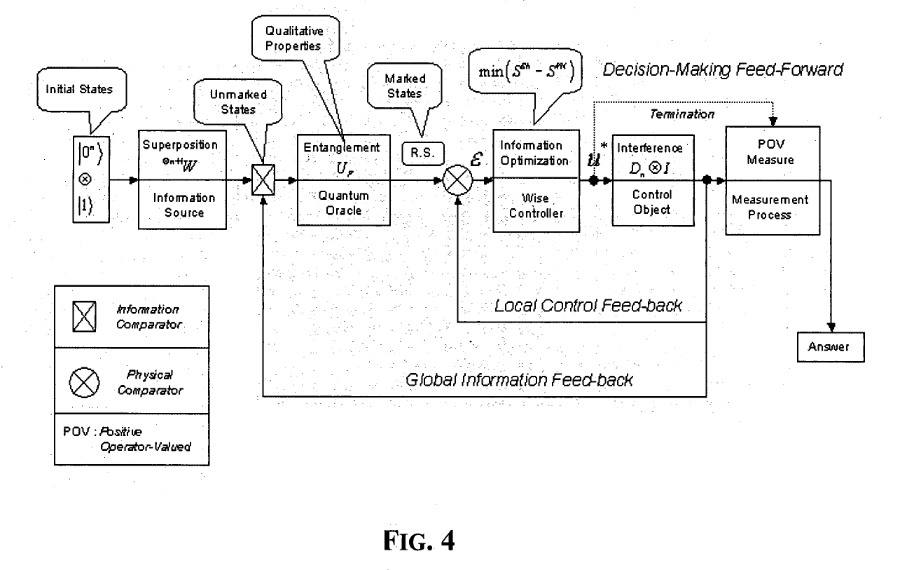

The following chapter 3 illustrates how the GA controls the execution of each operation of the quantum search algorithm in practical cases. FIG. 4 shows a self-organized structure of an intelligent QSA wise control system 2000 based on a QSA 2001. This structure is used below for HW-gate design of quantum search algorithms.

A general Quantum Algorithm (QA), written as a Quantum Circuit, can be automatically translated into the corresponding Programmable Quantum Gate for efficient classical simulation of an intelligent control system based on Quantum (Soft) Computing. This gate is represented as a quantum operator in matrix form such that, when it is applied to the vector input representation of the quantum register state, the result is the vector representation of the desired register output state.

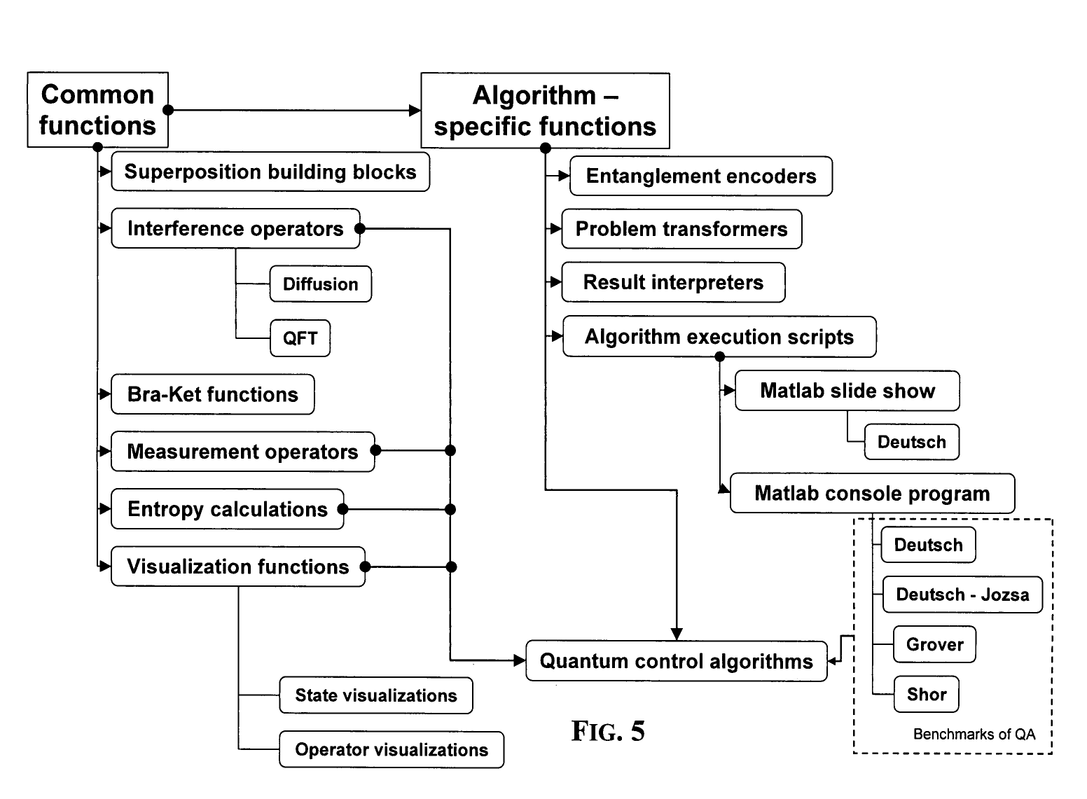

FIG. 5 shows one embodiment of the structure of QAG simulation software. The simulation system of quantum computation is based on quantum algorithm gates (QAG). The design process of QAG includes the matrix design form of three quantum operators: superposition (Sup), entanglement (U_{F}) and interference (Int).

In general form, the structure of a QAG can be described as follows:

QAG=[(Int [symbol] ⁿI)·U_{F}]^{h+1}·[ⁿH [symbol] ^{m}S] (2)

where I is the identity operator; the symbol [symbol] denotes the tensor product; S is equal to I or H and dependent on the problem description. One portion of the design process in Eq. (2) is the type-choice of the entanglement problem-dependent operator U_{F} that physically describes the qualitative properties of the function ƒ (such as, for example, the FC-KB in a QSC simulation).

The coherent intelligent states of QA's that describe physical systems are those solutions of the corresponding Schrödinger equations that represent the evolution states with minimum of entropic uncertainty (in Heisenberg-Schrödinger sense, they are those quantum states with “maximum classical properties”). The Hadamard Transform creates the superposition on classical states, and quantum operators such as CNOT create robust entangled states. The Quantum Fast Fourier Transform (QFFT) produces interference.

The efficient implementations of a number of operations for quantum computation include controlled phase adjustment of the amplitudes in the superposition, permutation, approximation of transformations and generalizations of the phase adjustments to block matrix transformations. These operations generalize those used in quantum search algorithms (QSA) that can be realized on a classical computer. This approach is applied below (see Chapter 4) to the efficient simulation on classical computers of the Deutsch QA, the Deutsch-Jozsa QA, the Simon QA, the Shor's QA and/or the Grover QA and any control QSA for simulation of a robust KB (Knowledge Base) of fuzzy control for P-, PD-, or PID-controllers with different random excitations on control objects, or with different noises in information/control channels of intelligent control systems.

2. Structure and main quantum operations of QA simulation system FIG. 5 shows the structure of a software system for simulation a QAs. The software system is divided into two general sections: (i) The first section involves common functions; (ii) The second section involves algorithm-specific functions for realizing the concrete algorithms.

The common functions include: Superposition building blocks, Interference building blocks, Bra-Ket functions, Measurement operators, Entropy calculation operators, Visualization functions, State visualization functions, and Operator visualization functions.

The algorithm-specific functions include: Entanglement encoders, Problem transformers, Result interpreters, Algorithm execution scripts, Deutsch algorithm execution script, Deutsch Jozsa's algorithm execution script, Grover's algorithm execution script, Shor's algorithm execution script, and Quantum control algorithms as scripts.

The superposition building blocks implement the superposition operator as a combination of the tensor products of Walsh-Hadamard H operators with the identity operator I:

$$H = \frac{1}{\sqrt{2}} [ \begin{matrix}1 & 1 \\ 1 & - 1\end{matrix} ] , I = [ \begin{matrix}1 & 0 \\ 0 & 1\end{matrix} ]$$

For most algorithms, the superposition operator can be expressed as:

$$Sp = ( {{i = 1}_{}}^{{k}_{1}} H ) ( {{i = 1}_{}}^{{k}_{2}} S ) ,$$

where k₁ and k₂ are the numbers of the inclusions of H and of S into the corresponding tensor products. Values of k₁, k₂ depend on the concrete algorithm and can be obtained from Table 1. Operator S, depending on the algorithm, may be the Walsh-Hadamard operator H or the identity operators I.

TABLE 1
Parameters of superposition and of
interference operators of QAs

| Algorithm | k₁ | k₂ | S | Interference |
|---|---|---|---|---|
| Deutsch's | 1 | 1 | I | H [symbol] H |
| Deutsch- | n − 1 | 1 | H | ^{k}^{₁}H [symbol] I |
| Jozsa's | | | | |
| Grover's | n − 1 | 1 | H | Dₖ_{₁} [symbol] I |
| Simon's | n/2 | n/2 | I | ^{k}^{₁}H [symbol] ^{k}^{₂}I |
| Shor's | n/2 | n/2 | I | QFTₖ_{₁} [symbol] ^{k}^{₂}I |

It is convenient to automate the process of the calculation of the tensor power of the Walsh-Hadamard operator as follows:

$${[ {}^{n} H ]}_{i , j} = \frac{{( - 1 )}^{i * j}}{{2}^{n / 2}} = \frac{1}{{2}^{n / 2}} \{ \begin{matrix}1 , & if i * j is even \\ - 1 , & if i * j is odd\end{matrix} \qquad ( 3 )$$

where i=0, 1, . . . , 2ⁿ, j=0, 1, . . . , 2ⁿ.

The tensor power of the identity operator can be calculated as follows:

[ⁿI]_{i,j}=1|ᵢ₌ⱼ0|_{i≠j}, (4)

where i=0, 1, . . . , 2ⁿ, j=0, 1, . . . , 2ⁿ.

Then any superposition operator can be presented as a block matrix of the following form:

$${[ Sp ]}_{i , j} = \frac{{( - 1 )}^{i + j}}{{2}^{{k}_{1} / 2}} {{k}_{2}}^{} S , \qquad ( 5 )$$

where i=0, . . . , 2^{k}^{₁}−1, j=0, . . . , 2^{k}^{₁}−1 denote the blocks; ^{k}^{₂}S is a k₂ tensor power of the corresponding operator. In this case n denotes the total number of qubits in the algorithm, including measurement qubits, and qubits necessary for encoding of the function. The actual number of input bits in this case is k₁. The actual number of output bits in this case is k₂. Operators used as S are presented in Table 1 for all QAs.

For the superposition operator of Deutsch's algorithm: n=2, k₁=1, k₂=1, S=I:

$${[ Sp ]}_{i , j}^{Deutsch} = \frac{{( - 1 )}^{i + j}}{{2}^{1 / 2}} I = \frac{1}{\sqrt{2}} ( \begin{matrix}{( - 1 )}^{0 * 0} I & {( - 1 )}^{0 * 1} I \\ {( - 1 )}^{1 * 0} I & {( - 1 )}^{1 * 1} I\end{matrix} ) = \frac{1}{\sqrt{2}} [ \begin{matrix}I & I \\ I & - I\end{matrix} ] \qquad ( 6 )$$

The superposition operator of Deutsch-Jozsa's and of Grover's algorithm is, n=3, k₁=2, k₂=1, S=H:

$${[ Sp ]}_{i , j}^{Deutsch \text{-} Jozsa ' s , Grover ' s} = \frac{{( - 1 )}^{i + j}}{{2}^{2 / 2}} H = \frac{1}{2} ( \begin{matrix}{( - 1 )}^{0 * 0} H & {( - 1 )}^{0 * 1} H & {( - 1 )}^{0 * 2} H & {( - 1 )}^{0 * 3} H \\ {( - 1 )}^{1 * 0} H & {( - 1 )}^{1 * 1} H & {( - 1 )}^{1 * 2} H & {( - 1 )}^{1 * 3} H \\ {( - 1 )}^{2 * 0} H & {( - 1 )}^{2 * 1} H & {( - 1 )}^{2 * 2} H & {( - 1 )}^{2 * 3} H \\ {( - 1 )}^{3 * 0} H & {( - 1 )}^{3 * 1} H & {( - 1 )}^{3 * 2} H & {( - 1 )}^{3 * 3} H\end{matrix} ) = \frac{1}{2} ( \begin{matrix}H & H & H & H \\ H & - H & H & - H \\ H & H & - H & - H \\ H & - H & - H & H\end{matrix} ) \qquad ( 7 )$$

The superposition operator of Simon's and of Shor's algorithms are, n=4, k₁=2, k₂=2, S=I:

$${[ Sp ]}_{i , j}^{Simon , Shor} = \frac{{( - 1 )}^{i + j}}{{2}^{2 / 2}} {2}^{} I = \frac{1}{2} ( \begin{matrix}{( - 1 )}^{0 * 0} ( {}^{2} I ) & {( - 1 )}^{0 * 1} ( {}^{2} I ) & {( - 1 )}^{0 * 2} ( {}^{2} I ) & {( - 1 )}^{0 * 3} ( {}^{2} I ) \\ {( - 1 )}^{1 * 0} ( {}^{2} I ) & {( - 1 )}^{1 * 1} ( {}^{2} I ) & {( - 1 )}^{1 * 2} ( {}^{2} I ) & {( - 1 )}^{1 * 3} ( {}^{2} I ) \\ {( - 1 )}^{2 * 0} ( {}^{2} I ) & {( - 1 )}^{2 * 1} ( {}^{2} I ) & {( - 1 )}^{2 * 2} ( {}^{2} I ) & {( - 1 )}^{2 * 3} ( {}^{2} I ) \\ {( - 1 )}^{3 * 0} ( {}^{2} I ) & {( - 1 )}^{3 * 1} ( {}^{2} I ) & {( - 1 )}^{3 * 2} ( {}^{2} I ) & {( - 1 )}^{3 * 3} ( {}^{2} I )\end{matrix} ) = \frac{1}{2} ( \begin{matrix}{}^{2} I & {}^{2} I & {}^{2} I & {}^{2} I \\ {}^{2} I & - {}^{2} I & {}^{2} I & - {}^{2} I \\ {}^{2} I & {}^{2} I & - {}^{2} I & - {}^{2} I \\ {}^{2} I & - {}^{2} I & - {}^{2} I & {}^{2} I\end{matrix} ) \qquad ( 8 )$$

The interference blocks implement the interference operator that, in general, is different for all algorithms. By contrast, the measurement part tends to be the same for most of the algorithms. The interference blocks compute the k₂ tensor power of the identity operator.

This interference operator of Deutsch's algorithm is a tensor product of two Walsh-Hadamard transformations, and can be calculated in general form using Eq. (3) with n=2:

$${[ {Int}^{Deutsch} ]}_{i , j} = {}^{2} H = \frac{{( - 1 )}^{i * j}}{{2}^{2 / 2}} = \frac{1}{2} ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) \qquad ( 9 )$$

Note that in Deutsch's algorithm, the Walsh-Hadamard transformation in interference operator is used also for the measurement basis.

The interference operator of Deutsch-Jozsa's algorithm is a tensor product of k₁ power of the Walsh-Hadamard operator with an identity operator. In general form, the block matrix of the interference operator of Deutsch-Jozsa's algorithm can be written as:

$${[ {Int}^{Deutsch \text{-} Jozsa ' s} ]}_{i , j} = \frac{{( - 1 )}^{i * j}}{{2}^{\frac{{k}_{1}}{2}}} I \qquad ( 10 )$$

where i=0, . . . , 2^{k}^{₁}−1, j=0, . . . , 2^{k}^{₁}−1:
The interference operator of Deutsch-Jozsa's algorithm for n=3, k₁=2, k₂=1:

$${[ {Int}^{Deutsch \text{-} Jozsa ' s} ]}_{i , j} = \frac{{( - 1 )}^{i * j}}{{2}^{\frac{2}{2}}} I = \frac{1}{2} ( \begin{matrix}{( - 1 )}^{0 * 0} I & {( - 1 )}^{0 * 1} I & {( - 1 )}^{0 * 2} I & {( - 1 )}^{0 * 3} I \\ {( - 1 )}^{1 * 0} I & {( - 1 )}^{1 * 1} I & {( - 1 )}^{1 * 2} I & {( - 1 )}^{1 * 3} I \\ {( - 1 )}^{2 * 0} I & {( - 1 )}^{2 * 1} I & {( - 1 )}^{2 * 2} I & {( - 1 )}^{2 * 3} I \\ {( - 1 )}^{3 * 0} I & {( - 1 )}^{3 * 1} I & {( - 1 )}^{3 * 2} I & {( - 1 )}^{3 * 3} I\end{matrix} ) = \frac{1}{2} ( \begin{matrix}I & I & I & I \\ I & - I & I & - I \\ I & I & - I & - I \\ I & - I & - I & I\end{matrix} ) \qquad ( 11 )$$

The interference operator of Grover's algorithm can be written as a block matrix of the following form:

$${[ {Int}^{Grover} ]}_{i , j} = {D}_{{k}_{1}} I = ( \frac{1}{{2}^{{k}_{1} / 2}} - {}^{{k}_{1}} I ) I = ( - 1 + \frac{1}{{2}^{{k}_{1} / 2}} ) I {\vert}_{i = j} , ( \frac{1}{{2}^{{k}_{1} / 2}} ) I {\vert}_{i \neq j} = \frac{1}{{2}^{{k}_{1} / 2}} \{ \begin{matrix}- I , i = j \\ I , i \neq j\end{matrix} \qquad ( 12 )$$

where i=0, . . . , 2^{k}^{₁}−1, j=0, . . . , 2^{k}^{₁}−1, Dₖ_{₁} refers to diffusion operator:

$${[ {D}_{{k}_{1}} ]}_{i , j} = \frac{{( - 1 )}^{1 AND ( i = j )}}{{2}^{{k}_{1} - 1}}$$

Thus, the interference operator of Grover's algorithm for n=3, k=2, k₂=1 is constructed as follows:

$${[ {Int}^{Grover} ]}_{i , j} = {D}_{2} I = ( \frac{1}{{2}^{2 / 2}} - {}^{2} I ) I = ( - 1 + \frac{1}{2} ) I {\vert}_{i = j} , ( \frac{1}{2} ) I {\vert}_{i \neq j} = ( \begin{matrix}( - 1 + \frac{1}{2} ) I & \frac{1}{2} I & \frac{1}{2} I & \frac{1}{2} I \\ \frac{1}{2} I & ( - 1 + \frac{1}{2} ) I & \frac{1}{2} I & \frac{1}{2} I \\ \frac{1}{2} I & \frac{1}{2} I & ( - 1 + \frac{1}{2} ) I & \frac{1}{2} I \\ \frac{1}{2} I & \frac{1}{2} I & \frac{1}{2} I & ( - 1 + \frac{1}{2} ) I\end{matrix} ) = \frac{1}{2} ( \begin{matrix}- I & I & I & I \\ I & - I & I & I \\ I & I & - I & I \\ I & I & I & - I\end{matrix} ) \qquad ( 13 )$$

Note that as the number of qubits increases, the gain coefficient becomes smaller and the dimension of the matrix increases according to 2^{k}^{₁}. However, each element can be extracted using Eq. (12), without constructing the entire operator matrix.

The interference operator of Simon's algorithm is prepared in the same manner as the superposition operators of Shor's and of Simon's algorithms and can be described as follows (see Eqs. (5), (8)):

$${[ {Int}^{Simon} ]}_{i , j} = {}^{{k}_{1}} H I = \frac{{( - 1 )}^{i * j}}{{2}^{{k}_{1} / 2}} I = \frac{1}{{2}^{{k}_{1} / 2}} ( \begin{matrix}{( - 1 )}^{0 * 0} \cdot {}^{{k}_{2}} I & … & {( - 1 )}^{0 * j} , {}^{{k}_{2}} I & … & {( - 1 )}^{0 * ( {2}^{{k}_{1}} - 1 )} \cdot {}^{{k}_{2}} I \\ ⋮ & ⋮ & ⋮ & ⋮ & ⋮ \\ {( - 1 )}^{i * 0} \cdot {}^{{k}_{2}} I & … & {( - 1 )}^{i * j} , {}^{{k}_{2}} I & … & {( - 1 )}^{i * ( {2}^{{k}_{1}} - 1 )} \cdot {}^{{k}_{2}} I \\ ⋮ & ⋮ & ⋮ & ⋮ & ⋮ \\ {( - 1 )}^{( {2}^{{k}_{1}} - 1 ) * 0} \cdot {}^{{k}_{2}} I & … & {( - 1 )}^{( {2}^{{k}_{1}} - 1 ) * j} , {}^{{k}_{2}} I & … & {( - 1 )}^{* ( {2}^{{k}_{1}} - 1 ) * ( {2}^{{k}_{1}} - 1 ) , {}^{{k}_{2}}} I\end{matrix} ) \qquad ( 14 )$$

In general, the interference operator of Simon's algorithm is similar to the interference operator of Deutsch-Jozsa's algorithm Eq. (10), but each block of the operator matrix Eq. (14) is a k₂ tensor product of the identity operator.

Each odd block (when the product of the indexes is an odd number) of the Simon's interference operator Eq. (14), has a negative sign. Actually, if i=0, 2, 4, . . . 2^{k}^{₁}−2 or j=0, 2, 4, . . . 2^{k}^{₁}−2 the block sign is positive, otherwise the block sign is negative. This rule is applicable also for Eq. (10) of the Deutsch-Jozsa's algorithm interference operator. Then it is convenient to check if one of the indexes is an even number instead of calculating the product. Then Eq. (14) can be reduced as:

$${[ {Int}^{Simon} ]}_{i , j} = {}^{{k}_{1}} H I = \frac{{( - 1 )}^{i * j}}{{2}^{{k}_{1} / 2}} I = \frac{1}{{2}^{{k}_{1} / 2}} \{ \begin{matrix}{}^{{k}_{2}} I , & if i is odd or if j is odd \\ - {}^{{k}_{2}} I , & if i is even and j is even\end{matrix} \qquad ( 15 )$$

The interference operator of Shor's algorithm uses the Quantum Fourier Transformation operator (QFT), calculated as:

$${[ Q F {T}_{{k}_{1}} ]}_{i , j} = \frac{1}{{2}^{{k}_{1} / 2}} {e}^{J ( i * j ) \frac{2 π}{{2}^{{k}_{1}}}} \qquad ( 16 )$$

where: J—imaginary unit, i=0, . . . , 2^{k}^{₁}−1, j=0, . . . , 2^{k}^{₁}−1.
With k₁=1:

$$Q F {T}_{{k}_{1}} {\vert}_{{k}_{1} = 1} = \frac{1}{{2}^{\frac{1}{2}}} ( \begin{matrix}{e}^{J * ( 0 * 0 ) 2 π / {2}^{1}} & {e}^{J * ( 0 * 1 ) 2 π / {2}^{1}} \\ {e}^{J * ( 1 * 0 ) 2 π / {2}^{1}} & {e}^{J * ( 1 * 1 ) 2 π / {2}^{1}}\end{matrix} ) = \frac{1}{\sqrt{2}} ( \begin{matrix}1 & 1 \\ 1 & - 1\end{matrix} ) = H \qquad ( 17 )$$

Eq. (16) can be also presented in harmonic form using Euler's formula:

$${[ Q F {T}_{{k}_{1}} ]}_{i , j} = \frac{1}{{2}^{{k}_{1} / 2}} ( cos ( ( i * j ) \frac{2 π}{{2}^{{k}_{1}}} ) + J sin ( ( i * j ) \frac{2 π}{{2}^{{k}_{1}}} ) ) \qquad ( 18 )$$

Bra and Ket functions are the function used to assign to quantum qubits the actual representation as a corresponding row or column vector using the following relation:

$$α \vert \underbrace{a}_{n} = α [ \begin{matrix}0 \\ ⋮ \\ 1 {\vert}_{{2}^{a}} \\ ⋮ \\ 0\end{matrix} ] \} {2}^{n} ; \\ α \underbrace{a}_{n} \vert = α \underbrace{[ \begin{matrix}0 & … & 1 {\vert}_{{2}^{a}} & … & 0\end{matrix} ]}_{{2}^{n}} \qquad ( 19 )$$

These functions are used for specification of the input of the QA, for calculation of the density matrices of intermediate quantum states, and for fidelity analysis of the QA.

Measurement operators are used to perform the measurement of the current superposition of the state vectors. A QA produces a superposition of the quantum states, in general described as:

$$\vert x = {\sum }_{i = 1}^{{2}^{n}} {a}_{i} \vert i \qquad ( 20 )$$

During quantum processing in the QA, the probability amplitudes αᵢ of the quantum states |i [symbol] , i=1, . . . , 2ⁿ are transformed in a way such that the probability amplitude aᵣₑₛᵤₗₜ of the answer quantum state |result [symbol] becomes larger than the amplitudes of the remaining quantum states. The measurement operator outputs a state vector |result [symbol] . When all of αᵢ=const, i=1, . . . , 2ⁿ, then the measurement operator sends an error message.

Entropy calculation operators are used to estimate the entropy of the current quantum state. Consider the quantum superposition state Eq. (20). The Shannon entropy of the quantum state Eq. (20) is calculated as:

$${H}^{Sh} = - {\sum }_{i = 1}^{{2}^{n}} {α}_{i}^{2} {log}_{2} {α}_{i}^{2} \qquad ( 21 )$$

The objective of minimizing the quantity in Eq. (21) can be used as a termination condition for the QA iterations. Shannon entropy describes the uncertainty of the quantum state. It is high when quantum superposition has many states with equal probability. The minimum possible value of the Shannon entropy is equal to the number k₂ of outputs (see Table 1) of QA.

Visualization functions are functions that provide the visualization display of the quantum state vector amplitudes and of the structure of the quantum operators.

Algorithm specific functions provide a set of scripts for QA execution in command line and tools for simulation of the QA, including quantum control algorithms. The functions of section 2 prepare the appropriate operators of each algorithm, using as operands the common functions.

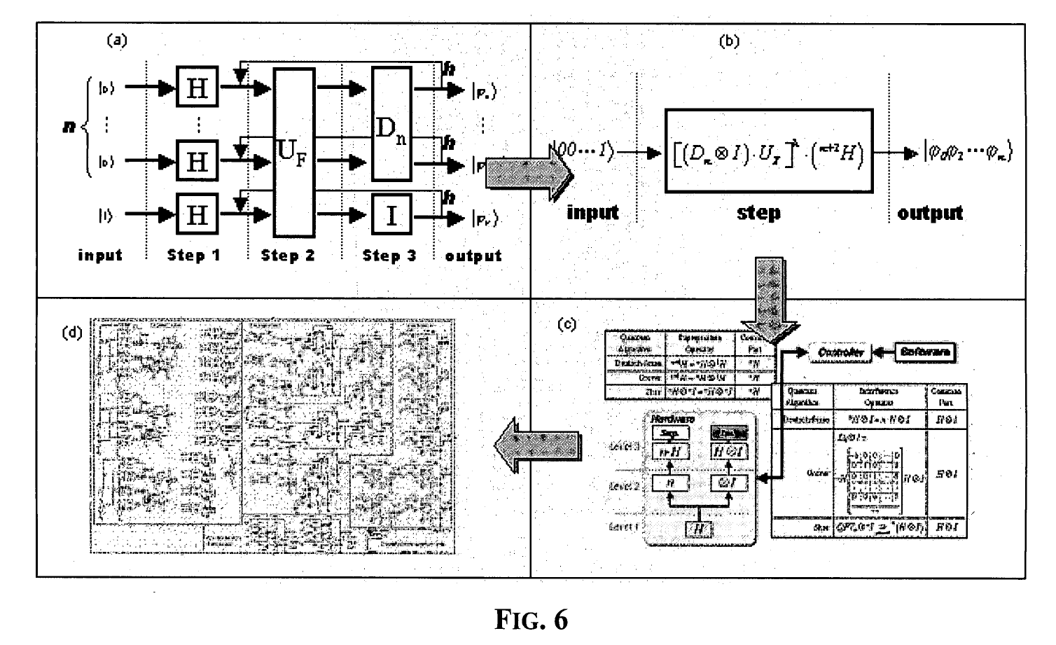

FIG. 6 shows technological process of QAG design and a corresponding circuit implementation. FIG. 6(a) is a quantum algorithm circuit. FIG. 6(b) shows corresponding quantum algorithm gate. FIG. 6(c) shows main quantum operators and their decomposition in HW implementation. FIG. 6(d) shows an example of HW implementation circuit design.

3. Quantum Evolutionary Programming (QEP) and learning control of quantum operators in QGSA with genetic operators The so-called Quantum Evolutionary Programming has two major sub-areas, Quantum Inspired Genetic Algorithms (QIGAs), and Quantum Genetic Algorithms (QGAs). The former adopts qubit chromosomes as representations and employs quantum gates for the search of the best solution. The latter tries to address a key question in this field, what GAs will look like as an implementation on quantum hardware. An important point for QGAs is to build a quantum algorithm that takes advantage both of GA's and quantum computing parallelism as well as true randomness provided by quantum computing. Below the difference and common parts as parallelism of both GA's and quantum algorithms are compared.

3.1. Genetic/Evolutionary computation and programming Evolutionary computation is a kind of self-organization and self-adaptive intelligent technique which analogies the process of natural evolution. According to Darwinism and Mendelism, it is through the reproduction, mutation, selection and competition that the evolution of life is fulfilled.

Simply stated, GAs are stochastic search algorithms based on the mechanics of natural selection and natural genetics. GAs applied to its capabilities for searching large and non-linear spaces where traditional methods are not efficient or also attracted by their capabilities for searching a solution in non-usual spaces such as for learning of quantum operators and in design of quantum circuits. An important point for GA's design is to build an algorithm that takes advantage of computing parallelism.

There exist some problems in the initialization of GAs. They can be very demanding in terms of computation and memory, and sequential GAs may get trapped in a sub-optimal region of the search space and thus may be unable to find good quality solutions. So, parallel genetic algorithms (PGAs) are proposed to solve more difficult problems that need large population. PGAs are parallel implementation of GAs which can provide considerable gains in terms of performance and scalability. The most important advantage of PGAs is that in many cases they provide better performance than single population-based algorithms, even when the parallelism is simulated on conventional computers. PGAs are not only an extension of the traditional GA sequential model, but they represent a new class of algorithms in that they search the space of solutions differently. Existing parallel implementations of GAs can be classified into three main types of PGAs: (i) Global single-population master-slave GAs; (ii) Massive parallel GAs; and (iii) Distributed GAs.

Global single-population master-slave GAs explore the search space exactly as a sequential GA and are easy to implement, and significant performance improvements are possible in many cases. Massive parallel GAs are also called fine-grained PGAs and they are suited for massively parallel computers. Distributed GAs are also called coarse-grained PGAs or island-based GA and are the most popular parallel methods because of its small communication overhead and its diversification of the population. Evolutionary algorithm (EA) is such a random searching algorithm based on the above model. It is the origin of the genetic algorithm (GA) that is derived from machine learning, evolutionary strategies (ES) which is brought forward by Rechenberg, “Evolutionstrategie: Optimizirung technischer systeme nach prinzipien der biologischen evolution,” Stuttgard, Germany: Frommann-Holzog, 1973, and Schwefel, “Evolution and optimum seeking,” N.Y.: Wiley, 1995, in numerical optimization, and evolutionary programming (EP).

EP is an efficient algorithm in solving optimization problems, but the criterion EP is of torpid convergence. Compared with GA, EP has some different characteristics. First, the evolution of GA is on the locus of chromosome, while EP directly operates on the population's behavior.

Second, GA is based on the Darwinism and genetics, so the crossover is the major operator. EP stresses on the evolution species, so there are not operations directly on the gene such as crossover, and mutation is the only operator to generate new individuals. Thus mutation is the only operator in EP and consequently it is the breakthrough point of EP. Cauchuy-mutation and logarithm-normal distribution mutation algorithms are examples, which also improved the performance of EP.

Third, there is a transformation of genotype and phenotype in GA, which does not in EP. Fourth, the evolution of EP is smooth and the evolution is much steady than GA, however it relies heavily on its initial distribution.

From the evolution mechanism, the EP that adopts Gauss mutation to generate offspring is characteristics of a slow convergent speed. Therefore, finding more efficient algorithm too speed up the convergence and improve the quantity of solution has become an important subject in the research of EP.

3.2. The fundamental result of quantum computation say that all the computation can be expanded in a circuit, which nodes are the universal gates and in quantum computing universal quantum simulator is possible. These gates offer an expansion of unitary operator U that evolves the system in order to perform some computation.

Thus, naturally two problems are discussed: (1) Given a set of functional points S={(x,y)} find the operator U such that y=U·x; and (2) Given a problem, find the quantum circuit that solves it. The former can be formulated in the context of GAs for learning algorithms while the latter through evolutionary strategies.

Quantum computing has a feature called quantum parallelism that cannot be replaced by classical computation without an exponential slowdown. This unique feature turns out to be the key to most successful quantum algorithms. Quantum parallelism refers to the process of evaluating a function once a superposition of all possible inputs to produce a superposition of all possible outputs. This means that all possible outputs are computed in the time required to calculate just one output with a classical computation. Superposition enables a quantum register to store exponentially more data than a classical register of the same size. Whereas a classical register with N bits can store one value out 2^{N}, a quantum register can be in a superposition of all 2^{N} values. An operation applied to the classical register produces one result. An operation applied to the quantum register produces a superposition of all possible results. This is what is meant by the term “quantum parallelism.”

Unfortunately, all of these outputs cannot be as easily obtained. Once a measurement is taken, the superposition collapses. Consequently, the promise of massive parallelism is offset by the inability to take advantage of it. This situation can be changed with the application hybrid algorithm (one part is Quantum Turing Machine (QTM) and another part is classical Turing Machine) as in Shor's quantum factoring algorithm that took advantage of quantum parallelism by using a Fourier transform.

3.3. Quantum Genetic Algorithm's model. This idea sketched out a Quantum Genetic Algorithm (QGA), which takes advantage of both the quantum computing and GAs parallelism. The key idea is to explore the quantum effects of superposition and entanglement to create a physical state that store individuals and their fitness. When measuring the fitness, the system collapses to a superposition of states that have that observed fitness. QGA starts from this idea, which can take advantage of both quantum computing and GAs paradigms.

Again, the difficulty is that a measurement of the quantum result collapses the superposition so that only one result is measured. At this point, it may seem that we have gained little. However, depending upon the function being applied, the superposition of answers may have common features with interference operators. If these features can be ascertained, it may be possible to divine the answer searching for probabilistically.

The next key feature to understand is entanglement. Entanglement is a quantum (correlation) connection between superimposed states. Entanglement produces a quantum correlation between the original superimposed qubit and the final superimposed answer, so that when the answer is measured, collapsing the superposition into one answer or the other, the original qubit also collapses into the value (0 or 1) that produces the measure answer. In fact, it collapses to all possible values that produce the measured answer. For example, as mentioned above, the key step in QGA is the fitness measurement of a quantum individual. We begin by calculating the fitness of the quantum individual and storing the result in the individual's fitness register. Because each quantum individual is a superposition of classical individuals, each with a potentially different fitness, the result of this calculation is a superposition of the fitnesses of the classical individuals. This calculation is made in such a way as to produce an entanglement between the register holding the individual and the register holding the fitness(es).

An interference operation is used after an entanglement operator for the extraction of successful solutions from superposed outputs of quantum algorithms. The well-known complementarity or duality of particle and wave is one of the deep concepts in quantum mechanics. A similar complementarity exists between entanglement and interference. The entanglement measure is a decreasing function of the visibility of interference.

Example: Complementarity of entanglement and interference. Let us consider the complementarity in a simple two-qubit pure state case. Consider the entangled state |ψ [symbol] =a|0₁ [symbol] |0₂ [symbol] +b|1₁ [symbol] |1₂ [symbol] with the constraint of unitarity: a²+b²=1. Then make a unitary transformation on the first qubit, |0₁ [symbol] →cos α|0₁ [symbol] +sin α|1₁ [symbol] , and obtain |ψ [symbol] →|ψ′ [symbol] =a(cos α|0₁ [symbol] +sin α|1₁ [symbol] |0₂ [symbol] +b(cos α|1₁ [symbol] −sin α|0₁ [symbol] )|1₂ [symbol] .

Finally observe the first qubit without caring about the second one. The probability to get the state |0₁ [symbol] is

$${P}_{\vert {0}_{1} 〉} = \frac{1}{2} [ 1 + ( {a}^{2} - {b}^{2} ) cos 2 α ] ,$$

which is a typical interference pattern if we regard the angle α as a control parameter. The visibility of the interference is: Γ≡|a²−b²| which vanishes when the initial state is maximally entangled, i.e., a²=b², while it becomes maximum when the state is separable, i.e. a=0 or b=0. On the other hand, the entanglement measure is partially traced von Neumann entropy as follows:

E≡S(ρ_{red})=−a² log a²−b² log b²,

where the reduced density operator
ρ_{red}=Tr₂|ψ [symbol] ψ′|=Tr₂|ψ [symbol] ψ|=a²|0₁ [symbol] 0₁|+b²|1₁ [symbol] 1₁|.

The entanglement takes the maximum value E=1 when a²=b² and the minimum value E=0 for a=0 or b=0. Thus, the more the state is entangled, the less visibility of the interference and vice versa. Another popular measure of entanglement such as the negativity may be better for a quick illustration. The negativity is minus twice of the least eigenvalue of the partial transpose of the density matrix. In this case, it is N=2|ab|. The complementarity is for this case as follows: N²+Γ²=1. This constraint between the entanglement and the interference comes from the condition of unitarity: a²+b²=1. Thus, in quantum algorithms these measures of entanglement and interference are not independent and the efficiency simulation of success solutions of quantum algorithms is correlated with equilibrium interrelations between these measures.

3.3.1. Learning control of quantum operator in QGSA with genetic operators. Similar to classical GA in that QGA allows the use of any fitness function that can be calculated on a QTM (Quantum Turing machine) without collapsing a superposition, which is generally a simple requirement to meet. The QGA differs from the classical GA in that each individual is a quantum individual. In the classical GA, when selecting an individual to perform crossover, or mutation, exactly one individual is selected. This is true regardless of whether there are other individuals with the same fitness. This is not the case with a quantum algorithm. By selecting an individual, all individuals with the same fitness are selected. In effect, this means that a single quantum individual in reality represents multiple classical individuals.

Thus, in QGA, each quantum individual is a superposition of one or more classical individuals. To do this several sets of quantum registers are used. Each individual uses two registers: (1) the individual register; and (2) the fitness register. The first register stores the superimposed classical individuals. The second register stores the quantum individual's fitness.

At different times during the QGA, the fitness register will hold a single fitness value (or a quantum superposition of fitness values). A population will be N of these quantum individuals.

Example. Let us consider the tensor product of the qubit chromosomes as follows:

$$\vert {ψ}_{1} \vert {ψ}_{2} \vert {ψ}_{3} = {\sum }_{{i}_{1} , {i}_{2} , {i}_{3} ∈ \{ 0 , 1 \}} {α}_{1 {i}_{1}} {α}_{2 {i}_{2}} {α}_{3 {i}_{3}} \vert {i}_{1} \vert {i}_{2} \vert {i}_{3} .$$

Thus, the qubit will be represented as a superposition of the states |i₁ [symbol] i₂ [symbol] i₃ [symbol] i₁, i₂, i₃ε{0,1}, and so it carries information about all of them at the same time.

Such observation points out the fact that the qubit representation has a better characteristic of diversity than the classical approaches, since it can represent superposition of states. In classical representations in the abovementioned example, we will need at least 2³=8 chromosomes to keep the information carried in the state, while only 3-qubit chromosome is enough in QGA case.

Thus, QGA uses two registers for each quantum individual. The first one stores an individual, while the second one stores the individual's fitness. A population of N quantum individuals is stored through pairs of registers

Rᵢ={(individual-register)ᵢ,(fitness-register)ᵢ}, i=1, 2 . . . , N.

Once a new population is generated, the fitness for each individual would be calculated and the result stored in the individual's fitness.

According to the law of quantum mechanics, the effect of the fitness measurement is a collapse and this process reduces each quantum individual to a superposition of classical individuals with a common fitness. It is an important step in the QGA. Then the crossover and mutation operations would be applied. The more significant advantage of QGA's will be an increase in the production of good building blocks (same as schemata in classical GAs) because, during the crossover, the building block is crossed with a superposition of many individuals instead of with only one in classical GAs (see examples below).

To improve the convergence we also need better evolutionary (crossover/mutation) strategies. The evolutionary strategies are efficient to get closer to the solution, but not to complete the learning process that can be realized efficiently with fuzzy neural network (FNN).

3.3.2. Physical requirements to crossover and mutation operator's models in QGAs. In QGAs, each chromosome represents a superposition of all possible solutions in a certain distribution, and any operation performed on such chromosome will affect all possible solutions it represents. Thus, the genetic operators defined on the quantum probability representation have to satisfy the requirement that it should be of the same efficiency to all possible solutions one chromosome represents.

In general, constrained search procedures like imaginary-time propagation frequently become trapped in a local minimum. The probability of trapping can be reduced, to some extent, by introducing a certain degree of randomness or noise (and in fact this can be achieved by increasing the time-step of the propagation). However, random searches are not efficient for problems involving complex hyper-surfaces, as is the case of the ground-state system of a system under the action of a complicated external potential. A completely different and unconventional approach for optimization of quantum systems is based on a genetic algorithm (GA), a technique, which resembles the process of evolution in nature. The GA belongs to a new generation of the so-called intelligent global optimization techniques. GA is a global search method, which simulates the process of evolution in nature. It starts from a population of individuals represented by chromosomes. The individuals go through the process of evolution, i.e., the formation of the off springs from a previous population containing the parents. The selection procedure is based on the principle of the survival of the fittest. Thus, the main ingredients of the method are a fitness function and genetic operations on the chromosomes. The main advantage of GA over other search methods is that it handles problems in highly nonlinear, multidimensional spaces with surprisingly high speed and efficiency. Furthermore, it performs a global search and therefore avoids, to a large extent, local minima. Another important advantage is that it does not require any gradient to perform the optimization. Due to the properties of the GA, the extension to higher dimensions and more particles is numerically less expensive than for other methods.

Thus in classical GA, the purpose of crossover is to exchange information between individuals. Consequently, when selecting individuals to perform crossover, or mutation, exactly one individual is selected. This is true regardless of whether there are other individuals with the same fitness. This is not the case with a QGA.

As mentioned above in the Summary, the major advantage for a QGA is the increased diversity of a quantum population. A quantum population can be exponentially larger than a classical population of the same size because each quantum individual is a superposition of multiple classical individuals. Thus, a quantum population is effectively much large than a similar classical population. This effective size is decreased during the fitness operation when the superposition is reduced to only individuals with the same fitness.

However, it is increased during the crossover operation. Consider two quantum individuals consisting of N and M superpositions each. One point crossover between these individuals results in offspring that are the superposition of N·M classical individuals. Thus, in the QGA, crossover increases the effective size of the population in addition to increasing it diversity.

There is a further benefit to quantum individuals. Consider the case of two individuals of relatively high fitness. If these are classical individuals, it is possible that these individuals are relatively incompatible. That is, any crossover between them is unlikely to produce a very fit offspring. Thus, after crossover, it is likely that the offspring of these individuals will not be selected and their good “genes” will be lost to the GA. If there are two quantum individuals all of the same high fitness is in a superposition. As such, it is very unlikely that all of these individuals are incompatible and it is almost certain that some highly fit offspring will be produced during crossover. At a necessary minimum, the necessary good offspring are somewhere over the classical case. This is a clear advantage of the QGA.

Consider the appearance of a new building block in a QGA. As mentioned above, during crossover, the building block is not crossed with only one other individual (as in classical GA). Instead, it is crossed with a superposition of many individuals. If that building block creates fit offspring with most of the individuals, then by definition, it is a good building block. Furthermore, it is clear that in measuring the superimposed fitness, one of the “good” fitness is likely to be measured (because there are many of them), thereby preserving that building block. In effect, by using superimposed individuals, the QGA removes much of the randomness of the GA. Thus, the statistical advantage of good building blocks should be much greater in the QGA. This should cause the number of good building blocks to grow much more rapidly.

One can also view the evolutionary process as a dynamic map in which populations tends to converge on fixed points in the population space. From this point of view, the advantage of s QGA is that the large effective size allows the population to sample from more basins of attraction. Thus, it is much more likely that the population will include members in the basins of attraction for the higher fitness solutions.

Therefore, in a QGA the evolution information of each individual is well contained in its contemporary evolution target (high fitness). In this case, the contemporary evolution target represents the current evolution state of one individual that have the best solution corresponding to its current fitness. Because the contemporary evolution target represents the current evolution state of one individual, the exchanging contemporary evolution targets by crossover operator of two individuals, the evolution process of one individual will be influenced by the evolution state of the other one.

Example: Crossover operator. The crossover operator for this case satisfies the above requirement:

| | |
|---|---|
| (1) | Select two chromosomes from the group randomly |
| | with a given probability P_{Cr}; |
| (2) | Exchange their evolution target (fitness) |
| | temporarily; |
| (3) | Update the two chromosomes according to their new |
| | targets (fitness)for one time; and |
| (4) | Change back their evolution targets (fitness) |

Thus with this model of crossover operator, the evolution process of one individual will be influenced by the evolution state of the other one.

Example: Mutation operator. The purpose of mutation is to slightly disturb the evolution states of some individuals, and to prevent the algorithm from falling into local optimum. The requirement for designing mutation resembles that for designing crossover. As a probing research, a single qubit mutation operator can be used, but the thought can be generalized easily to the multiple qubits scenarios. Following is the procedure of mutation operator:

| | |
|---|---|
| (1) | Select a set of chromosomes from the group |
| | randomly with a given probability P_{Mt}; |
| (2) | For each chromosome, select a qubit randomly; and |
| (3) | Exchange the position of its pair of probability |
| | amplitude. |

Clearly, the mutation operator defined above has the same efficiency to all the superposition states.

Let us briefly consider an example of how an application of GA operation on a quantum computing can be considered.

Example. In GA, a population of an appropriate size is maintained during each iteration. A chromosome in the population is assumed to code with binary strings. Let the length of these binary strings be n. There are a total of 2ⁿ such strings. Usually, only a small number (m<<2ⁿ) of these strings are chosen to be in the population. A possible state in a quantum computer corresponds to a chromosome in GA. Choosing an initial population is equivalent to setting the amplitude of those states that correspond to the chromosomes in the population to be 1/\sqrt{m} and 0 otherwise.

FIG. 7 shows a possible coding of bit-strings (chromosomes of a genetic algorithm) with a tensor product of qubits (herein referred also as quantum chromosomes). According to the above-mentioned requirements, crossover operator of two chromosomes in GA is performed by a randomly selected cutting point and concatenating the left part of the first chromosome with the right part of the second, and the left part of the second with the right part of the first. If the first chromosome is fₗfᵣ and the second is sₗsᵣ, then the resulting new chromosomes are fₗsᵣ and sₗfᵣ.

Quantum computing is manipulated with unitary operators. A unitary transformation can be constructed so that it will operate on one chromosome or one state and will emulate crossover. If the number of bits after cutting point is k, then a simple unitary transformation that transforms sᵣ to fᵣ and fᵣ to sᵣ can be constructed easily by starting out with a unit matrix, then setting a 1 at the (sᵣ, fᵣ) and (fᵣ, sᵣ) positions, and changing the one at the (sᵣ,sᵣ) and (fᵣ,fᵣ) positions to be 0. The k bits after the cut point can be crossed over by composing k such unitary operators.

As an example, the following matrix that operates at the last two bits does crossover of 1011 and 0110 to 1010 and 0111, where the cutting points is at the middle:

$$\begin{matrix}\vert 00 〉 \\ \vert 01 〉 \\ \vert 10 〉 \\ \vert 11 〉\end{matrix} ( \begin{matrix}{1}^{〈 00 \vert} & {0}^{〈 01 \vert} & {0}^{〈 10 \vert} & {0}^{〈 11 \vert} \\ 0 & 1 & 0 & 0 \\ 0 & 0 & 0 & 1 \\ 0 & 0 & 1 & 0\end{matrix} ) ,$$

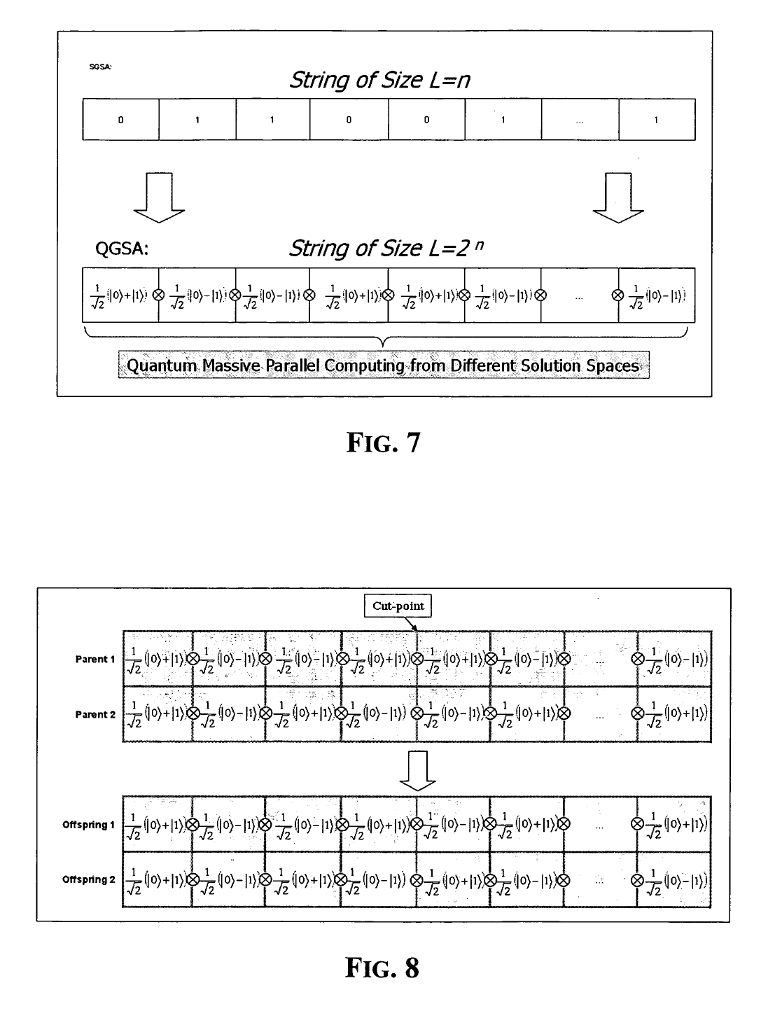

i.e., it is the matrix form of the CNOT-gate that can create entanglement. FIG. 8 shows one cut-point crossover operation in QGA.

Mutation of a chromosome alters one or more genes. It can also be described by changing the bit at a certain position or positions. Switching the bit can be simply carried out by the unitary transformation (negation operator, for example):

$$\begin{matrix} & 〈 0 \vert & 〈 1 \vert \\ \begin{matrix}\vert 0 〉 \\ \vert 1 〉\end{matrix} ( \begin{matrix}0 & 1 \\ 1 & 0\end{matrix} ) & & \end{matrix}$$

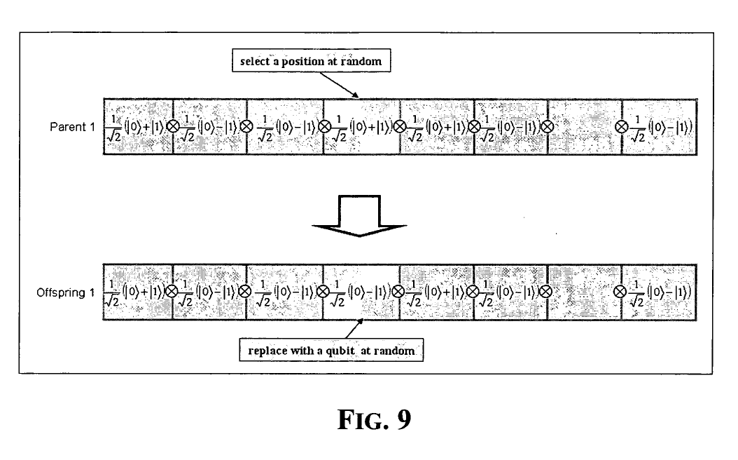

at a certain bit position or positions. FIG. 9 shows mutation operation in QGSA.

The selection/reproduction process involves choosing chromosomes to form the next generation of the population. Selection is based on the fitness values of the chromosomes. Typical selection rules are to replace all parents by the offspring, or retain a few of the best parents, or retain the best among all parents and offspring. When using GA to solve an optimization problem, the objective function value is “the fitness”. We can interpret the objective function as the energy or entropy rate of the state and states with lower energy have a higher probability of surviving.

There are two ways that the selection process can be implemented. First, follow the same steps as in a classical computer. That is, evaluate the “fitness” or “energy” of each chromosome. The fitness has to be stored since the evaluation process is not reversible. Second, we can make use of the quantum behavior of a quantum computing to perform selection, as described below. Selecting a suitable Hamiltonian will be equivalent to choosing a selection strategy. Since members of the successive populations are wave functions, the uncertainty principle has to be taken into account when defining the genetic operations. In QGA this can be achieved by introducing smooth or “uncertain” genetic operations (see example below).

After the selection step, the GA will return to its first step and continue iterations. It will terminate when an observation of the state is performed.

3.4. Mathematical model of genetic-quantum operator's interrelation. The quantum individual |x [symbol] and its fitness f(x) could be mathematically represented by an entangled state (using crossover operator as unitary CNOT-gate):

$$\vert Ψ 〉 = \frac{1}{\sqrt{N}} \sum \vert x 〉 ⊗ \vert f ( x ) 〉 .$$

In mathematical formulation, each register is a closed quantum system. Thus, all of them can be initialized with this entangled state |ψ [symbol] . So, if we have M quantum individuals in each generation we need M register pairs (individual register, fitness register). Then, unitary operators as Walsh-Hadamard W will be applied to the first register of the state |x [symbol] in order to complete the generation of the initial population. Henceforth, the initialization could encompass the following steps.

| Step | Computational algorithm (Quantum computing) |
|---|---|
| 1 | For each register i, generate the state: |
| | $\vert {ψ}_{i} = \frac{1}{\sqrt{N}} {\sum }_{x = 0}^{N - 1} \vert x ⊗ \vert 0$ |
| 2 | Apply unitary operators using Walsh-Hadamard |
| | transformation W (for example, as rotations) |
| | and operator U_{f}, the known black-box which |
| | performs the operation U_{f}\|a [symbol] \|0 [symbol] = \|a [symbol] \|f(a) [symbol] to |
| | complete the initial population: |
| | $\begin{matrix}\vert ψ ≡ {U}_{f} W \vert {ψ}_{i} = {\sum }_{x = 0}^{N - 1} {U}_{f} ( W ( \frac{\vert x }{\sqrt{N}} ⊗ \vert 0 ) ) \\ = {\sum }_{x = 0}^{N - 1} {U}_{f} ( {a}_{x} \vert x ⊗ \vert 0 {i}_{} ) \\ = {\sum }_{x = 0}^{N - 1} {a}_{xi} {\underbrace{\vert x {i}_{}}}_{1 st register} \underbrace{\vert f ( x ) {i}_{}}_{2 nd register} , i = 1 , 2 , … , M\end{matrix}$ |
| | Remark. It is important to observe that the |
| | fitness f(x) is stored in the second register |
| | after the generation of the population. |
| 3 | By measuring the fitness in the second register, |
| | each individual undergoes collapse, as following |
| | final result: |
| | $\vert ψ {i}_{Msr}^{} = \frac{1}{\sqrt{{K}_{i}}} {\sum }_{k = 0}^{{K}_{i} - 1} \vert k {i}_{} ⊗ \vert {y}_{0} {i}_{} ,$ |
| | where\|k [symbol] is such that the observed fitness for |
| | the i-th register is f(k) = y₀. |
| | Remark. When entering the main loop, the |
| | observed fitness is used to select the best |
| | individuals. |

Then, genetic operators must be applied. Let us consider one of possible model of important genetic operator application as mutation. Example: Mutation operator application. Mutations can be implemented through the following steps.

| Step | Computational algorithm (Genetic operation) |
|---|---|
| 1 | Apply U_{f}⁻¹ over the measurement result: |
| | ${U}_{f}^{- 1} \vert Ψ {i}_{Msr}^{} = \frac{1}{\sqrt{{K}_{i}}} {\sum }_{k = 0}^{{K}_{i} - 1} \vert k ⊗ \vert 0 {i}_{} ⊗ \underbrace{( \vert 0 {i}_{} - \vert 1 {i}_{} )}_{Auxiliary qubit}$ |
| 2 | Unitary operators R (small rotation, for |
| | example) are applied to the above result: |
| | $\begin{matrix}R ( {U}_{f}^{- 1} \vert Ψ {i}_{Msr}^{} ) = {\sum }_{k = 0}^{{K}_{i} - 1} P ( \frac{\vert k {i}_{}}{\sqrt{{K}_{i}}} ) ⊗ \vert 0 {i}_{} ⊗ \underbrace{( \vert 0 {i}_{} - \vert 1 {i}_{} )}_{Auxiliary qubit} \\ = {\sum }_{k = 0}^{{K}_{i} - 1} {β}_{xi} \vert x {i}_{} ⊗ \vert 0 {i}_{} ⊗ \underbrace{( \vert 0 {i}_{} - \vert 1 {i}_{} )}_{Auxiliary qubit}\end{matrix} ,$ |
| | where the result is expanded in the |
| | computational basis. |
| 3 | Finally, apply U_{f} to recover the diversity as |
| | entangled state that was lost during the |
| | measurement: |
| | ${U}_{f} [ {RU}_{f}^{- 1} ] \vert Ψ {i}_{Msr}^{} = {\sum }_{k = 0}^{{K}_{i} - 1} {β}_{xi} \vert x {i}_{} ⊗ \vert f ( x ) {i}_{} ⊗ \underbrace{( \vert 0 {i}_{} - \vert 1 {i}_{} )}_{Auxiliary qubit} ,$ |
| | that keep the correlation “individual [symbol] fitness” as in |
| | step 2 of abovementioned computational |
| | algorithm. |

The major advantage for a QGA is the increase diversity of a quantum population due to superposition, which is precisely defined above in step 2 of computational algorithm as

$${\vert Ψ 〉}_{i} = {\sum }_{x = 0}^{N - 1} {a}_{xi} {\underbrace{{\vert x 〉}_{i}}}_{1 st register} ⊗ {\underbrace{{\vert f ( x ) 〉}_{i}}}_{2 nd register} , i = 1 , 2 , … , M$$

This effective size decreases during the measurement of the fitness, when the superposition is reduced to only individuals with the observed fitness according to the expression

$${\vert Ψ 〉}_{i}^{Msr} = \frac{1}{\sqrt{{K}_{i}}} {\sum }_{k = 0}^{{K}_{i} - 1} {\vert k 〉}_{i} ⊗ {\vert {y}_{0} 〉}_{i} ⊗ \underbrace{( {\vert 0 〉}_{i} - {\vert 1 〉}_{i} )}_{Auxiliary qubit}$$

However, it would be increased during the crossover and mutation applications. Besides, by increasing diversity, it is much more likely that the population will include members in the basins of attraction for the higher fitness solutions.

Thus, an improved convergence rate must be expected. Besides, classical individuals with high fitness can be relatively incompatible, which is that any crossover between them is unlikely to produce a very fit offspring. However, in the QGA, these individuals can co-exist in a superposition.

3.5. QGA-simulation of quantum physical systems. There are two ways that the selection process can be implemented. First, follow the same steps as in a classical computer. That is, evaluate the “fitness” or “energy” of each chromosome. The fitness has to be stored since the evaluation process is not reversible. Second, we can make use of the quantum behavior of a quantum computing to perform selection, as described below. Selecting a suitable Hamiltonian will be equivalent to choosing a selection strategy.

After the selection step, the GA will return to its first step and continue iterations. It will terminate when an observation of the state is performed. Since members of the successive populations are wave functions, the uncertainty principle has to be taken into account when defining the genetic operations. As abovementioned in QGA this can be achieved by introducing smooth or “uncertain” genetic operations (see below).

Example: QGA model in 1D search space. As we have mentioned before, the GA was developed to optimize (maximize or minimize) a given property (like an area, a volume or an energy). The property in question is a function of many variables of the system. In GA-language this quantity is referred to as the fitness function. There are many different ways to apply GA. One of them is the phenotype version. In this approach, the GA basically maps the degrees of freedom or variables of the system to be optimized onto a genetic code (represented by a vector). Thus, a random population of individuals is created as a first generation. This population “evolves” and subsequent generations are reproduced from previous generations through application of different operators on the genetic codes, like, for instance, mutations, crossovers and reproductions or copies. The mutation operator changes randomly the genetic information of an individual, i.e., one or many components of the vector representing its genetic code. The crossover or recombination operator interchanges the components of the genetic codes of two individuals. In a simple recombination, a random position is chosen at which each partner in a particular pair is divided into two pieces. Each vector then exchanges a section of itself with its partner. The copy or reproduction operator merely transfers the information of the parent to an individual of the next generation without any changes.

In the QGA approach, the vector representing the genetic code is just the wave function ψ(x). The fitness function, i.e., the function to be optimized by the successive generations is the expectation:

$$E [ ψ ] = \frac{〈 ψ \vert {H}^{⋒} \vert ψ 〉}{〈 ψ \vert ψ 〉} ,$$

where the 1D-Hamiltonian is given by

$${H}^{⋒} = - \frac{1}{2} {∇}^{2} + V ( x ) .$$

Here, V(x) is the external potential. In the case of Grover's search algorithm we can write that Ĥ≡GUⱼ.

There are many different ways to describe the evolution of the population and the creation of the offspring. The GA can be described as follows:

| | |
|---|---|
| Step | Computational algorithm |
| (i) | Create a random initial population |
| | consisting of N wave functions |
| (ii) | Determine the fitness E[ψⱼ^{(0)] of all individuals} |
| (iii) | Create a new population {ψⱼ⁽¹⁾(x)} through |
| | application of the genetic operators |
| (iv) | Evaluate the fitness of the new generation |
| (v) | Repeat steps (iii) and (iv) for the successive |
| | generations {ψⱼ⁽ⁿ⁾(x)} until convergence is |
| | achieved and the ground-state wave is found |

Usually, real-space calculations deal with boundary conditions on a box. Therefore, and in order to describe a wave function within a given interval a≦x≦b, we have to choose boundary conditions for ψ(a) and ψ(b). For simplicity we set ψ(a)=ψ(b)=0, i.e., we consider a finite box with infinite walls at x=a and x=b. Inside this box we can simulate different kinds of potentials, and if the size of the box is large enough, boundary effects on the results of our calculations can be reduced.

As an initial population of wave functions satisfying the boundary conditions: ψⱼ(a)=0, ψⱼ(b)=0, we choose Gaussian-like functions of the form

$${ψ}_{j} ( x ) = A exp [ - \frac{{( x - {x}_{j} )}^{2}}{{σ}_{j}^{2}} ] ( x - a ) ( b - x ) ,$$

with random values for xⱼε[a,b] and σⱼε(0,b−a], whereas the amplitude A is calculated from the normalization condition ∫|ψ(x)|²dx=1 for given values of xⱼ and σⱼ.

As we have mentioned above, three kinds of operations on the individuals can be defined: reproduction and mutation of a function, and crossover between two functions. The reproduction operation has the same meaning as in previous applications of GA. Both the crossover and the mutation operations have to be redefined and applied to the quantum mechanical case. The smooth or “uncertain” crossover is defined as follows. Let us take two randomly chosen “parent” functions ψ₁⁽ⁿ⁺¹⁾(x) and ψ₂⁽ⁿ⁺¹⁾(x) as

$${ψ}_{1}^{( n + 1 )} ( x ) = {ψ}_{1}^{( n )} ( x ) St ( x ) + {ψ}_{2}^{( n )} ( x ) ( 1 - St ( x ) )$$

$${ψ}_{2}^{( n + 1 )} ( x ) = {ψ}_{2}^{( n )} ( x ) St ( x ) + {ψ}_{1}^{( n )} ( x ) ( 1 - St ( x ) )$$

where St(x) is a smooth step function involved in the crossover operation. We consider the following case:

$$St ( x ) = \frac{1}{2} [ 1 + tanh ( \frac{x - {x}_{0}}{{k}_{c}^{2}} ) ] ,$$

where x₀ is chosen randomly (x₀ε(a,b)) and k_{c} is a parameter, which allows to control the sharpness of the crossover operation. The idea behind the “uncertain” crossover is to avoid large derivatives of the new generated wave functions. Note, that the crossover operation between identical wave functions generates the same wave functions.

The mutation operation in the quantum case must also take into account the uncertainty relations. It is not possible to change randomly the value of the wave function at a given point without producing dramatic changes in the kinetic energy of the state. To avoid this problem we define the mutation operation is defined as ψ⁽ⁿ⁺¹⁾(x)=ψ⁽ⁿ⁾(x)+ψᵣ(X), where ψᵣ(x) is the random mutation function. In the present case we choose ψᵣ(x) as a Gaussian

$${ψ}_{r} ( x ) = B exp [ - \frac{{( {x}_{r} - x )}^{2}}{{R}^{2}} ]$$

with a random center xᵣε(a,b), width Rε(0,b−a) and amplitude B. For each step of a GA iteration we randomly perform copy, crossover and mutation operations. After the application of the genetic operation, the newly created functions are normalized.

Example: QGA model in 2D search space. In this case, the QGA maps each wave function onto a genetic code (represented by a matrix containing the values of the wave function at the mash points). The algorithm is implemented as follows. A rectangular box Ω≡{(x,y),0≦x≦d,0≦y≦d} is chosen as a finite region in real space. An initial population of trial two-body wave functions {Ψᵢ}, i=1, . . . , Nₚₒₚ is chosen randomly. For this purpose, we can construct each Ψᵢ, using Gaussian-like one-particle wave functions of the form

$${ψ}_{v} ( x , y ) = {A}_{v} exp \{ - \frac{{( x - {\overline{x}}_{v} )}^{2}}{{σ}_{X , v}^{2}} - \frac{{( y - {\overline{y}}_{v} )}^{2}}{{σ}_{Y , v}^{2}} \} x ( d - x ) y ( d - y )$$

with v=1, 2 and random values for x̅ᵥ, y̅ᵥ and for σ_{X,v}, σ_{Y,v} for each wave function. The amplitude Aᵥ is calculated from the normalization condition: ∫∫|ψⱼ(x,y)|²dxdy=1, and its sign is chosen randomly. Note that defined in such a way, the wave functions ψⱼ(x,y) fulfill zero condition on the boundary ∂Ω

ψᵥ(x,y)|_{∂Ω}=0

So constructed initial population, {Ψᵢ}, corresponds to the initial generation. Now, the fitness of each individual Ψᵢ of the population is determined by evaluating the function

Eᵢ=E[ψᵢ]≡∫Ψᵢ*(r₁,r₂)\hat{H}(r₁,r₂)Ψᵢ(r₁,r₂)dr₁dr₂,

where Ĥ is the Hamiltonian of the corresponding problem. This means that the expectation value of the energy for a given individual is a measure of its fitness, and we apply the QGA to minimize the energy. By virtue of the variational principle, when the QGA finds the global minimum, it corresponds to the ground state of Ĥ.

Off-springs of the initial generation are formed through application of mutation, crossover and copy operations on the genetic codes. We define continuous analogies of three kinds of genetic operations on the individuals: reproduction, mutation, and crossover. While the reproduction operation has the same meaning as in previous “classical” applications of the GA, both the crossover and the mutation operations have to be redefined to be applied to the quantum mechanical case. The smooth or “uncertain” crossover in two dimensions is defined as follows. Given two randomly chosen single-particle “parent” functions ψᵢᵥ^{(old)}(x,y) and ψ_{1μ}^{(old)}(x,y) (i, l=1, Nₚₒₚ, μ, v=1, 2), one can construct two new functions ψᵢᵥ^{(new)}(x,y) and ψ_{1μ}^{(new)}(x,y) as

$${ψ}_{iv}^{( new )} ( x , y ) = {ψ}_{iv}^{( old )} ( x , y ) St ( x , y ) + {ψ}_{iv}^{( old )} ( x , y ) ( 1 - St ( x , y ) )$$

$${ψ}_{l μ}^{( new )} ( x , y ) = {ψ}_{l μ}^{( old )} ( x , y ) St ( x , y ) + {ψ}_{l μ}^{( old )} ( x , y ) ( 1 - St ( x , y ) )$$

where St(x,y) is 2D smooth step function which produces the crossover operation. We can define

$$St ( x , y ) = \frac{1}{2} [ 1 + tanh ( \frac{ax + by + c}{{k}_{c}^{2}} ) ] ,$$

where a, b, c are chosen randomly. The line ax+by+c=0 cuts Ω into two pieces, k_{c} is a parameter, which allows control of the sharpness of the crossover operation. The idea behind the “uncertain” crossover is to avoid very large derivatives of the newly generated wave functions, i.e., very large kinetic energy of the system. Note that the crossover operation between identical wave functions generates the same wave functions.

As abovementioned the mutation operation in the quantum case should also take into account the uncertainty relations. It is not possible to change randomly the value of the wave function at a given point without producing dramatic changes in the kinetic energy of the state. To avoid this problem we define a new kind of mutation operation for a random “parent” ψᵢᵥ^{(old)}(x,y) as follows: ψᵢᵥ^{(new)}(x,y)=ψᵢᵥ^{(old)}(x,y)+ψᵣ(x,y), where ωᵣ(x,y) is random mutation function. In the present case, we choose ψᵣ(x,y) as a Gaussian-like function

$${ψ}_{r} ( x , y ) = {A}_{r} exp [ - \frac{{( {x}_{r} - x )}^{2}}{{R}_{x}^{2}} - \frac{{( {y}_{r} - y )}^{2}}{{R}_{y}^{2}} ] x ( d - x ) y ( d - y )$$

with random values for xᵣ, y, Rₓ, R_{y} and Aᵣ. Similarly to 1D space, for each step of a GA iteration, we randomly perform copy, crossover and mutation operations. After the application of the genetic operation, the new-created functions are normalized and orthogonalized. Then, the fitness of the individuals is evaluated and the fittest individuals are selected. The procedure is repeated until convergence of the fitness function (the energy of the system) to a reduced value is reached. Inside the box Ω we can simulate different kinds of external potentials. If the size of the box is large enough, boundary effects are negligible.

4. SIMULATION SYSTEM OF SMART INTELLIGENT CONTROL BASED ON QUANTUM SOFT COMPUTING

4.1. GENERAL STRUCTURE OF QA's SIMULATION SYSTEM. The problems solved by the quantum algorithms we will describe can be so stated:

| | |
|---|---|
| Input | A function f : {0, 1}ⁿ |
| | →{0, 1}^{m} |
| Problem | Find a certain |
| | property of f |

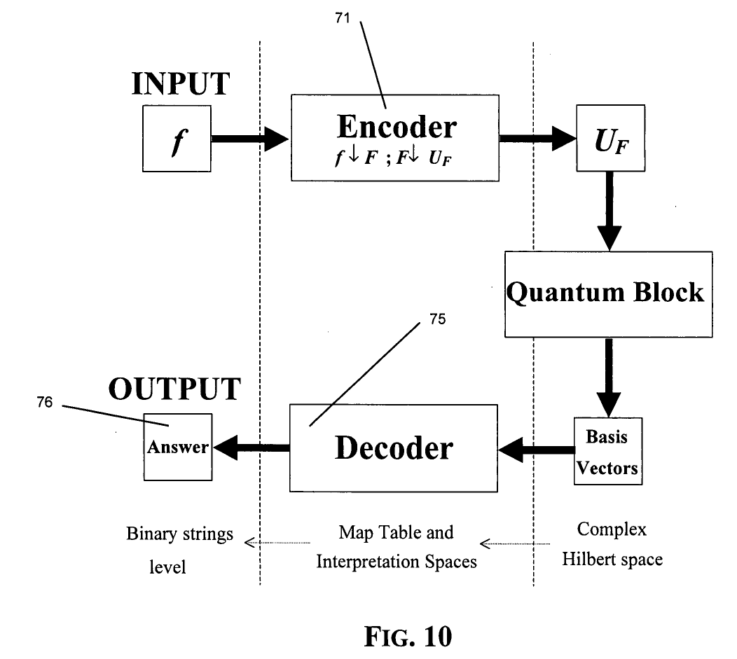

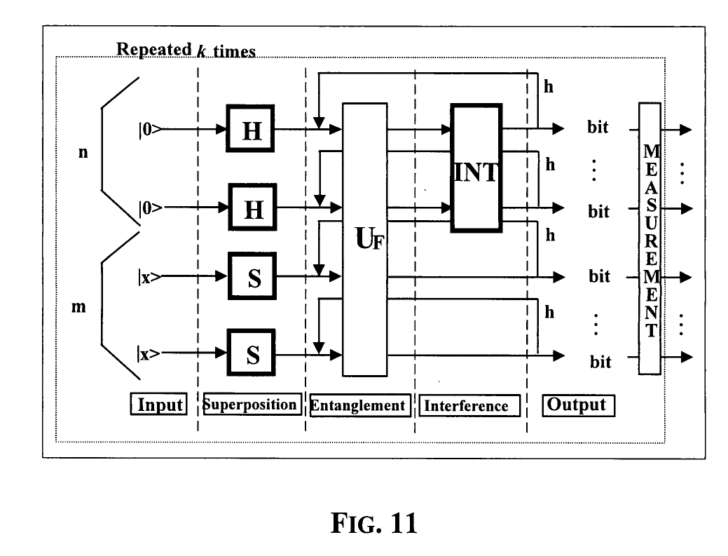

FIG. 10 shows a basic scheme of Quantum Algorithms. FIG. 11 shows a sample quantum circuit. The structure of a quantum algorithm is outlined, with a high level representation, in the scheme diagram of FIG. 12.

The input of a quantum algorithm is always a function f from binary strings into binary strings. This function is represented as a map table in Box 2201, defining for every string its image. Function f is first encoded in Box 2207 into a unitary matrix operator U_{F} depending on f properties. In some sense, this operator calculates f when its input and output strings are encoded into canonical basis vectors of a Complex Hilbert Space: U_{F} maps the vector code of every string into the vector code of its image by f.

A squared matrix U_{F} on the complex field is unitary if its inverse matrix coincides with its conjugate transpose: U_{F}⁻¹=U_{F}. A unitary matrix is always reversible and preserves the norm of vectors.

When the matrix operator U_{F} has been generated, it is embedded into a quantum gate G, a unitary matrix whose structure depends on the form of matrix U_{F} and on the problem we want to address. The quantum gate is the heart of a quantum algorithm. In quantum algorithms, the quantum gate acts on an initial canonical basis vector (we can always choose the same vector) in order to generate a complex linear combination (let's call it superposition) of basis vectors as the output. This superposition contains the information to answer the initial problem.

After this superposition has been created, measurement takes place in order to extract this information. In quantum mechanics, measurement is a non-deterministic operation that produces as output only one of the basis vectors in the entering superposition. The probability of every basis vector of being the output of measurement depends on its complex coefficient (probability amplitude) in the entering complex linear combination.

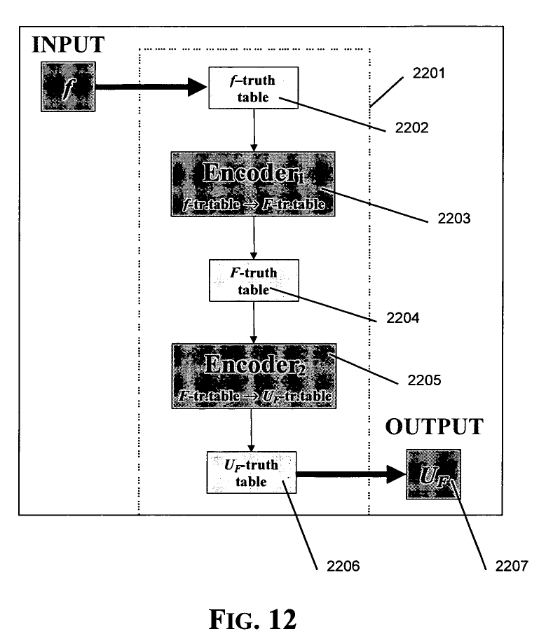

The segmental action of the quantum gate and of the measurement constitutes the quantum block (see FIG. 13). The quantum block is repeated k times in order to produce a collection of k basis vectors. Since measurement is a non-deterministic operation, these basic vectors won't necessarily be identical and each one of them will encode a piece of the information needed to solve the problem. The last part of the algorithm comprises the interpretation of the collected basis vectors to get the right answer for the initial problem with a certain probability.

4.1.1. The behavior of the encoder block is described in the detailed scheme diagram of FIG. 12. Function f is encoded into matrix U_{F} in three steps.

Step 1: The map table of function f: {0,1}ⁿ→{0,1}^{m} is transformed in box 2203 into the map table of the injective function F:{0,1}^{n+m}→{0,1}^{n+m} such that:

F(x₀, . . . , xₙ₋₁, y₀, . . . , yₘ₋₁)=(x₀, . . . , xₙ₋₁, f(x₀, . . . , xₙ₋₁)⊕(y₀, . . . , yₘ₋₁)).

The need to deal with an injective function comes from the requirement that U_{F} is unitary. A unitary operator is reversible, so it cannot map 2 two different inputs in the same output. Since U_{F} will be the matrix representation of F, F is supposed to be infective. If we directly employed the matrix representation of the function f, we could obtain a non-unitary matrix, since f could be non-injective. So, injectivity is fulfilled by increasing the number of bits and considering the function F instead of the function f. Anyway, function f can always be calculated from F by putting (y₀, . . . , yₘ₋₁)=(0, . . . , 0) in the input string and reading the last m values of the output string.

Reversible circuits generally realize permutation operations. When can we realize any Boolean circuit F:Bⁿ→B^{m} by reversible circuit? For this case, we do not calculate the function F:Bⁿ→B^{m}. We can calculate another function with expanding F_{⊕}:B^{n+m}→B^{n+m} that we define with the following relation: F_{⊕}(x,y)=(x,y⊕F(x)) where the operation ⊕ is defined as addition on module 2. Then the value of F(x) is defined as F_{⊕}(x,0)=(x,F(x)).

Step 2: The function F map table is transformed in Box 2205 into U_{F} map table, following the following constraint:

∀sε{0,1}^{n+m}:U_{F}[τ(s)]=τ[F(s)]

The code map τ:{0,1}^{n+m}→C²^{^{n+m}} (C²^{^{n+m}} is the target Complex Hilbert Space) is such that:

$$τ ( 0 ) = ( \begin{matrix}1 \\ 0\end{matrix} ) = \vert 0 〉 , τ ( 1 ) = ( \begin{matrix}0 \\ 1\end{matrix} ) = \vert 1 〉$$

$$τ ( {x}_{0} , … , {x}_{n + m - 1} ) = τ ( {x}_{0} ) ⊗ … ⊗ τ ( {x}_{n + m - 1} ) = \vert {x}_{0} … {x}_{n + m - 1} 〉$$

Code τ maps bit values into complex vectors of dimension 2 belonging to the canonical basis of C². Besides, using tensor product, τ maps the general state of a binary string of dimension n into a vector of dimension 2ⁿ, reducing this state to the joint state of the n bits composing the register. Every bit state is transformed into the corresponding 2-dimensional basis vector and then the string state is mapped into the corresponding 2ⁿ-dimensional basis vector by composing all bit-vectors through tensor product. In this sense the tensor product is the vector counterpart of state conjunction.

If a component of a complex vector is interpreted as the probability amplitude of a system of being in a given state (indexed by the component number), the tensor product between two vectors describes the joint probability amplitude of two systems of being in a joint state. Basis vectors are denoted using the ket notation |i [symbol] This notation is taken from Dirac description of quantum mechanics.

Step 3: U_{F} map table is transformed in Box 2206 into U_{F} using the following transformation rule:

This rule can easily be understood when vectors |i [symbol] and |j [symbol] are considered as column vectors. Since these vectors belong to the canonical basis, U_{F} defines a permutation map of the identity matrix rows. In general, row |j [symbol] is mapped into row |i [symbol] .

4.1.2. The heart of the quantum block is the quantum gate, which depends on the properties of the matrix U_{F}. The scheme in FIG. 13 gives a more detailed description of the quantum block.

The matrix operator U_{F} in FIG. 13 is the output of the encoder block represented in FIG. 12. Here, it becomes the input for the quantum block in Box 2301.

This matrix operator is first embedded into a more complex gate, the quantum gate G in Box 2303. the unitary matrix G is applied k times to an initial canonical basis vector |i [symbol] of dimension 2^{n+m} from Box 2302. Every time, the resulting complex superposition G|0 . . . 01 . . . 1 [symbol] of basis vectors is measured, producing one basis vector |x [symbol] as a result. All the measured basis vectors {x₁, . . . , xₖ} are collected together in Box 2306. This collection is the output of the quantum block in Box 2307.

The “intelligence” of our algorithms is in the ability to build a quantum gate that is able to extract the information necessary to find the required property of f and to store it into the output vector collection. We will discuss in detail the structure of the quantum gate for a quantum algorithm and observe that it can be described in a general way.

In order to represent quantum gates, we are going to employ some special diagrams called quantum circuits. An example of quantum circuit is illustrated in FIG. 11.

Every rectangle is associated to a matrix 2ⁿ×2ⁿ, where n is the number of lines entering and leaving the rectangle. For example, the rectangle marked U_{F} is associated with matrix U_{F}.

Quantum circuits. Let us give a high-level description of the gate and, using some transformation rules, we can easily compile them into the corresponding gate-matrix. These rules are described in detail in the U.S. Pat. No. 6,578,018.

4.1.3. The decoder block in Box 75 of FIG. 10 has the function to interpret the basis vectors collected after the iterated execution in the quantum block. Decoding these vectors means to retranslate them into binary strings and interprete them directly if they already contain the answer to the starting problem, or use them, for instance, as coefficients vectors for some equation system to get the searched solution. We shall not investigate this part in detail since it is a non-interesting and easy classical part.

Analog description of Operators and Gate Referring to the Quantum Algorithm general scheme depicted in FIG. 11, the output vector of superposition is well known if the value of matrix S is defined or, in other words, a particular algorithm is chosen. This fact avoids, in a dedicated gate, several time-consuming matrix tensor products and will be explained in next sections in more detail. However, if we want to keep the generality of the method, a circuit performing the superposition operation is proposed in the European patent application EP 1 267 304 in the name of STMicroelectronics, S.r.l. It avoids the use of multipliers and, by utilizing logic gates in an analog architecture, reduce the number of operation and components.

As showed in FIG. 11, the first general operation needed is S|x>, where S can be H or I and |x> can be |0> or |1>. The results are therefore combined together by tensor products. Neglecting the constant factor 1/2^{(n+)/2} the four possibilities can be written as follows:

$$H \vert 0 〉 = [ \begin{matrix}1 & 1 \\ 1 & - 1\end{matrix} ] [ \begin{matrix}1 \\ 0\end{matrix} ] H \vert 1 〉 = [ \begin{matrix}1 & 1 \\ 1 & - 1\end{matrix} ] [ \begin{matrix}0 \\ 1\end{matrix} ]$$

$$I \vert 0 〉 = [ \begin{matrix}1 & 0 \\ 0 & 1\end{matrix} ] [ \begin{matrix}1 \\ 0\end{matrix} ] I \vert 1 〉 = [ \begin{matrix}1 & 0 \\ 0 & 1\end{matrix} ] [ \begin{matrix}0 \\ 1\end{matrix} ]$$

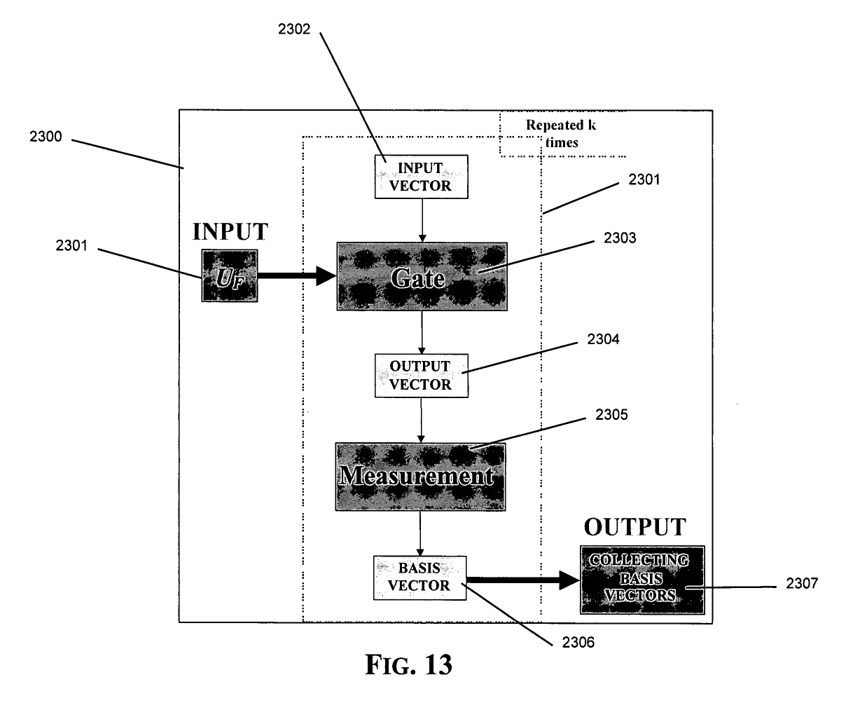

It can be noted that in all of these cases, direct product can be performed via AND gates. In fact, we have 1*1=1 [symbol] 1=1; −1*1=−(1 [symbol] 1)=−1; 1*0=(1 [symbol] 0)=0. Taking into account these equalities, H|0> can be obtained as in FIG. 14, while H|1> is calculated as in FIG. 15.

If S=I the structure is the same but all signs are positive. However, in this case it is quite evident that AND gates can be bypassed.

Let us focus on tensor products between the resulting vectors. After direct product we can have several of these to be combined:

$$\begin{matrix}H \vert 0 〉 = [ \begin{matrix}1 \\ 1\end{matrix} ] & H \vert 1 〉 = [ \begin{matrix}1 \\ - 1\end{matrix} ] \\ I \vert 0 〉 = [ \begin{matrix}1 \\ 0\end{matrix} ] & I \vert 1 〉 = [ \begin{matrix}0 \\ 1\end{matrix} ]\end{matrix}$$

Some preliminary considerations must be done in order to simplify the problem. For example, vector I|1> is not present in any quantum algorithm. Moreover, H|1> and I|0> are not present in the same algorithm at the same time. So the output of superposition is the result of products like

$$[ \begin{matrix}1 \\ 1\end{matrix} ] ⊗ [ \begin{matrix}1 \\ 1\end{matrix} ] ⊗ [ \begin{matrix}1 \\ - 1\end{matrix} ] ⊗ …$$

$$or like \\ [ \begin{matrix}1 \\ 1\end{matrix} ] [ \begin{matrix}1 \\ 1\end{matrix} ] ⊗ [ \begin{matrix}1 \\ 0\end{matrix} ] ⊗ …$$

In both cases, only two values are present in this expression, and therefore logic gates can be used again. From a formal point of view, the two expression are identical (the second one can be considered the normalization between 0 and 1 of the first one).

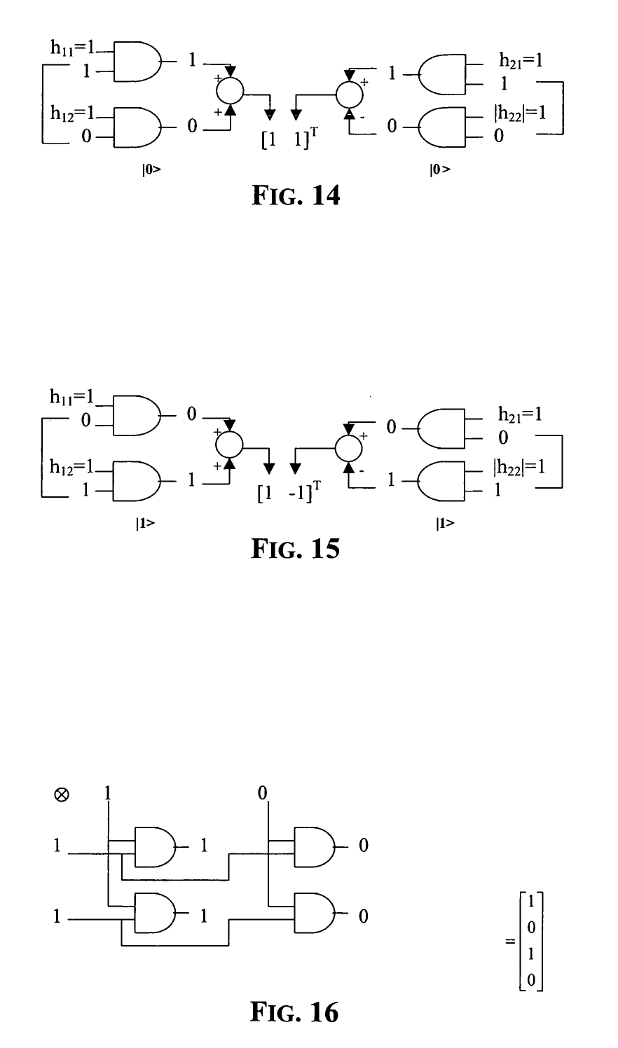

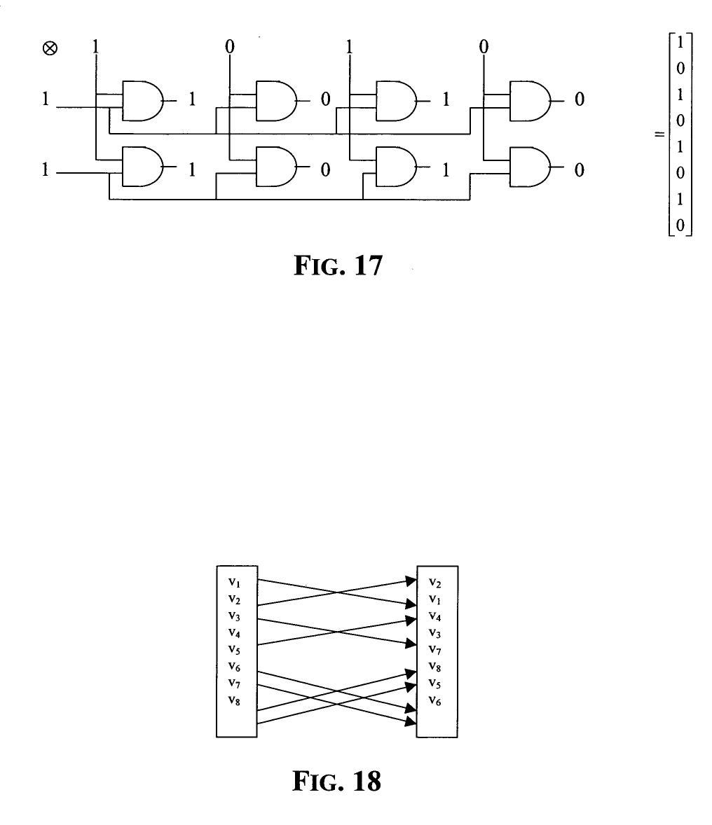

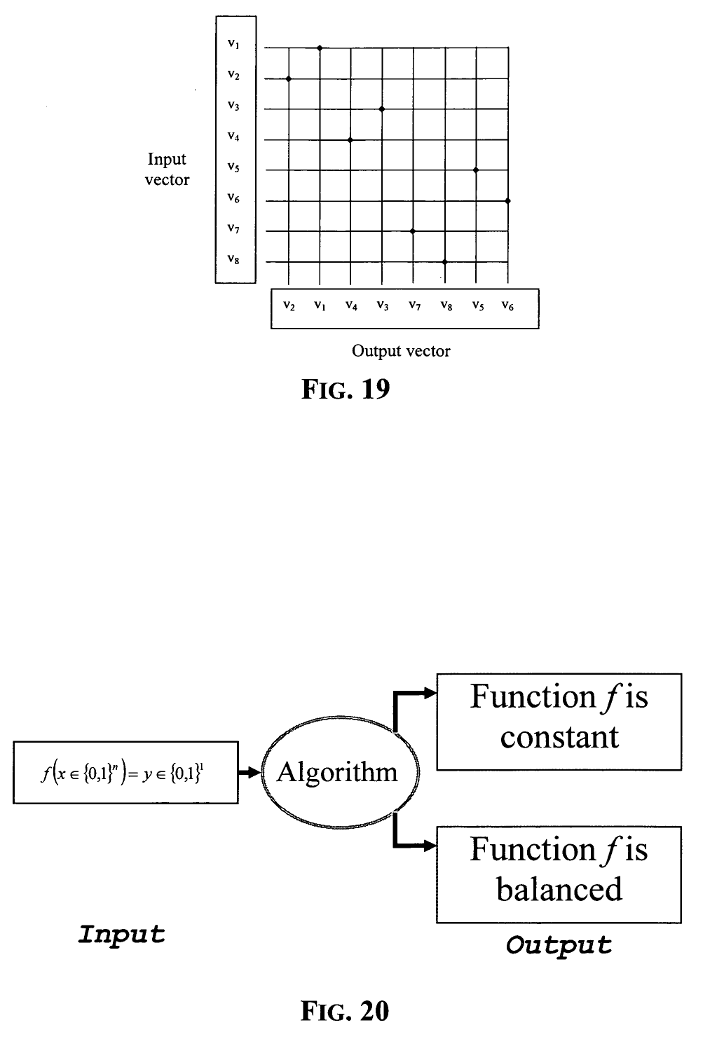

Let us suppose we wish to calculate [1 1]^{T} [symbol] [1 0]^{T}. The simple logic gate of FIG. 16 performs this operation. The tensor product [1 1]^{T} [symbol] [1 1]^{T} [symbol] [1 0]^{T} can therefore be obtained as depicted in FIG. 17. However, the whole superposition block can be constituted by only four AND gates. In fact the addition of further qubits to the specific quantum algorithm can be very easy.

Suppose that A is a vector representing the superposition output of an n qubits algorithm. In order to have an n+1 qubits superposition output vector two operations are possible:

$$[ \begin{matrix}1 \\ 1\end{matrix} ] ⊗ A = [ \begin{matrix}A \\ A\end{matrix} ] or [ \begin{matrix}1 \\ 0\end{matrix} ] ⊗ A = [ \begin{matrix}A \\ 0\end{matrix} ]$$

depending on the specific algorithm. These results can be obtained only by replicating (or not) the previous vector A. The resulting vector is ready to be the input of the following block (i.e. the Entanglement block) after a suitable denormalization between −1 and 1 and after being scaled by the factor 1/2^{(n+1)/2}.

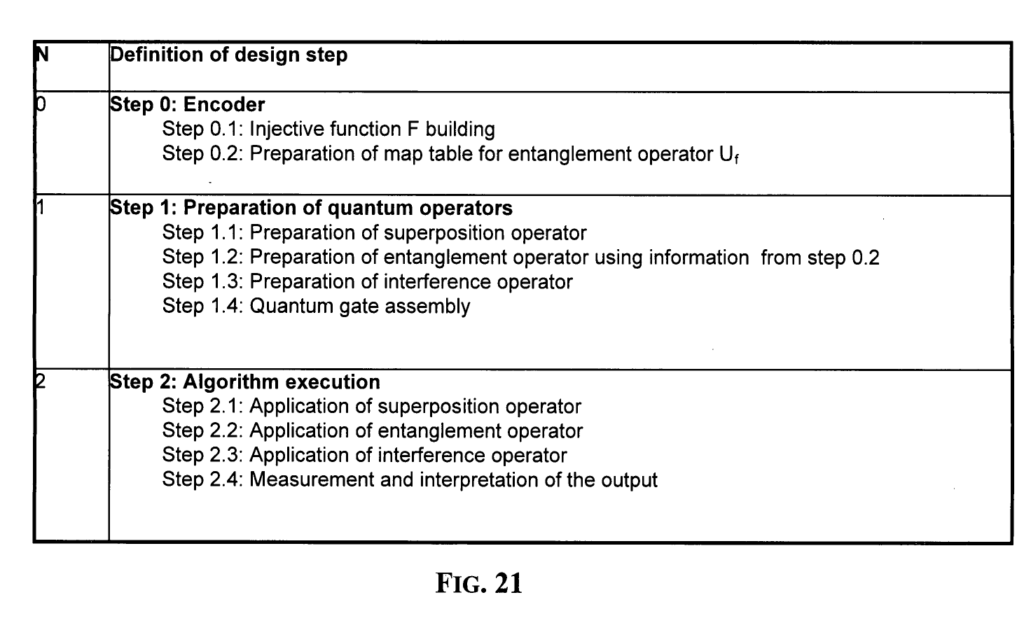

The entanglement step comprises, as showed in previous sections, in a direct product among the unitary matrix U_{F} (in which the problem is encoded via a binary function f) and the vector coming out from superposition. The real effect on this vector is in general the permutation of some elements, as shown in FIG. 18. In order to perform similar operations, a PROM matrix structure as that of FIG. 19 can be adopted, in which conduction takes place in correspondence of a nonzero element of U_{F}.

Regarding the interference operator, it could be treated in general like superposition using AND gates for tensor products, but due to important differences among Quantum Algorithms at this step, the best approach is to build a dedicated interchangeable interference block. To this aim it will be discussed case by case in the next sections, including parallelism and possible similarities between algorithms.

4.2. Definition of Deutsch-Jozsa's problem is so stated:

| | |
|---|---|
| Input | A constant or balanced function |
| | f: {0, 1}ⁿ→{0, 1} |
| Problem | Decide if f is constant or balanced |

This problem is very similar to Deutsch's problem, but it has been generalized to n>1. FIG. 20 shows the structure of the problem and FIG. 21 shows the steps of gate design process. According to design steps on the FIG. 21 let's consider the step 0: Encoder.

4.2.1. We first deal with some special functions with n=2. This should help the reader to understand the main ideas of this algorithm. Then, we discuss the general case with n=2 and finally we encode a balanced or constant function in the more general situation n>0. We consider the encoding steps process according to the structure on the FIG. 12.

Encoding a constant function with value 1.

Let's consider the case:
n=2

∀xε{0,1}ⁿ:f(x)=1

In this case f map table is so defined:

| x | f(x) |
|---|---|
| 00 | 1 |
| 01 | 1 |
| 10 | 1 |
| 11 | 1 |

The encoder block takes a f map table as input and encodes it into matrix operator U_{F}, which acts inside of a complex Hilbert space.

Step 1 Function f is encoded into the injective function F, built according to the following statement:

F:{0,1}ⁿ⁺¹→{0,1}ⁿ⁺¹:F(x₀,x₁,y₀)=(x₀,x₁,f(x₀,x₁)⊕y₀)

Then, F map table is:

| (x₀, x₁, | F(x₀, x₁, |
|---|---|
| y₀) | y₀) |
| 000 | 001 |
| 010 | 011 |
| 100 | 101 |
| 110 | 111 |
| 001 | 000 |
| 011 | 010 |
| 101 | 100 |
| 111 | 110 |

Step 2 Let's now encode F into U_{F} map table using the rule:

∀tε{0,1}ⁿ⁺¹:U_{F}[τ(t)]=τ[F(t)]

where τ is the code map defined above. This means:

| | U_{F}\|x₀ x₁ |
|---|---|
| \|x₀ x₁ y₀> | y₀> |
| \|000> | \|001> |
| \|010> | \|011> |
| \|100> | \|101> |
| \|110> | \|111> |
| \|001> | \|000> |
| \|011> | \|010> |
| \|101> | \|100> |
| \|111> | \|110> |

Here, we used ket notation to denote basis vectors.

Step 3 Starting from the map table of U_{F}, we calculate the corresponding matrix operator. This matrix is obtained using the rule:

[U_{F}]_{i,j}=1 [symbol] U_{F}|j [symbol] =|i

[symbol]

So, U_{F} is the following matrix:

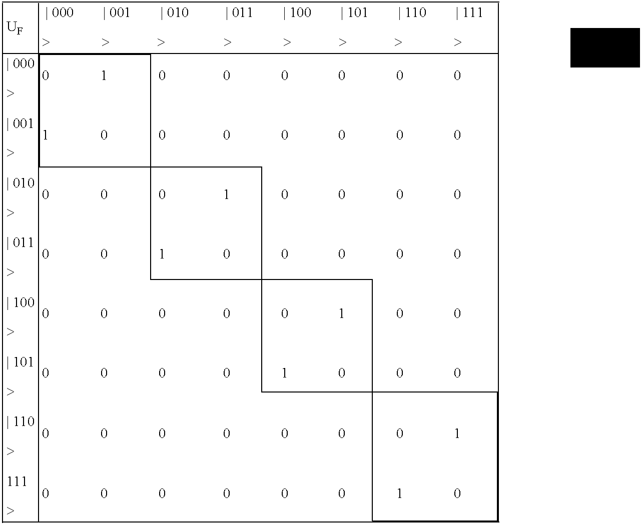

Using matrix tensor product, U_{F} can be written as:

U_{F}=I [symbol] I [symbol] C

where ⊕ is the tensor product, I is the identity matrix of order 2 and C is the NOT-matrix so defined:

$$C = [ \begin{matrix}0 & 1 \\ 1 & 0\end{matrix} ]$$

Matrix C flips a basis vector: in fact it transforms vector |0> into |1> and |1> into |0>.

If matrix U_{F} is applied to the tensor product of three vectors of dimension 2, the resulting vector is the tensor product of the three vectors obtained applying matrix I to the first two input vectors and matrix C to the third.

Tensor product and entanglement Given m vectors v₁, . . . , vₘ of dimension 2^{d}^{₁}, . . . , 2^{d}^{ₘ} and m matrix operators M₁, . . . , Mₘ of order 2^{d}^{₁}×2^{d}^{₁}, . . . , 2^{d}^{ₘ}×2^{d}^{ₘ} the following property holds:

(M₁ [symbol] Mₘ)·(v₁ [symbol] vₙ)=M₁·v₁ [symbol] Mₘ·vₙ

This means that, if a matrix operator can be written as the tensor product of m smaller matrix operator, the evolutions of the m vectors the operator is applied to are independent, namely no correlation is present among this vector. An important corollary is that if the initial state was not entangled, the final state is also not entangled.

The structure of U_{F} is such that the first two vectors in the input tensor product are preserved (action of I), whereas the third is flipped (action of C). We can easily verify that this action corresponds to the constraints stated by U_{F} map table.

B. Encoding a constant function with value 0

Let's now consider the case:
n=2

∀xε{0,1}ⁿ:f(x)=0

In this case f map table is so defined:

| x | f(x) |
|---|---|
| 00 | 0 |
| 01 | 0 |
| 10 | 0 |
| 11 | 0 |

Step 1. F map table is:

| (x₀, x₁, | F(x₀, x₁, |
|---|---|
| y₀) | y₀) |
| 000 | 000 |
| 010 | 010 |
| 100 | 100 |
| 110 | 110 |
| 001 | 001 |
| 011 | 011 |
| 101 | 101 |
| 111 | 111 |

Step 2. F map table is encoded into U_{F} map table:

| | U_{F} \|x₀ x₁ |
|---|---|
| \|x₀ x₁ y₀22 | y₀> |
| \|000> | \|000> |
| \|010> | \|010> |
| \|100> | \|100> |
| \|110> | \|110> |
| \|001> | \|001> |
| \|011> | \|011> |
| \|101> | \|101> |
| \|111> | \|111> |

Step 3. It is very easy to transform this map table into a matrix. In fact, we can observe that every vector is preserved.

Therefore the corresponding matrix is the identity matrix of order 2³.

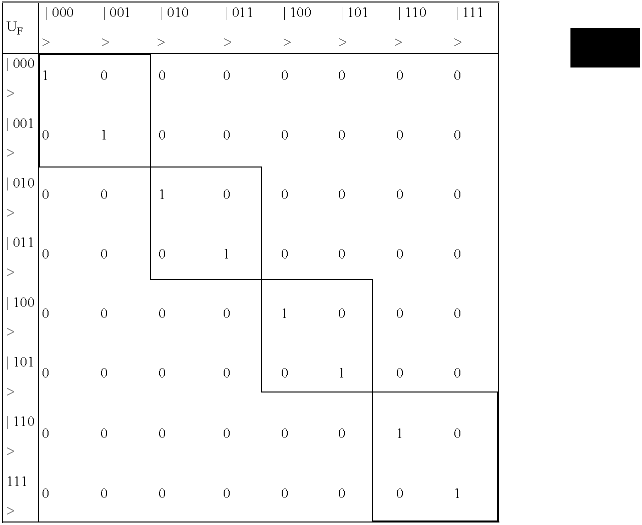

Using matrix tensor product, this matrix can be written as:

U_{F}=I [symbol] I [symbol] I

The structure of U_{F} is such that all basis vectors of dimension 2 in the input tensor product evolve independently. No vector controls any other vector.

C. Encoding a Balanced Function

Consider now the balanced function:

n=2

∀(x₁, . . . , xₙ)ε{0,1}ⁿ:f(x₁, . . . , xₙ)=x₁⊕ . . . ⊕xₙ

In this case f map table is the following:

| x | f(x) |
|---|---|
| 00 | 0 |
| 01 | 1 |
| 10 | 1 |
| 11 | 0 |

Step 1

The following map table calculated in the usual way represents the injective function F (where f is encoded into):

| (x₀, x₁, y₀) | F(x₀, x₁, y₀) | (x₀, x₁, y₀) | F(x₀, x₁, y₀) |
|---|---|---|---|
| 000 | 000 | 001 | 001 |
| 010 | 011 | 011 | 010 |
| 100 | 101 | 101 | 100 |
| 110 | 110 | 111 | 111 |

Step 2. Let's now encode F into U_{F} map table:

| | U_{F} \|x₀ x₁ |
|---|---|
| \|x₀ x₁ y₀> | y₀> |
| \|000> | \|000> |
| \|010> | \|011> |
| \|100> | \|101> |
| \|110> | \|110> |
| \|001> | \|001> |
| \|011> | \|010> |
| \|101> | \|100> |
| \|111> | \|111> |

Step 3.

The matrix corresponding to U_{F} is:

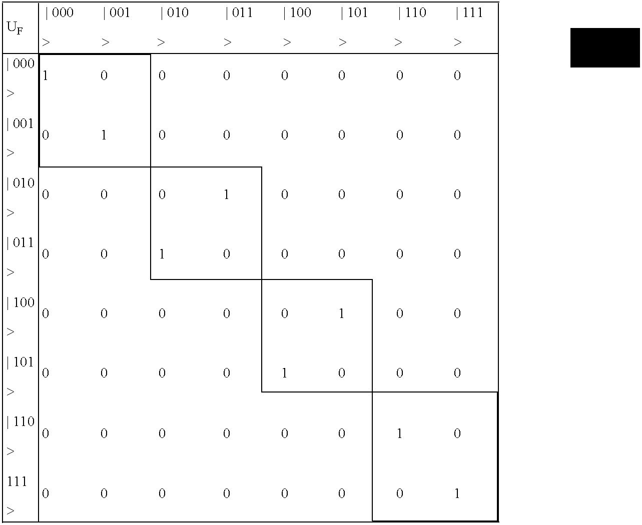

This matrix cannot be written as the tensor product of smaller matrices. In fact, if we write it as a block matrix we obtain:

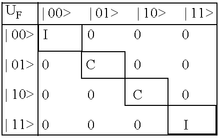

This means that the matrix operator acting on the third vector in the input tensor product depends on the values of the first two vectors. If these vectors are |0> and |0>, for instance, the operator acting on the third vector is the identity matrix, if the first two vectors are |0> and |1>, then the evolution of the third is determined by matrix C. We say that this operator creates entanglement, namely correlation among the vectors in the tensor product.

D. General case with n=2 Consider now a general function with n=2. In this general case f map table is the following:

| x | f(x) |
|---|---|
| 00 | f₀₀ |
| 01 | f₀₁ |
| 10 | f₁₀ |
| 11 | f₁₁ |

with fᵢε{0,1}, i=00, 01, 10, 11. If f is constant then ∃yε{0,1}∀xε{0,1}²: f(x)=y. If f is balanced then {fᵢ:fᵢ=0}|=|{fᵢ: fᵢ=1}|

Step 1. Injective function F (where f is encoded) is represented by the following map table calculated in the usual way:

| (x₀, x₁, | F(x₀, x₁, |
|---|---|
| y₀) | y₀) |
| 000 | 0 0 f₀₀ |
| 010 | 0 1 f₀₁ |
| 100 | 1 0 f₁₀ |
| 110 | 1 1 f₁₁ |
| 001 | 0 0 [symbol] f₀₀ |
| 011 | 0 1 [symbol] f₀₁ |
| 101 | 1 0 [symbol] f₁₀ |
| 111 | 1 1 [symbol] f₁₁ |

Step 2. Let's now encode F into U_{F} map table:

| | U_{F} \|x₀ x₁ |
|---|---|
| \|x₀ x₁ y₀> | y₀> |
| \|000> | \|0 0 f₀₀> |
| \|010> | \|0 1 f₀₁> |
| \|100> | \|1 0 f₁₀> |
| \|110> | \|1 1 f₁₁> |
| \|001> | \|0 0 [symbol] |
| | f₀₀> |
| \|011> | \|0 1 [symbol] |
| | f₀₁> |
| \|101> | \|1 0 [symbol] |
| | f₁₀> |
| \|111> | \|1 1 [symbol] |
| | f₁₁> |

Step 3. The matrix corresponding to U_{F} can be written as a block matrix with the following general form:

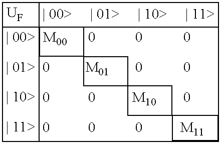

where Mᵢ=I if fᵢ=0 and Mᵢ=C if fᵢ=1,i=00, 01, 10, 11. The structure of this matrix is such that, when the first two vectors are mapped into some other vectors, the null operator is applied to the third vector, generating a null probability amplitude for this transition. This means that the first two vectors are left unchanged. On the contrary, operators Mᵢε{I, C} and they are applied to the third vector when the first two are mapped into themselves. If all Mᵢ coincide, operator U_{F} encodes a constant function. Otherwise it encodes a non-constant function. If |{Mᵢ: Mᵢ=I}|=|{Mᵢ: Mᵢ=C} I then f is balanced.

E. General case Consider now the general case n>0. Input function f map table is the following:

| xε{0, 1}ⁿ⁺¹ | f(x) |
|---|---|
| 0 . . . 0 | f_{0 . . . 0} |
| 0 . . . 1 | f_{0 . . . 1} |
| . . . | . . . |
| 1 . . . 1 | f_{1 . . . 1} |

with fᵢε{0,1}, iε{0,1}ⁿ. If f is constant then ∃yε{0,1}∀xε{0,1}ⁿ: f(x)=y. If f is balanced then |{fᵢ: fᵢ=0}|=|{fᵢ: fᵢ=1}|.

Step 1. The map table of the corresponding infective function F is:

| xε{0, 1}ⁿ⁺¹ | f(x) |
|---|---|
| 0 . . . 00 | 0 . . . 0 f_{0 . . . 0} |
| . . . | . . . |
| 1 . . . 10 | 1 . . . 1 f_{1 . . . 1} |
| 0 . . . 01 | 0 . . . 0 [symbol] |
| | f_{0 . . . 0} |
| . . . | . . . |
| 1 . . . 11 | 1 . . . 1 [symbol] |
| | f_{1 . . . 1} |

Step 2. Let's now encode F into U_{F} map table:

| \|x> | U_{F} \|x> |
|---|---|
| \|0 . . . 00> | \|0 . . . 0 |
| | f_{0 . . . 0}> |
| . . . | . . . |
| \|1 . . . 10> | \|1 . . . 1 |
| | f_{1 . . . 1}> |
| \|0 . . . 01> | \|0 . . . 0 [symbol] |
| | f_{0 . . . 0>} |
| . . . | . . . |
| \|1 . . . 11> | \|1 . . . 1 [symbol] |
| | f_{1 . . . 1}> |

Step 3. The matrix corresponding to U_{F} can be written as a block matrix with the following general form:

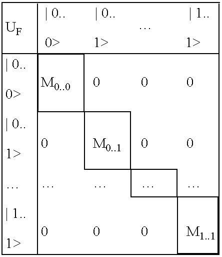

where Mᵢ=I if fᵢ=0 and Mᵢ=C if fᵢ=1, iε{0,1}ⁿ.

This matrix leaves the first n vectors unchanged and applies operator Mᵢε{I, C} to the last vector. If all Mᵢ coincide with I or C, the matrix encodes a constant function and it can be written as ⁿI [symbol] I or ⁿI [symbol] C. In this case no entanglement is generated. Otherwise, if the condition |{Mᵢ: Mᵢ=I}|=|{Mᵢ: Mᵢ=C}| is fulfilled, then f is balanced and the operator creates correlation among vectors.

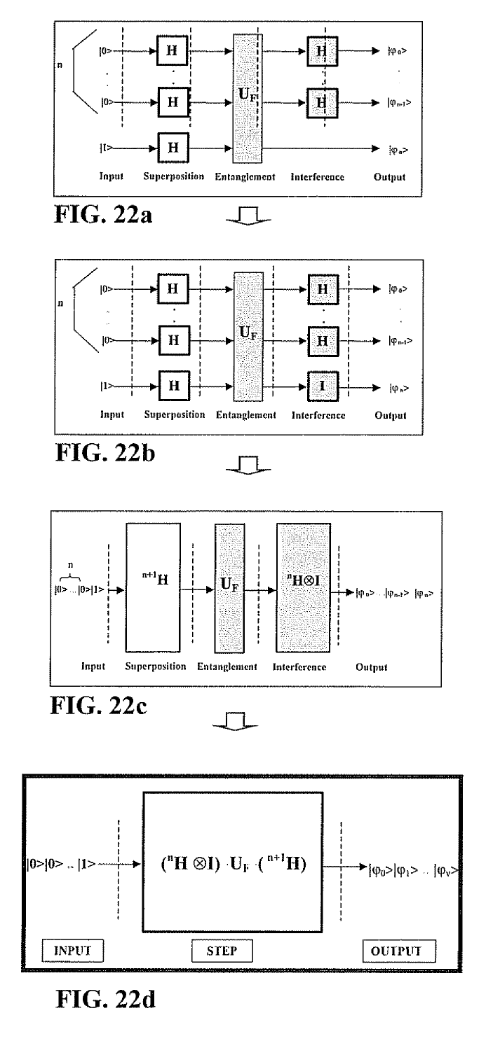

4.2.2. Quantum block Matrix U_{F}, the output of the encoder, is now embedded into the quantum gate of Deutsch-Jozsa's algorithm. As we did for Deutsch's algorithm, we describe this gate using a quantum circuit FIG. 22a. The previous circuit is compiled into the one presented on the FIG. 22b.

Let's consider operator U_{F} in the case of constant and balanced functions. The structure of this operator strongly influences the structure of the whole gate. We shall analyze this structure in the case, f is 1 everywhere, f is 0 everywhere, and in the general case with n=2. Finally, we propose the general form for our gate with n>0.

Constant function with value 1 If f is constant and its value is 1, matrix operator U_{F} can be written as ⁿI [symbol] C. This means that U_{F} can be decomposed into n+1 smaller operators acting concurrently on the n+1 vectors of dimension 2 in the input tensor product.

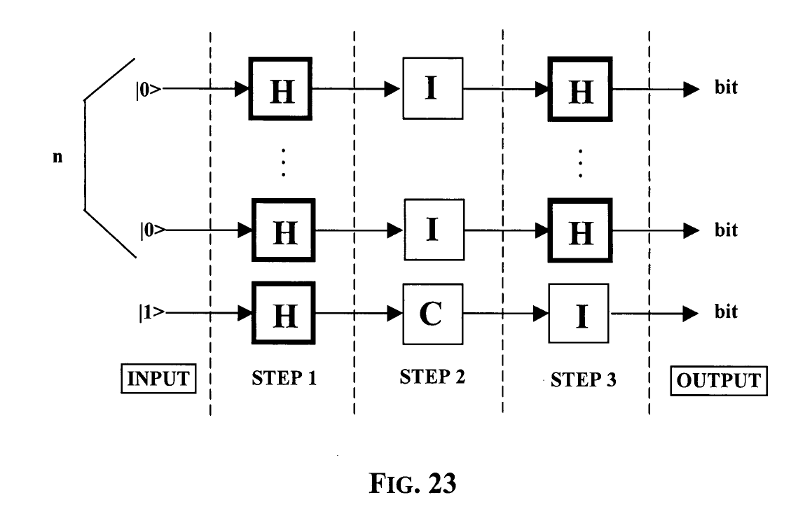

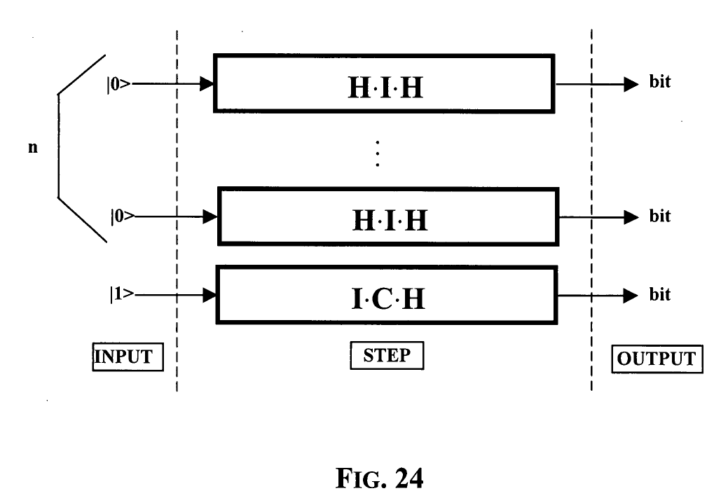

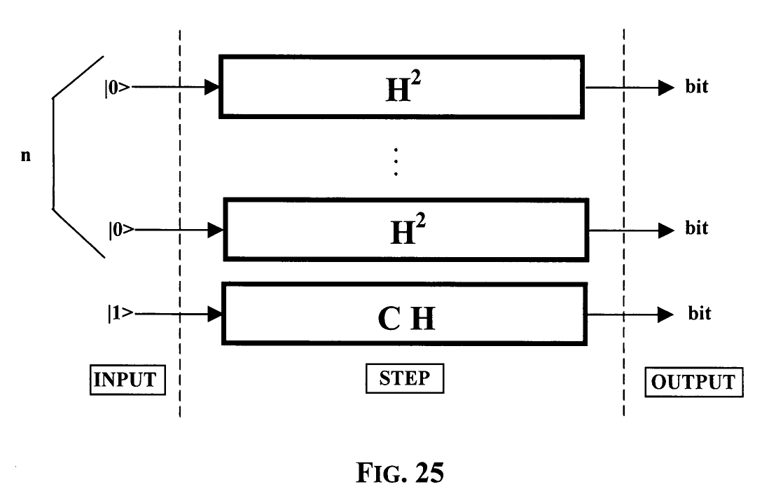

The resulting circuit representation according to FIG. 22c is reported in FIG. 23. By combining the sub-gates acting on every vector of dimension 2 in input, the circuit in FIG. 24 is obtained.

Let's observe that every vector in input evolves independently from other vectors. This is because operator U_{F} doesn't create any correlation. So, the evolution of every input vector can be analyzed separately. This circuit can be written in a simpler way as shown in FIG. 25, observing that M·I=M.

We can easily show that:

H²=I

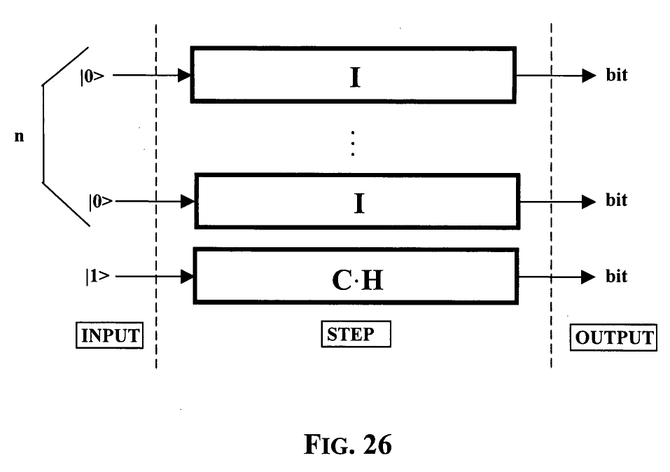

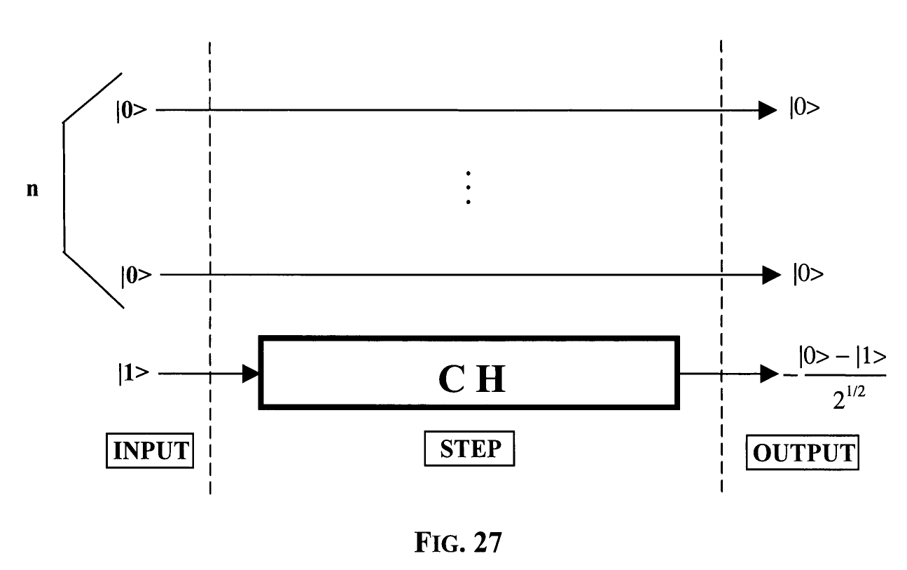

Therefore the circuit is rewritten in this way as shown in FIG. 26.

Let's now consider the effect of the operators acting on every vector:

$$I \vert 0 〉 = \vert 0 〉 C \cdot H \vert 1 〉 = - \frac{\vert 0 〉 - \vert 1 〉}{\sqrt{2}}$$

Using these results, the circuit shown in FIG. 27 is obtained as the particular case of the structure shown in FIG. 22d. It is easy to see that, if f is constant with value 1, the first n vectors are preserved.

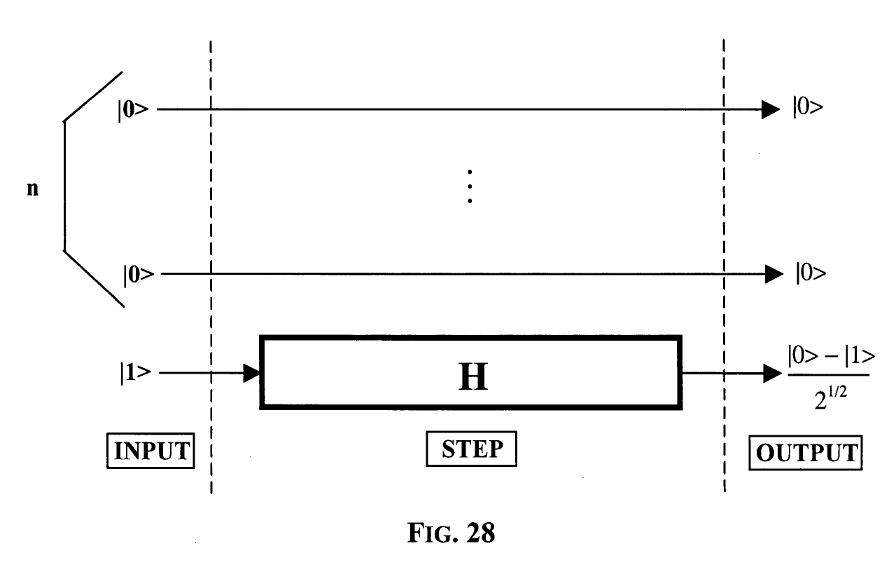

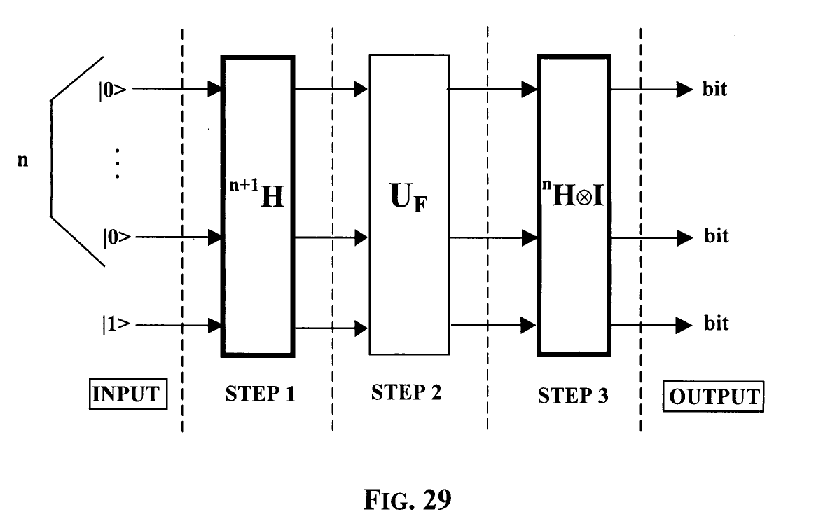

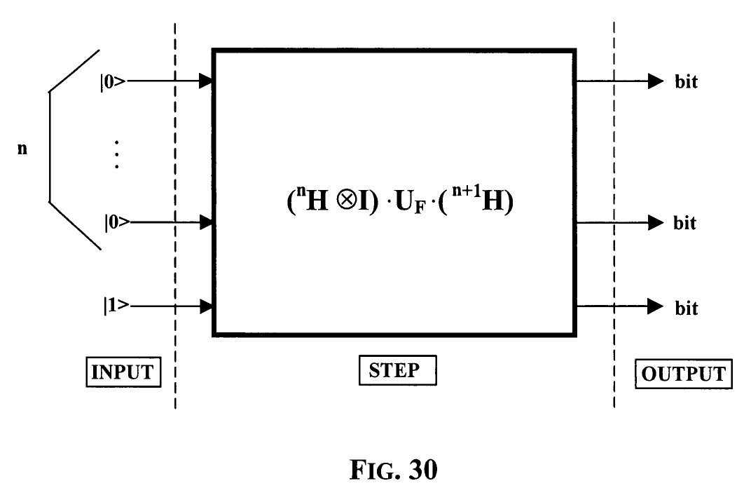

B. Constant function with value 0 A similar analysis can be repeated for a constant function with value 0. In this situation U_{F} can be written as ⁿI [symbol] H and the final circuit is shown on the FIG. 28. Also in this case, the first n input vectors are preserved. So, their output values after the quantum gate has acted are still |0>.

C. General case (n=2) The gate implementing Deutsch-Jozsa's algorithm in the general case is shown in the FIGS. 29 and 30. If n=2, U_{F} has the following form:

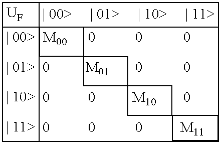

where Mᵢε{I, C}, i=00, 01, 10, 11.

Let's calculate the quantum gate G=(²H [symbol] I)·U_{F}·(²⁺¹H) in this case:

| ³H | \|00> | \|01> | \|10> | \|11> |
|---|---|---|---|---|
| \|00> | H/2 | H/2 | H/2 | H/2 |
| \|01> | H/2 | −H/2 | H/2 | −H/2 |
| \|10> | H/2 | H/2 | −H/2 | −H/2 |
| \|11> | H/2 | −H/2 | −H/2 | H/2 |

| ²H [symbol] I | \|00> | \|01> | \|10> | \|11> |
|---|---|---|---|---|
| \|00> | I/2 | I/2 | I/2 | I/2 |
| \|01> | I/2 | −I/2 | I/2 | −I/2 |
| \|10> | I/2 | I/2 | −I/2 | −I/2 |
| \|11> | I/2 | −I/2 | −I/2 | I/2 |

| U_{F} · ³H | \|00> | \|01> | \|10> | \|11> |
|---|---|---|---|---|
| \|00> | M₀₀H/2 | M₀₀H/2 | M₀₀H/2 | M₀₀H/2 |
| \|01> | M₀₁H/2 | −M₀₁H/2 | M₀₁H/2 | −M₀₁H/2 |
| \|10> | M₁₀H/2 | M₁₀H/2 | −M₁₀H/2 | −M₁₀H/2 |
| \|11> | M₁₁H/2 | −M₁₁H/2 | −M₁₁H/2 | M₁₁H/2 |

| G | \|00> | \|01> | \|10> | \|11> |
|---|---|---|---|---|
| \|00> | (M₀₀ + M₀₁ + M₁₀ + M₁₁)H/4 | (M₀₀ − M₀₁ + M₁₀ − M₁₁)H/4 | (M₀₀ + M₀₁ − M₁₀ − M₁₁)H/4 | (M₀₀ − M₀₁ − M₁₀ + M₁₁)H/4 |
| \|01> | (M₀₀ − M₀₁ + M₁₀ − M₁₁)H/4 | (M₀₀ + M₀₁ + M₁₀ + M₁₁)H/4 | (M₀₀ − M₀₁ − M₁₀ + M₁₁)H/4 | (M₀₀ + M₀₁ − M₁₀ − M₁₁)H/4 |
| \|10> | (M₀₀ + M₀₁ − M₁₀ − M₁₁)H/4 | (M₀₀ − M₀₁ − M₁₀ + M₁₁)H/4 | (M₀₀ + M₀₁ + M₁₀ + M₁₁)H/4 | (M₀₀ − M₀₁ + M₁₀ − M₁₁)H/4 |
| \|11> | (M₀₀ − M₀₁ − M₁₀ + M₁₁)H/4 | (M₀₀ + M₀₁ − M₁₀ − M₁₁)H/4 | (M₀₀ − M₀₁ + M₁₀ − M₁₁)H/4 | (M₀₀ + M₀₁ + M₁₀ + M₁₁)H/4 |

Now, consider the application of G to vector |001>:

$$G \vert 001 〉 = \frac{1}{4} \vert 00 〉 ⊗ ( {M}_{00} + {M}_{01} + {M}_{10} + {M}_{11} ) H \vert 1 〉 + \frac{1}{4} \vert 01 〉 ⊗ ( {M}_{00} - {M}_{01} + {M}_{10} - {M}_{11} ) H \vert 1 〉 ++ \frac{1}{4} \vert 10 〉 ⊗ ( {M}_{00} + {M}_{01} - {M}_{10} - {M}_{11} ) H \vert 1 〉 + \frac{1}{4} \vert 11 〉 ⊗ ( {M}_{00} - {M}_{01} - {M}_{10} + {M}_{11} ) H \vert 1 〉$$

Consider the operator (M₀₀+M₀₁+M₁₀+M₁₁)H under the hypotheses of balanced functions Mᵢε{I, C} and |{M: Mᵢ=I}|=|{Mᵢ: Mᵢ=C}|. Then:

| M₀₀ + M₀₁ + M₁₀ + M₁₁ | \|0> | \|1> |
|---|---|---|
| \|0> | 2 | 2 |
| \|1> | 2 | 2 |

| (M₀₀ + M₀₁ + M₁₀ + M₁₁)H/4 | \|0> | \|1> |
|---|---|---|
| \|0> | 1/2^{1/2} | 0 |
| \|1> | 1/2^{1/2} | 0 |

### Thus:

$$\frac{1}{4} ( {M}_{00} + {M}_{01} + {M}_{10} + {M}_{11} ) H \vert 1 〉 = 0$$

This means that the probability amplitude of vector |001> of being mapped into a vector |000> or |001> is null.

Consider now the operators:

(M₀₀+M₀₁+M₁₀+M₁₁)H

(M₀₀−M₀₁+M₁₀−M₁₁)H

(M₀₀+M₀₁−M₁₀−M₁₁)H

(M₀₀−M₀₁−M₁₀+M₁₁)H

under the hypotheses ∀i: Mᵢ=I, which holds for constant functions with values 0:

| M₀₀ + M₀₁ + M₁₀ + M₁₁ | \|0> | \|1> |
|---|---|---|
| \|0> | 4 | 0 |
| \|1> | 0 | 4 |

| (M₀₀ + M₀₁ + M₁₀ + M₁₁)H/4 | \|0> | \|1> |
|---|---|---|
| \|0> | 1/2^{1/2} | 1/2^{1/2} |
| \|1> | 1/2^{1/2} | −1/2^{1/2} |

| M₀₀ − M₀₁ + M₁₀ − M₁₁ | \|0> | \|1> |
|---|---|---|
| \|0> | 0 | 0 |
| \|1> | 0 | 0 |

| M₀₀ + M₀₁ − M₁₀ − M₁₁ | \|0> | \|1> |
|---|---|---|
| \|0> | 0 | 0 |
| \|1> | 0 | 0 |

| M₀₀ − M₀₁ − M₁₀ + M₁₁ | \|0> | \|1> |
|---|---|---|
| \|0> | 0 | 0 |
| \|1> | 0 | 0 |

Using these calculations, we obtain the following results:

$$\frac{1}{4} ( {M}_{00} - {M}_{01} + {M}_{10} - {M}_{11} ) H \vert 1 〉 = 0 \\ \frac{1}{4} ( {M}_{00} + {M}_{01} - {M}_{10} - {M}_{11} ) H \vert 1 〉 = 0 \\ \frac{1}{4} ( {M}_{00} - {M}_{01} - {M}_{10} + {M}_{11} ) H \vert 1 〉 = 0$$

This means that the probability amplitude of vector |001> of being mapped into a superposition of vectors |010>, |011>, |100>, |101>, |110>, |111> is null. The only possible output is a superposition of vectors |000> and |001>, as we showed before using circuits. A similar analysis can be developed under the hypotheses ∀i: Mᵢ=C.

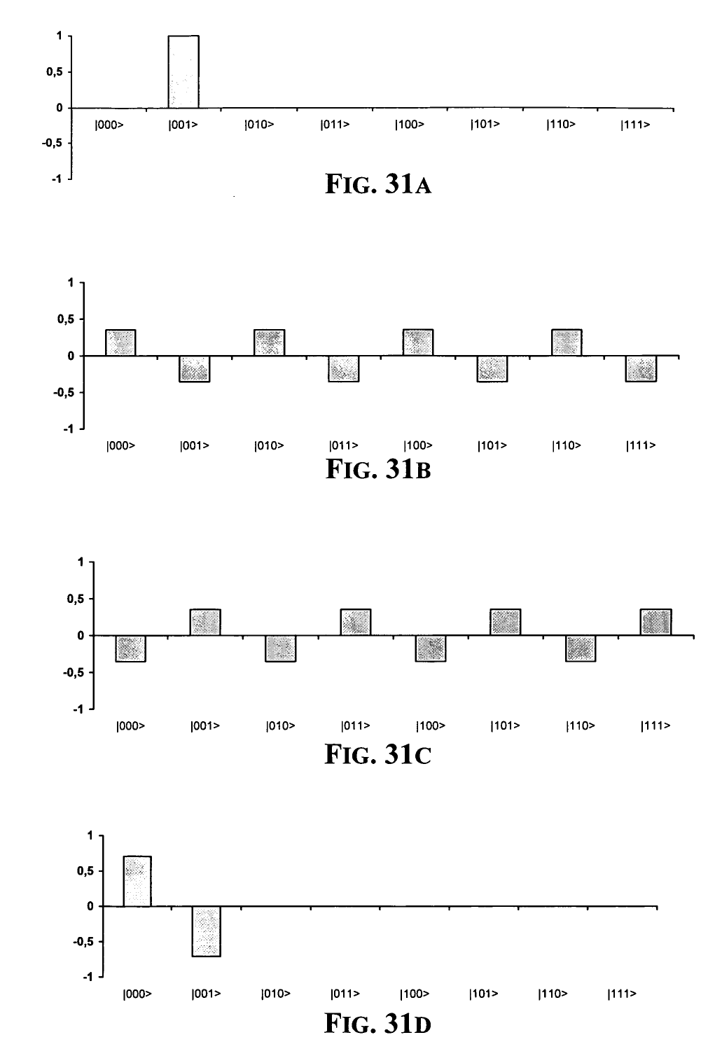

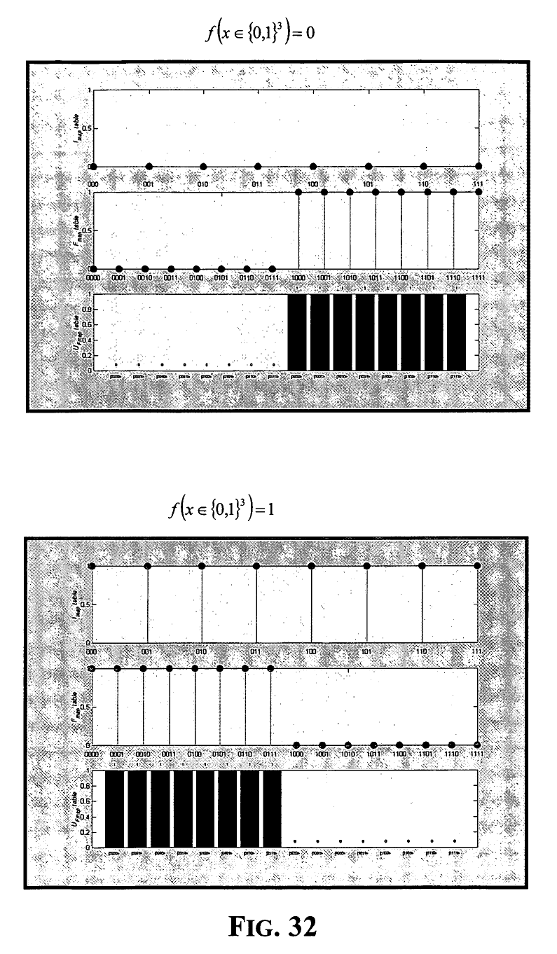

It is useful to outline the evolution of the probability amplitudes of every basis vector while operator ³H, U_{F} and ²H [symbol] I are applied in sequence, for instance when f has constant value 1. This is done in FIGS. 31a to 31d.

Operator ³H in FIG. 31b puts the initial canonical basis vector |001> into a superposition of all basis vectors with the same (real) coefficients in modulus, but with positive sign if the last vector is |0>, negative otherwise. Operator U_{F} in FIG. 31c in this case does not create correlation: it flips the third vector independently from the values of the first two vectors.

Finally, ²H [symbol] I in FIG. 31d produces interference: for every basis vector |x₀x₁y₀> it calculates its output probability amplitude α′ₓ_{₀}ₓ_{₀}_{y}_{₀} as the summation of the probability amplitudes of all basis vectors in the form |x₀x₁y₀> in the input superposition, all with the same sign if |x₀x₁>=|00>, otherwise changing the sign of exactly the middle of the probability amplitudes.

Since, in this case, the vectors in the form |x₀x₁0> have the same (negative real) probability amplitude and vectors in the form |x₀x₁1> have the same (positive real) probability amplitude, when |x₀x₁>=|00>, probability amplitudes interfere positively. Otherwise the terms in the summation interfere destructively annihilating the result.

D. General case (n>0) In the general case n>0, U_{F} has the following form:

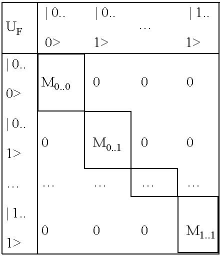

where Mᵢε{I, C}, iε{0,1}ⁿ.

Let's calculate the quantum gate G=(ⁿH [symbol] I)·U_{F}·(ⁿ⁺¹H):

| ⁿ⁺¹H | \|0 . . . 0> | . . . | \|j> | . . . | \|1 . . . 1> |
|---|---|---|---|---|---|
| \|0 . . . 0> | H/2^{n/2} | . . . | H/2^{n/2} | . . . | H/2^{n/2} |
| . . . | . . . | . . . | . . . | . . . | . . . |
| \|i> | H/2^{n/2} | . . . | (−1)^{i·j}H/2^{n/2} | . . . | (−1)^{i·(1 . . . 1)}H/2^{n/2} |
| . . . | . . . | . . . | . . . | . . . | . . . |
| \|11> | H/2^{n/2} | . . . | (−1)^{(1 . . . 1)·j}H/2^{n/2} | . . . | (−1)^{(1 . . . 1)·(1 . . . 1)}H/2^{n/2} |

Here we employed binary string operator ·, which represents the parity of the AND bit per bit between two strings.

Priority of bit per bit AND. Given two binary strings x and y of length n, we define:

x·y=x₁·y₁⊕x₂·y₂⊕ . . . ⊕xₙ·yₙ

The symbol · used between two bits is interpreted as the logical AND operator.

We shall prove that matrix ⁿ⁺¹H really has the described form. We show that:

$${[ {}^{n} H ]}_{ij} = \frac{{( - 1 )}^{i \cdot j}}{{2}^{n / 2}}$$

The proof is by induction:

$$n = 1 \text{:} \begin{matrix}{[ {}^{1} H ]}_{0 , 0} = \frac{1}{{2}^{1 / 2}} = \frac{{( - 1 )}^{( 0 ) \cdot ( 0 )}}{{2}^{1 / 2}} & {[ {}^{1} H ]}_{0 , 1} = \frac{1}{{2}^{1 / 2}} = \frac{{( - 1 )}^{( 0 ) \cdot ( 1 )}}{{2}^{1 / 2}} \\ {[ {}^{1} H ]}_{1 , 0} = \frac{1}{{2}^{1 / 2}} = \frac{{( - 1 )}^{( 1 ) \cdot ( 0 )}}{{2}^{1 / 2}} & {[ {}^{1} H ]}_{1 , 1} = \frac{- 1}{{2}^{1 / 2}} = \frac{{( - 1 )}^{( 1 ) \cdot ( 1 )}}{{2}^{1 / 2}}\end{matrix}$$

$$n > 1 \text{:} \begin{matrix}{[ {}^{n} H ]}_{i 0 , j 0} = {\frac{1}{{2}^{1 / 2}} [ {}^{n - 1} H ]}_{i , j} = \frac{1}{{2}^{1 / 2}} \frac{{( - 1 )}^{i \cdot j}}{{2}^{( n - 1 ) / 2}} = \frac{{( - 1 )}^{( i 0 ) \cdot ( j 0 )}}{{2}^{n / 2}} \\ {[ {}^{n} H ]}_{i 0 , j 1} = {\frac{1}{{2}^{1 / 2}} [ {}^{n - 1} H ]}_{i , j} = \frac{1}{{2}^{1 / 2}} \frac{{( - 1 )}^{i \cdot j}}{{2}^{( n - 1 ) / 2}} = \frac{{( - 1 )}^{( i 0 ) \cdot ( j 1 )}}{{2}^{n / 2}} \\ {[ {}^{n} H ]}_{i 1 , j 0} = {\frac{1}{{2}^{1 / 2}} [ {}^{n - 1} H ]}_{i , j} = \frac{1}{{2}^{1 / 2}} \frac{{( - 1 )}^{i \cdot j}}{{2}^{( n - 1 ) / 2}} = \frac{{( - 1 )}^{( i 1 ) \cdot ( j 0 )}}{{2}^{n / 2}} \\ {[ {}^{n} H ]}_{i 1 , j 1} = - {\frac{1}{{2}^{1 / 2}} [ {}^{n - 1} H ]}_{i , j} = - \frac{1}{{2}^{1 / 2}} \frac{{( - 1 )}^{i \cdot j}}{{2}^{( n - 1 ) / 2}} = \frac{{( - 1 )}^{( i 1 ) \cdot ( j 1 )}}{{2}^{n / 2}}\end{matrix}$$

Matrix ⁿ⁺¹H is obtained from ⁿH by tensor product. Similarly, matrix ⁿH [symbol] I is calculated:

| ⁿH [symbol] I | \|0 . . . 0> | . . . | \|j> | . . . | \|1 . . . 1> |
|---|---|---|---|---|---|
| \|0 . . . 0> | I/2^{n/2} | . . . | I/2^{n/2} | . . . | I/2^{n/2} |
| . . . | . . . | . . . | . . . | . . . | . . . |
| \|i> | I/2^{n/2} | . . . | (−1)^{i·j}I/2^{n/2} | . . . | (−1)^{i·(1 . . . 1)}I/2^{n/2} |
| . . . | . . . | . . . | . . . | . . . | . . . |
| \|11> | I/2^{n/2} | . . . | (−1)^{(1 . . . 1)·j}I/2^{n/2} | . . . | (−1)^{(1 . . . 1)·(1 . . . 1)}I/2^{n/2} |

| U_{F} · ⁿ⁺¹H | \|0 . . . 0> | . . . | \|j> | . . . | \|1 . . . 1> |
|---|---|---|---|---|---|
| \|0 . . . 0> | M_{0 . . . 0}H/2^{n/2} | . . . | M_{0 . . . 0}H/2^{n/2} | . . . | M_{0 . . . 0}H/2^{n/2} |
| . . . | . . . | . . . | . . . | . . . | . . . |
| \|i> | MᵢH/2^{n/2} | . . . | (−1)^{i·j}MᵢH/2^{n/2} | . . . | (−1)^{i·(1 . . . 1)}MᵢH/2^{n/2} |
| . . . | . . . | . . . | . . . | . . . | . . . |
| \|1 . . . 1> | M_{1 . . . 1}H/2^{n/2} | . . . | (−1)^{(1 . . . 1)·j}M_{1 . . . 1}H/2^{n/2} | . . . | (−1)^{(1 . . . 1)·(1 . . . 1)}M_{1 . . . 1}H/2^{n/2} |

We calculated only the first column of gate G since this operator is applied exclusively to input vector |0..01> and so only the first column is involved.

| G | \|0 . . . 0> | . . . |
|---|---|---|
| \|0 . . . 0> | (M_{0 . . . 0} + . . . + Mᵢ + . . . + M_{1 . . . 1})H/2ⁿ | . . . |
| . . . | . . . | . . . |
| \|i> | (Σ_{jε{0, 1}}_{ⁿ} (−1)^{i·j}Mⱼ)H/2ⁿ | . . . |
| . . . | . . . | . . . |
| \|1 . . . 1> | (Σ_{jε{0, 1}}_{ⁿ} (−1)^{(1 . . . 1)·j}Mⱼ)H/2ⁿ | . . . |

Now consider the case of f constant. We saw that this means that all matrices Mᵢ are identical.

This implies:

$$\frac{1}{{2}^{n}} ( {\sum }_{j} {( - 1 )}^{i \cdot j} {M}_{j} ) H = 0$$

since in this summation the number of +1 equals the number of −1. Therefore, the input vector |0.01> is mapped into a superposition of vectors |0.00> and |0..01> as we showed using circuits.

If f is balanced, the number of Mᵢ=1 equals the number of Mᵢ=C. This implies:

$$\frac{1}{{2}^{n}} ( {\sum }_{j} {M}_{j} ) H = \frac{1}{{2}^{n}} ( {2}^{n - 1} I + {2}^{n - 1} C ) H = \frac{1}{2} [ \begin{matrix}1 & 1 \\ 1 & 1\end{matrix} ] H = \frac{1}{2 \sqrt{2}} [ \begin{matrix}1 & 1 \\ 1 & 1\end{matrix} ] [ \begin{matrix}1 & 1 \\ 1 & - 1\end{matrix} ] = \frac{1}{\sqrt{2}} [ \begin{matrix}1 & 0 \\ 1 & 0\end{matrix} ]$$

And therefore:

$$\frac{1}{{2}^{n}} ( {\sum }_{j} {M}_{j} ) H \vert 1 〉 = 0$$

This means that input vector |0..01>, in the case of balanced functions, can't be mapped by the quantum gate into a superposition containing vectors |0..00> or |0..01>.

The quantum block terminates with measurement. Considering the results showed till now, we can determine the possible outputs of measurement and their probabilities:

| Superposition of Basis | | |
|---|---|---|
| Vectors | Result of Measurement | |
| Before Measurement | Vector | Probability |
| Constant functions: | \|0 . . . 00> | \|\|α₀\|\|² |
| G\|0 . . . 01> = \|0 . . . 0 > [symbol] (α₀\| | \|0 . . . 01> | \|\|α₁\|\|² |
| 0> + α₁\|1>) | | |
| Balanced functions: | ∀iε{0, 1}ⁿ − | \|\|αᵢ\|\|² |
| G\|0 . . . 01> = Σ_{iε{0, 1}}_{ⁿ}_{-{0 . . . 00,} | {0 . . . 00, 0 . . . 01}: | |
| _{0 . . . 01}} αᵢ\|i> | \|1> | |

The set A-B is given by all elements of A, unless those elements belong to B also. This set is sometimes denoted as A/B. The quantum block is repeated only one time in Deutsch-Jozsa's algorithm. So, the final collection is made only by one vector.

4.2.3. Decoder As in Deutsch's algorithm, when the final basis vector has been measured, we must interpret it in order to decide if f is constant or balanced. If the resulting vector is |0..0> we know that the function was constant, otherwise we decide that it is balanced. In fact gate G produces a vector such that, when it is measured, only basis vectors |0..00> and ≡0..01> have a non-null probability amplitude exclusively in the case f is constant. Besides, if f is balanced, these two vectors have null coefficients in the linear combination of basis vectors generated by G. In this way, the resulting vector is easily decoded in order to answer Deutsch-Jozsa's problem:

| Resulting Vector after | |
|---|---|
| Measurement | Answer |
| \|0 . . . 00> | f is constant |
| \|0 . . . 01> | f is constant |
| otherwise | f is balanced |

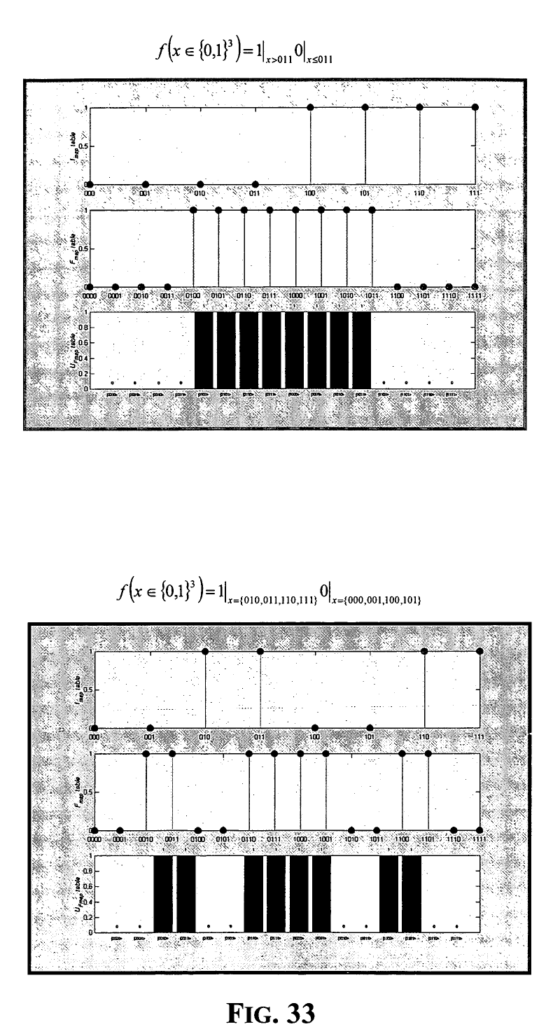

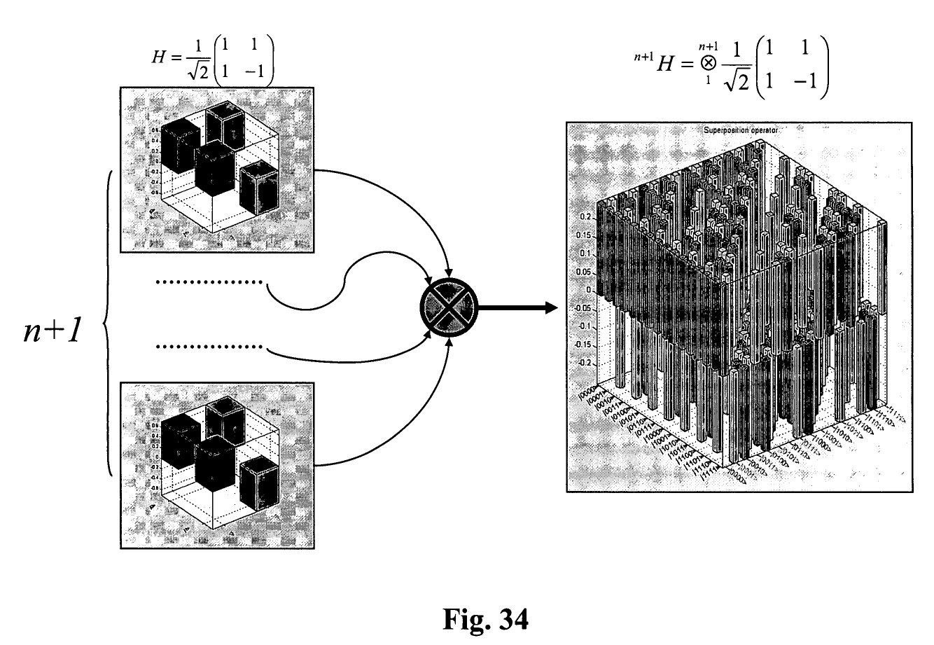

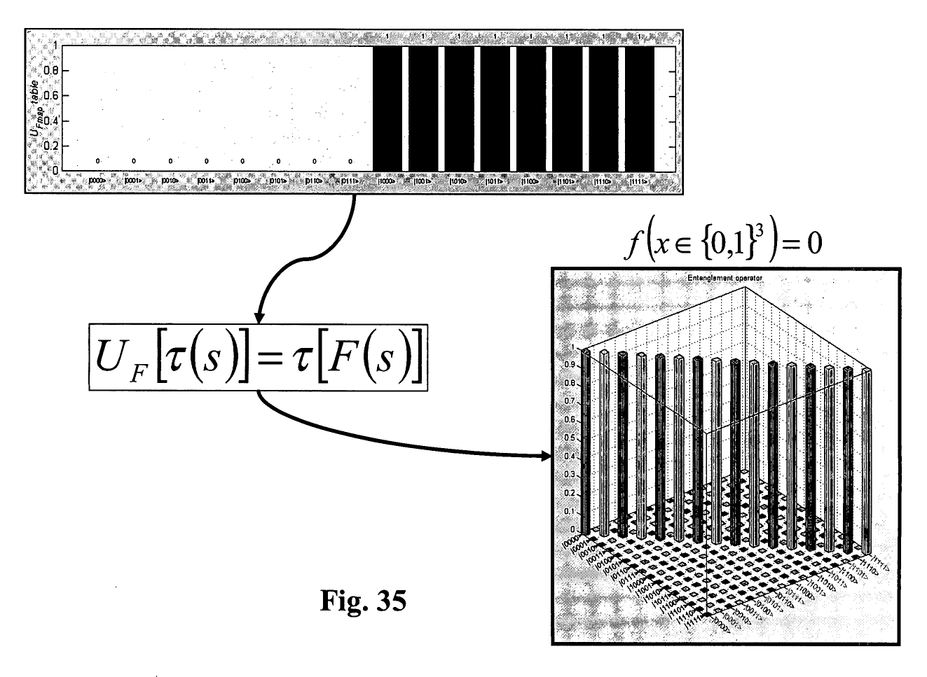

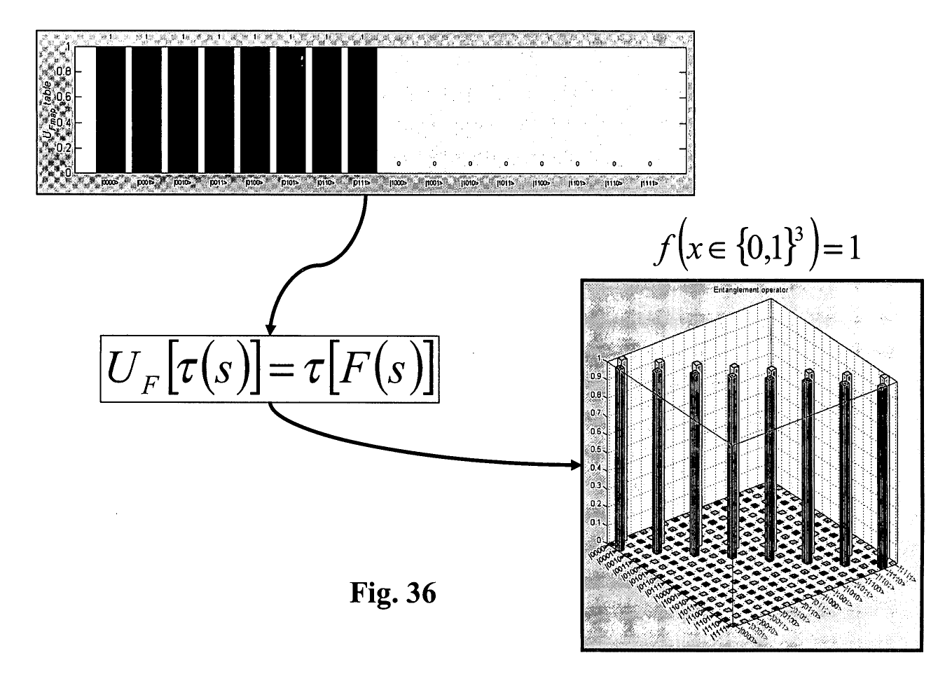

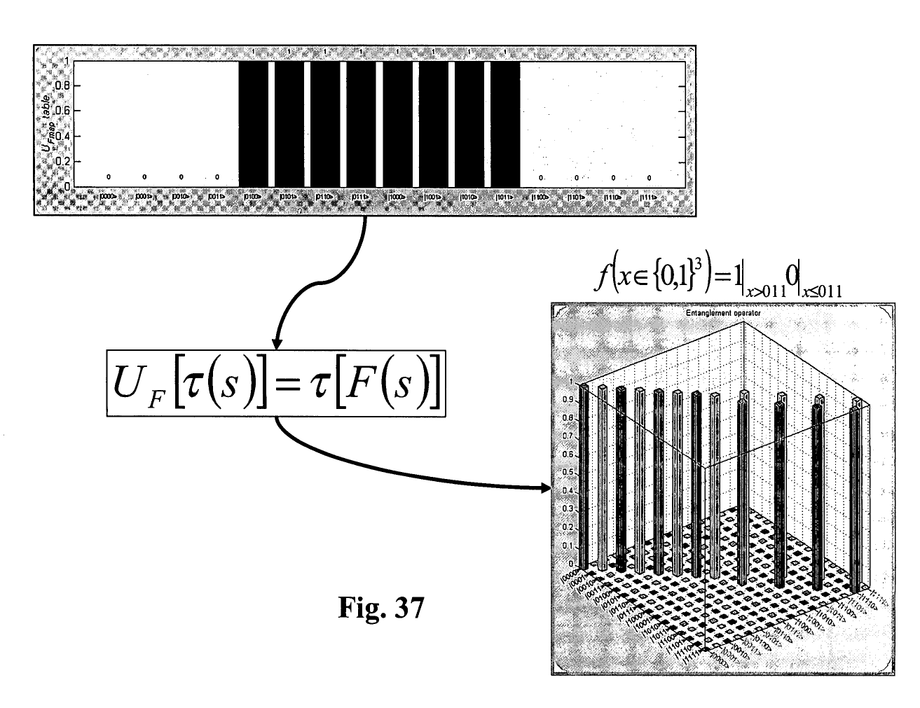

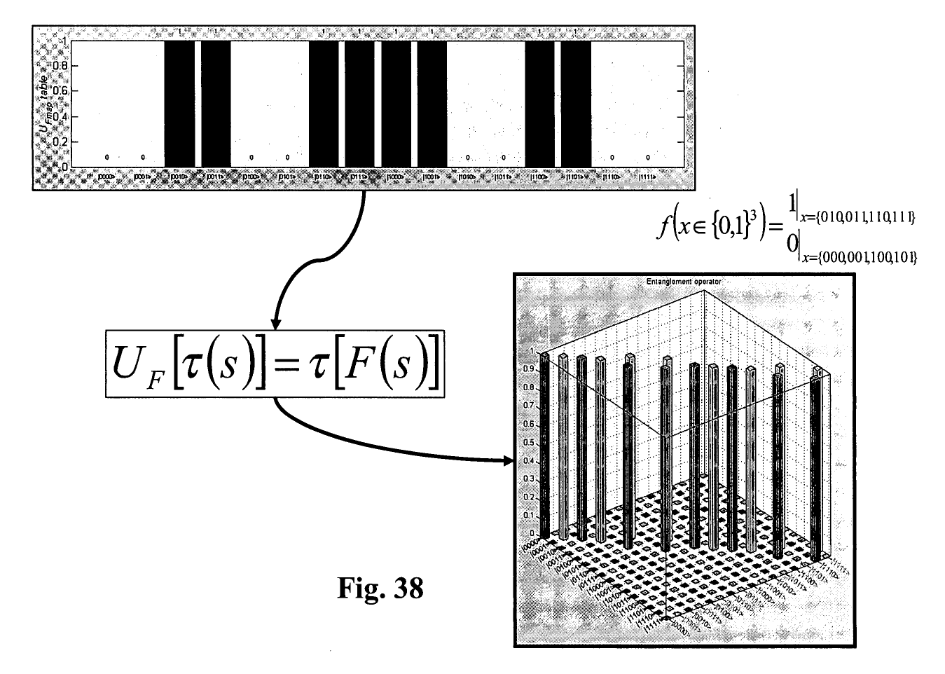

4.2.4. Computer design process of Deutsch-Jozsa's quantum algorithm gate (D.-J. QAG) and simulation results. Let us consider the design process of D.-J. QAG according to the steps represented in FIG. 21. For step 0 (Encoding), case n=3, examples of constant and balanced functions encoding in FIGS. 32 and 33, accordingly, are shown. For step 1 in FIG. 21, the example of quantum operator preparation such as superposition operator in FIG. 34 is shown. FIGS. 35-38 shows the step 1.2 from FIG. 21 as the preparation of entanglement operators:

For constant function

case f(ε{0,1}³=0) and f(ε{0,1}³=1) in FIGS. 34 and 35;

for balanced function

case f(ε{0,1}³=1|_{x>011}0|_{x≦011}) and

$$f ( ∈ {\{ 0 , 1 \}}^{3} = \{ \begin{matrix}1 & x = \{ 010 , 011 , 110 , 111 \} \\ 0 & x = \{ 000 , 001 , 100 , 101 \}\end{matrix} ) ,$$

accordingly.

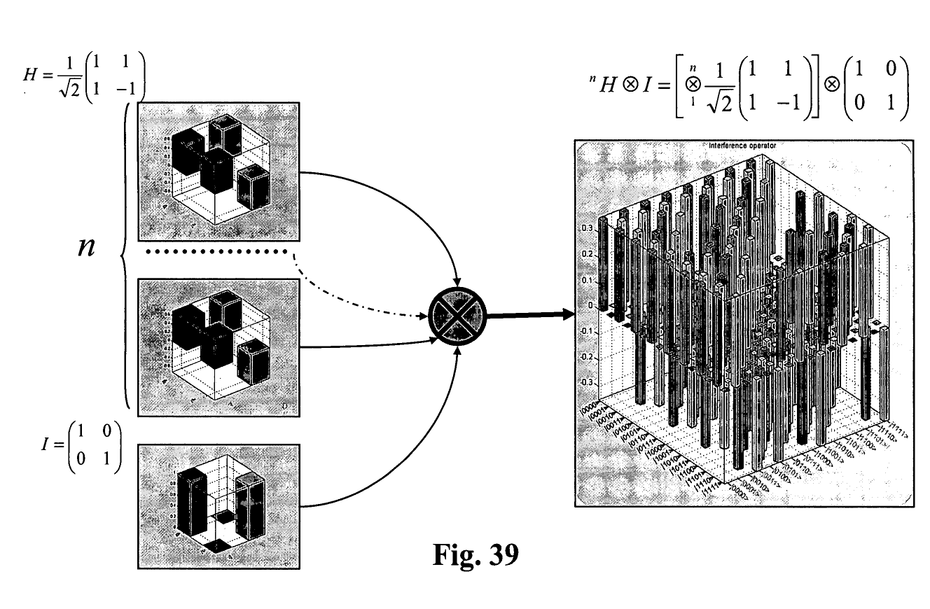

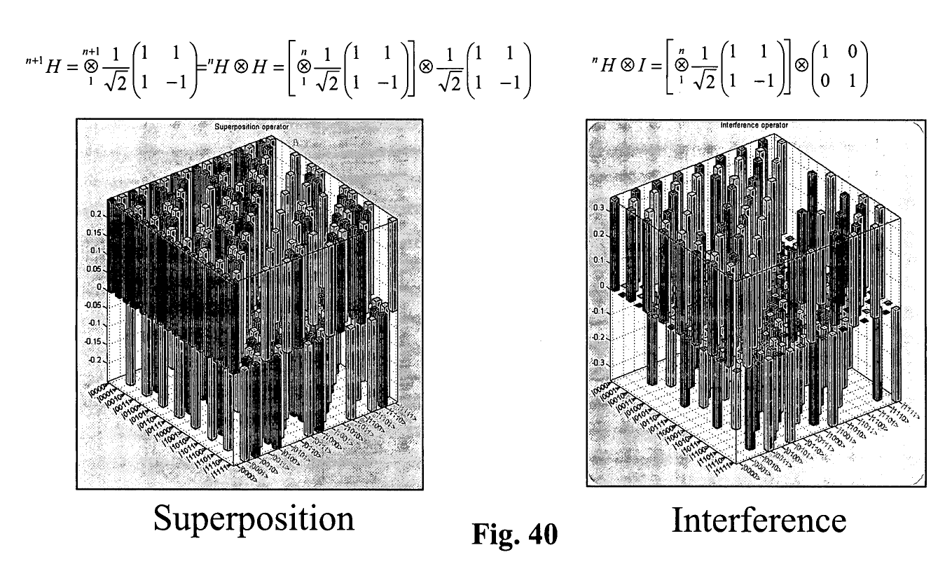

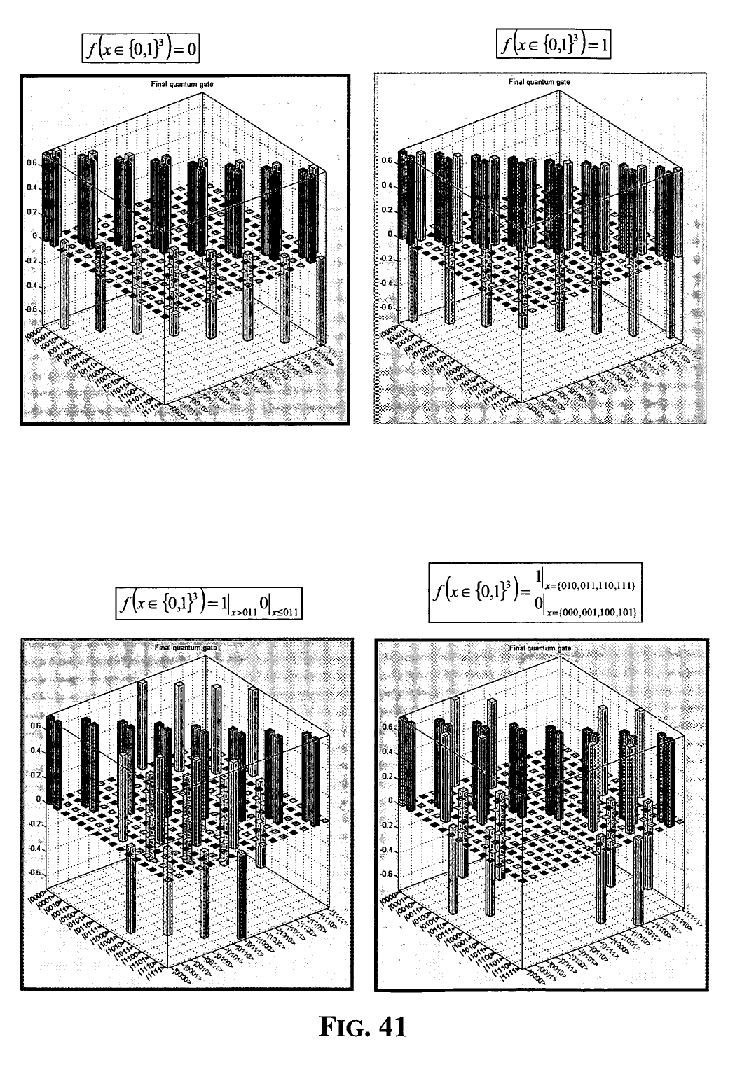

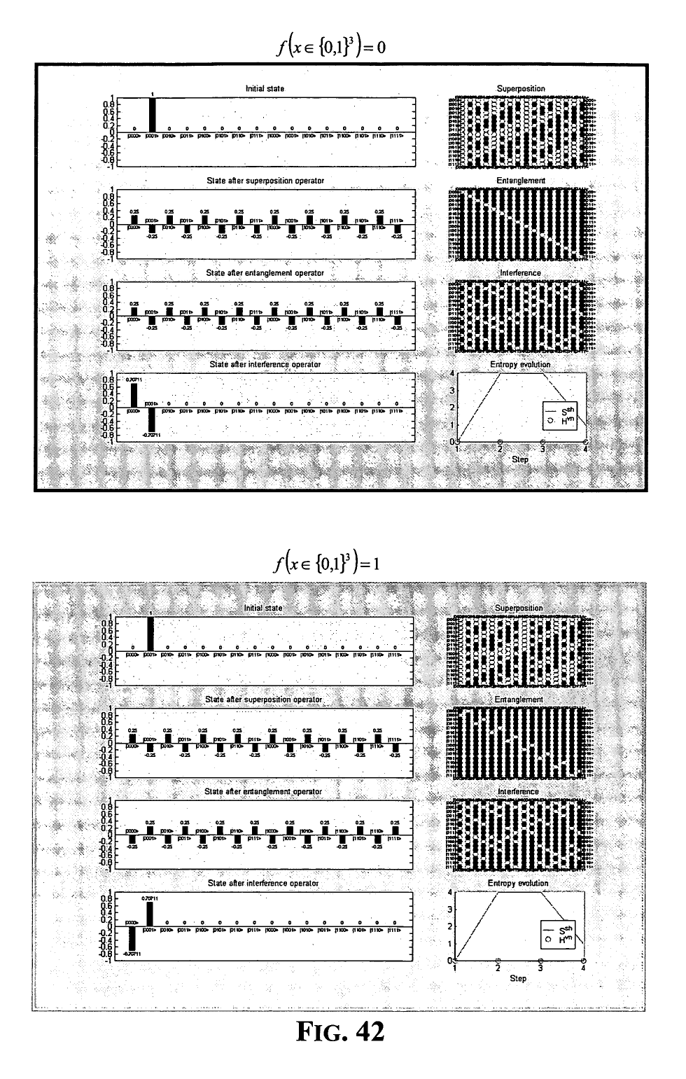

Step 1.3 in FIG. 21 as the preparation of interference operator in FIG. 39 is shown. Comparison between superposition and interference operators in FIG. 40 is shown. The evolution of gate design process form FIG. 21 is shown in FIG. 41.

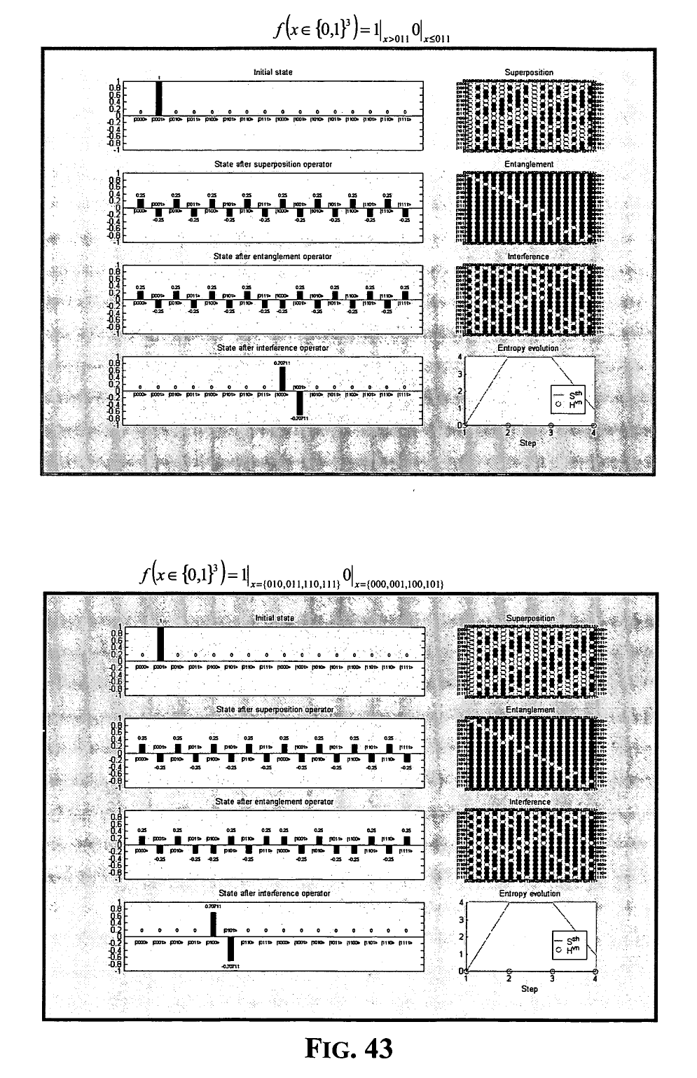

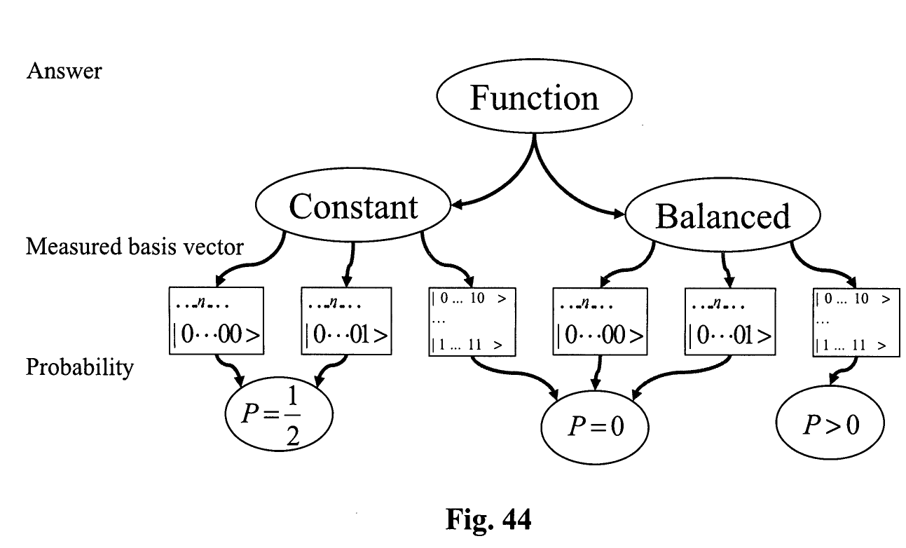

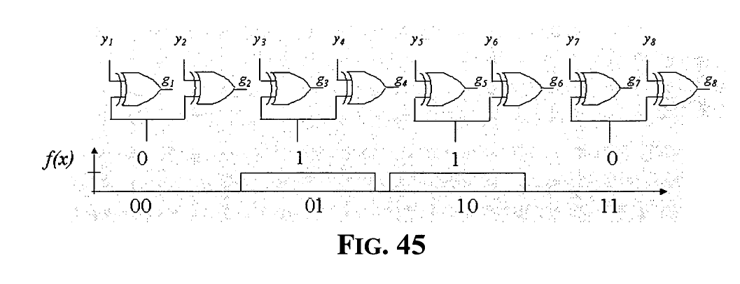

Step 1.4 from FIG. 21 as quantum gate assembly in FIG. 41 for design cases is shown. FIGS. 42 and 43 show the results of algorithm gate execution for constant and balanced functions accordingly (as the step 2 from FIG. 21). Result interpretation (as the step 2.4 from FIG. 21) is shown in FIG. 44.

In Deutsch-Jozsa's QA the mathematical and physical structures of the interference operator (ⁿH [symbol] I) differ from its superposition operator (ⁿ⁺¹H). The interference operator extracts the qualitative information about the property (constant or balanced property of function f) with operator ⁿH, and separate this property qualitatively with operator I. Deutsch-Jozsa's QA is a decision-making algorithm. For the case of Deutsch-Jozsa's QA only one's iteration is needed without estimation quantitatively the qualitative property of function f and with error probability 0.5 of successful result. It means that the Deutsch-Jozsa's QA is a robust QA. The main role in this decision-making QA plays the superposition and entanglement operators that organize quantum massive parallel computation process (by superposition operator) and robust extraction of function property (by entanglement operator).

4.2.5. Analog description of Deutsch-Jozsa's QA-Operators and Gate-Superposition As reported in FIG. 22, in Deutsch-Jozsa algorithm, the gate is prepared with first n qubits set to |0> and qubit n+1 set to |1>. Since superposition block is constituted by H [symbol] H [symbol] . . . [symbol] H=ⁿH, the output vector Y can be represented in the following way:

Y=[y₁y₂ . . . yᵢ . . . y₂ⁿ⁺¹]

where yᵢ=(−1)ⁱ⁺¹/2^{(n+1)/2}.

It must be noted that this formula is very general and, due to the particular initial configuration of qubits in the present algorithm, it avoids the use of AND gates providing directly the output vector Y. The dimension n is taken into account by varying index i from 1 to 2ⁿ⁺¹. As it will be seen in following sections, the same formula will be used for Grover's algorithm, too.

B. Entanglement In Deutsch-Jozsa's algorithm the Entanglement matrix U_{F} has the same diagonal structure independent from the number of qubits, in fact, the 2×2 well known blocks I and C are always present on principal diagonal. This happens due to the fact that f:{0,1}ⁿ→{0,1}, meaning that encoding function f is scalar and therefore the complete evaluation of U_{F} can be avoided by using the input-output approach. So if we consider for example the following expression for f in a 2-qubits case (balanced function)

$$\{ \begin{matrix}f ( 01 ) = f ( 10 ) = 1 \\ f ( \cdot ) = 0 elsewhere\end{matrix}$$

Of course in Deutsch-Jozsa's entanglement, binary function f could assume more than twice value “1”, but the upper example is taken for sake of simplicity. The output of entanglement G=U_{F}·Y can be directly calculated, as shown in the European patent application EP 1 380 991, by using 2ⁿ⁺¹=8 XOR gates, suitably driven by the encoding function f. In fact, the general form of the entanglement output vector G can be the following:

G=[g₁g₂ . . . gᵢ . . . g₂ⁿ⁺¹]

And, therefore, according to the scheme in FIG. 45, gᵢ=yᵢ⊕f_{1+INT(i-1)/2} where yᵢ is the general term of superposition transformed in a suitable binary value.

C. Interference A more difficult task is to deal with interference. In fact, differently from Entanglement, Interference matrix ⁿ⁺¹H is not a pseudo-diagonal matrix and therefore it is full of nonzero elements. Moreover, the presence of tensor products, whose number increases dramatically with the dimensions, constitutes an important point at this step. In order to find a suitable input-output relation, it must be considered that the general term of ⁿ⁺¹H can be written as

$${}_{}^{n}{h}{}_{ij}^{} = {\frac{( - 1 )}{{2}^{n / 2}} }^{{\sum }_{k = 0}^{n - 1} INT ( \frac{i - 1}{{2}^{k}} ) INT ( \frac{j - 1}{{2}^{k}} )}$$

To this aim, being gᵢ the generic term belonging to the input vector, the output vector V=(ⁿ⁺¹H)G can be derived as follows:

$${v}_{i} = {\sum }_{j = 1}^{{2}^{n + 1}} {g}_{j} {\frac{( - 1 )}{{2}^{n / 2}} }^{{\sum }_{k = 0}^{n - 1} INT ( \frac{i - 1}{{2}^{k}} ) INT ( \frac{j - 1}{{2}^{k}} )}$$

It must be noted that only sums and differences are necessary and therefore a possible hardware structure could be constituted by a certain number of OPAMPS in which their configuration could be set to “inverting” or “not inverting” in a suitable way. The value 1/2^{n/2} depends only by the number n of qubits and can be considered as the scaling value of the sum and decided by a suitable choice of feedback resistors.

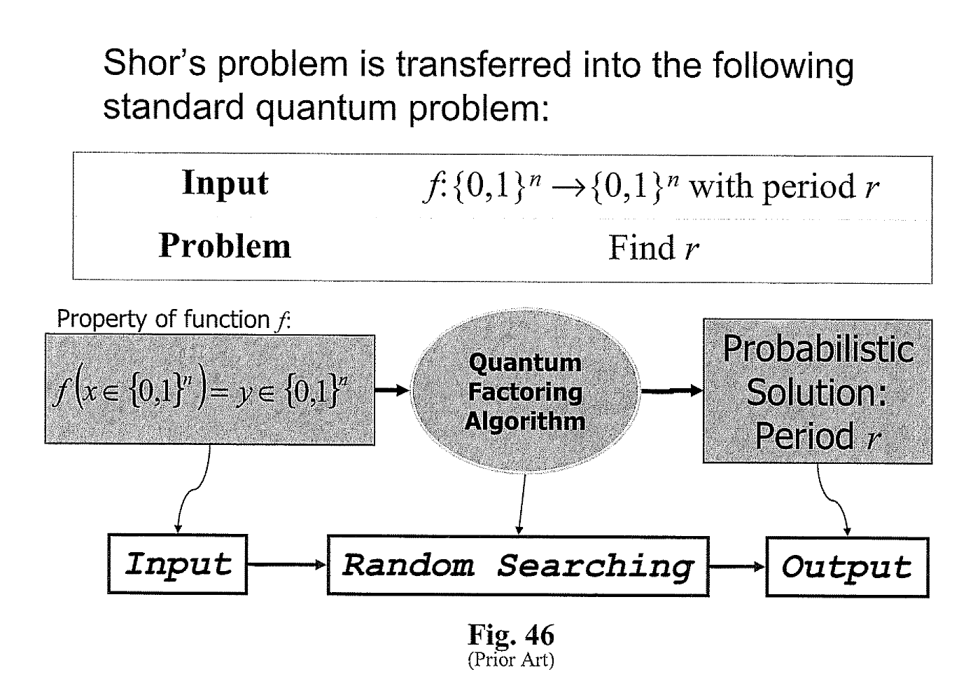

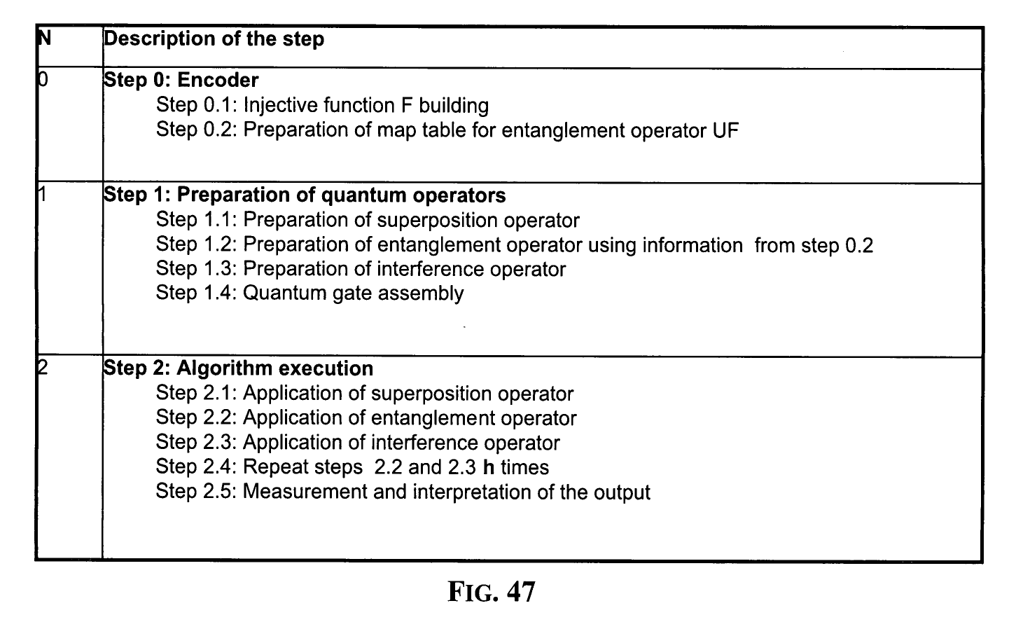

4.3. Analog description of Shor QA-operators and Gate The Shor's quantum algorithm is well known in the art. For sake of simplicity it is summarized in FIG. 46 and will not be described herein in detail.

By applying the same reasoning carried out for the Deutsch-Jozsa's quantum algorithm it is possible to define the design steps according to this invention, illustrated in FIG. 47.

SUPERPOSITION METHOD As previously reported, in Deutsch-Jozsa's algorithm the gate is prepared with first n qubits set to |0> and qubit n+1 set to |1>. Since superposition block is constituted by H [symbol] H [symbol] . . . [symbol] H=ⁿH, the output vector Y can be represented in the following way:

Y=[y₁y₂ . . . yᵢ . . . y₂ⁿ⁺¹]

Where yᵢ=(−1)ⁱ⁺¹/2^{(n+1)/2}.
Different considerations have to be done for Shor's algorithm, summarized in FIG. 46. According to the method of designing quantum gates of this invention, the process of FIG. 47 should be carried out.

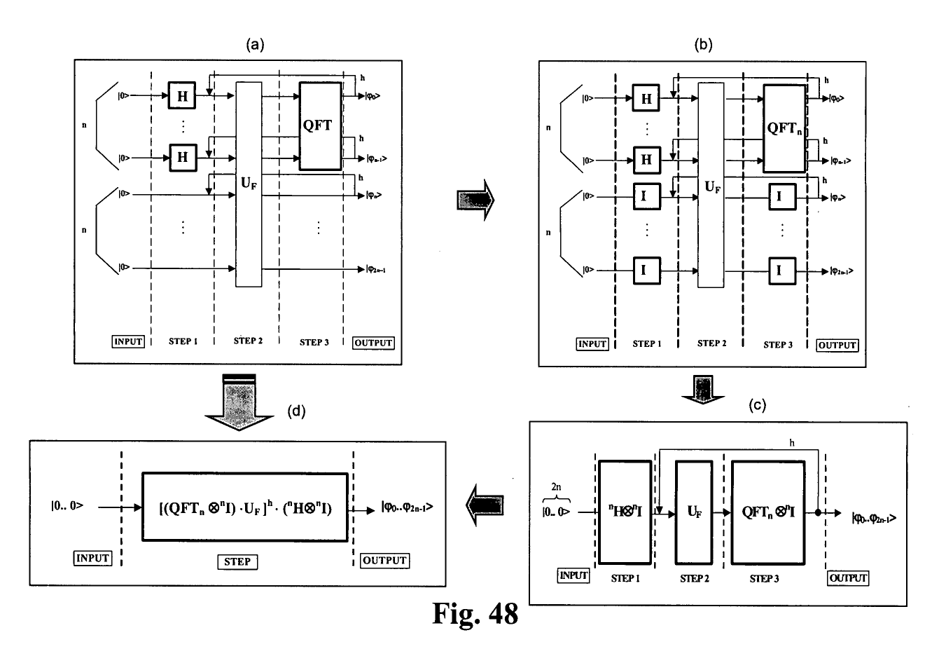

The scheme of Shor's algorithm is illustrated in FIG. 48. In fact, even if all of 2n qubits are more easily set to |0>, in this case superposition block is ⁿH [symbol] ⁿI. This fact means that first n qubits have to be multiplied for ⁿH and second ones for ⁿI. Regarding the first ones, it has still been shown how the operation H|0> [symbol] H|022 [symbol] H|0> can be performed neglecting the constant factor 1/2^{3/2} (n=3)

$$[ \begin{matrix}1 \\ 1\end{matrix} ] [ \begin{matrix}1 \\ 1\end{matrix} ] ⊗ [ \begin{matrix}1 \\ 1\end{matrix} ] = {[ \begin{matrix}1 & 1 & 1 & 1 & 1 & 1 & 1 & 1\end{matrix} ]}^{T}$$

In general, this vector can be indicated in the following way

X=[x₁x₂ . . . xᵢ . . . x₂n]

Where xᵢ=1/2^{n/2}.
Finally, Y=X [symbol] ⁿI|0..0> that, for n=3, results

$$\frac{1}{{2}^{3 / 2}} \cdot {[ \begin{matrix}1 & 1 & 1 & 1 & 1 & 1 & 1 & 1\end{matrix} ]}^{T} ⊗ {[ \begin{matrix}1 & 0 & 0 & 0 & 0 & 0 & 0 & 0\end{matrix} ]}^{T}$$

It is now simple to find a general form for output Y:

$${y}_{i} = \{ \begin{matrix}\frac{1}{{2}^{n / 2}} & if i = 1 + {2}^{n} ( j - 1 ) \\ 0 & elsewhere\end{matrix} \\ with j = 1 … {2}^{n} , i = 1 … {2}^{2 n} .$$

In hardware these values can be easily generated by a CPLD by setting the number n of qubits.

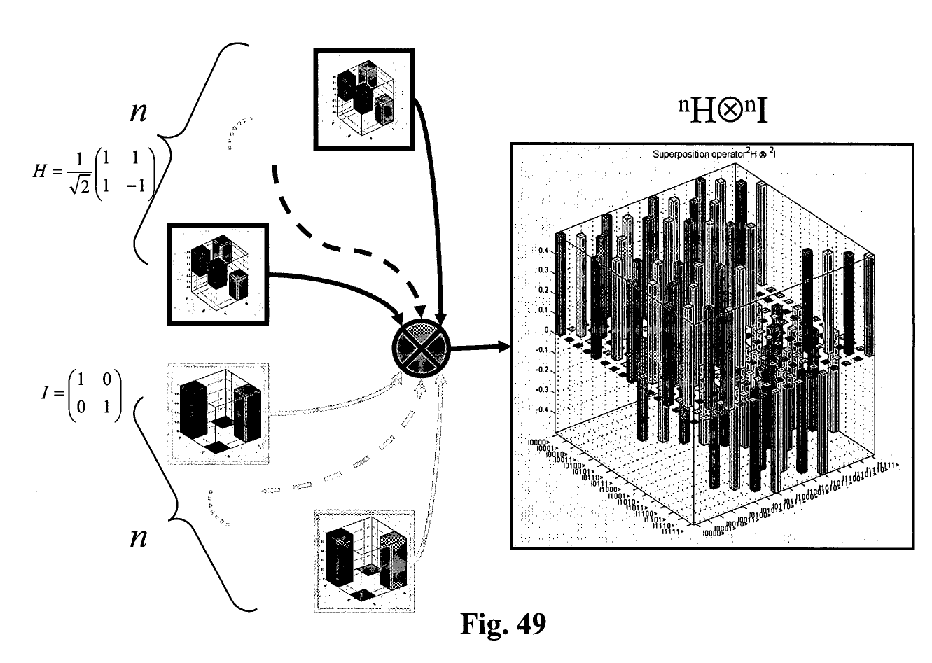

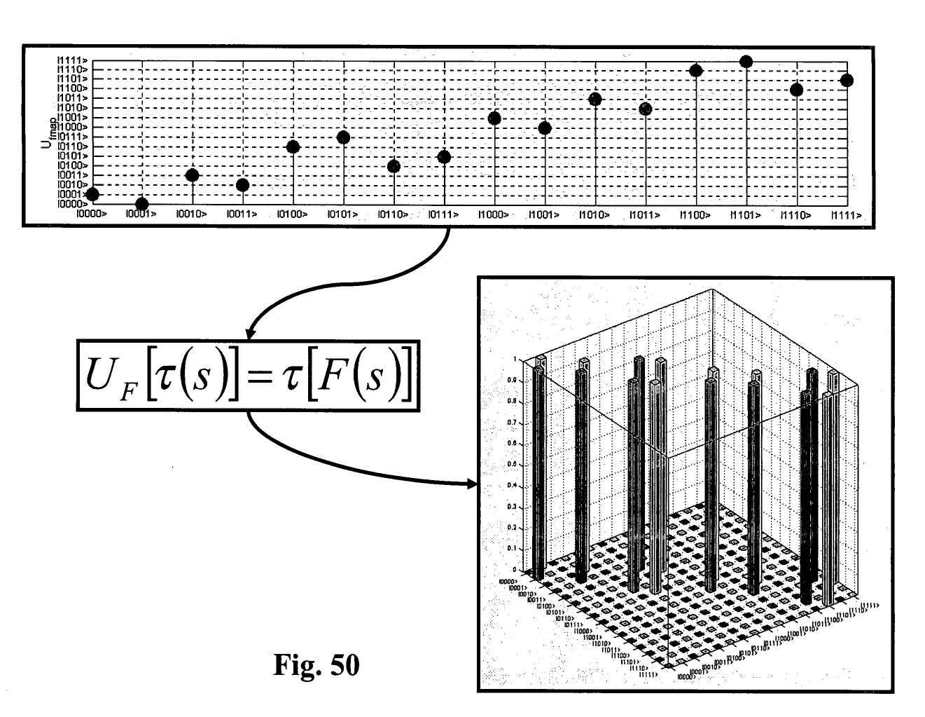

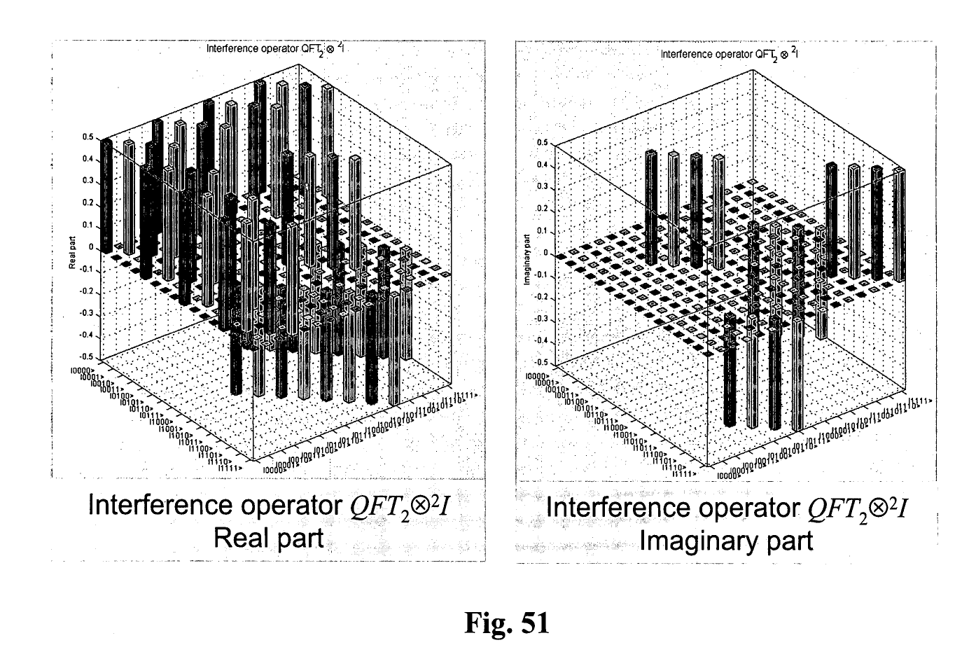

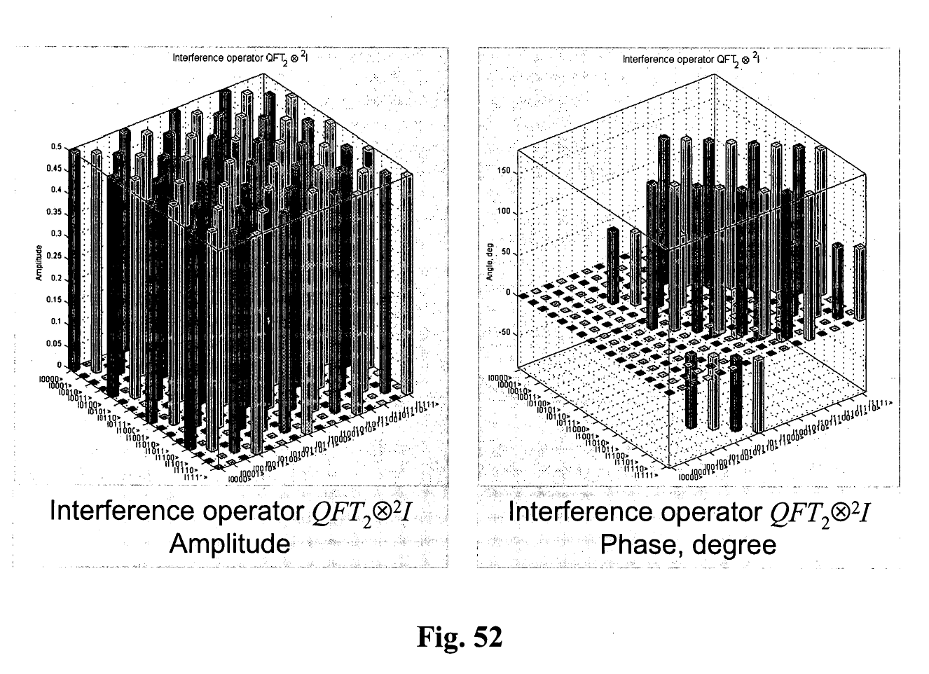

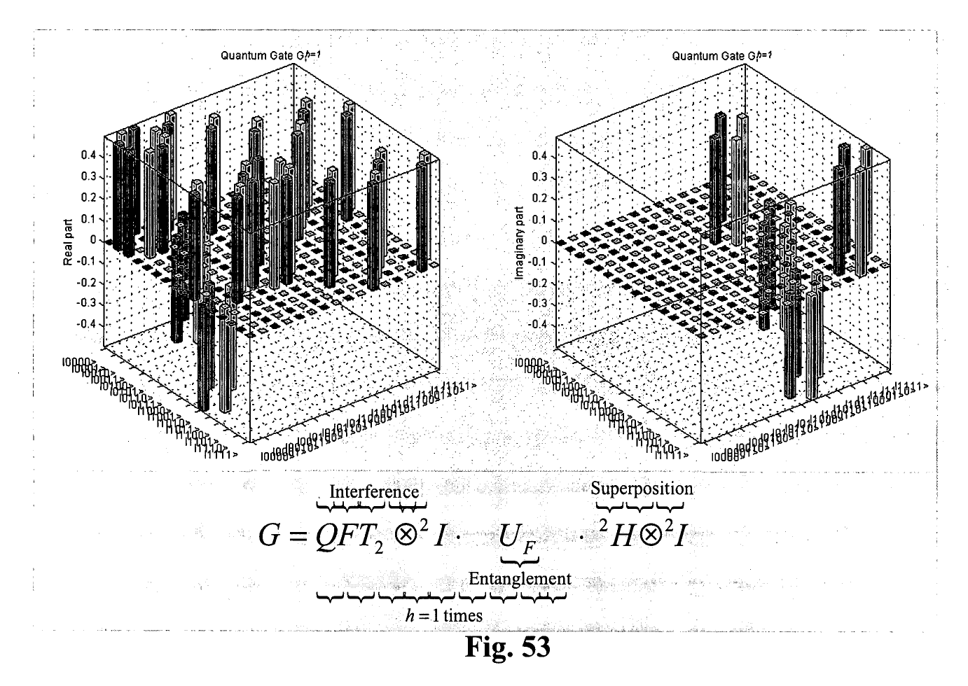

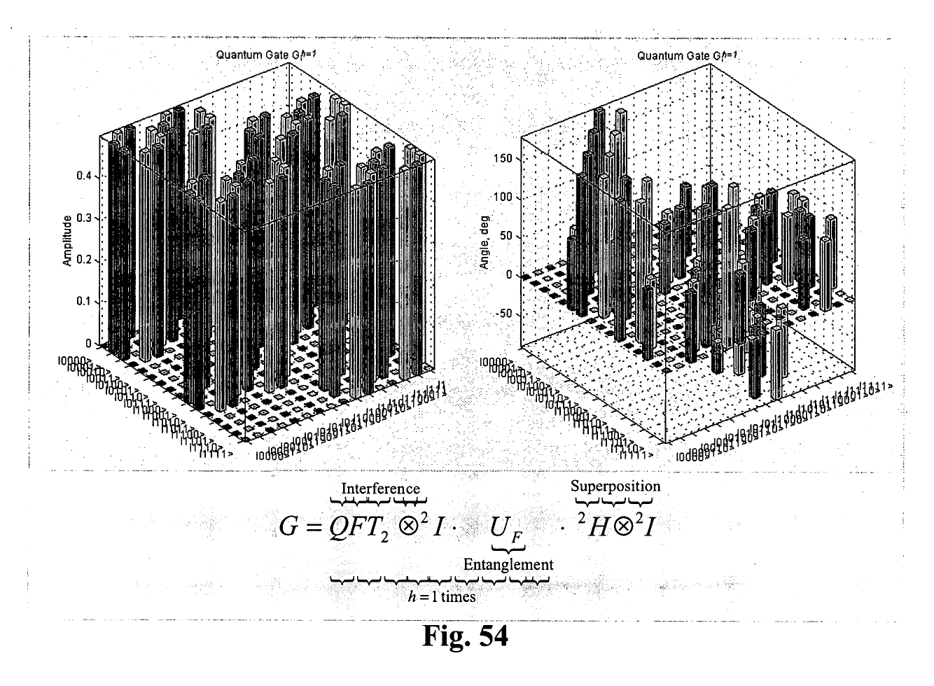

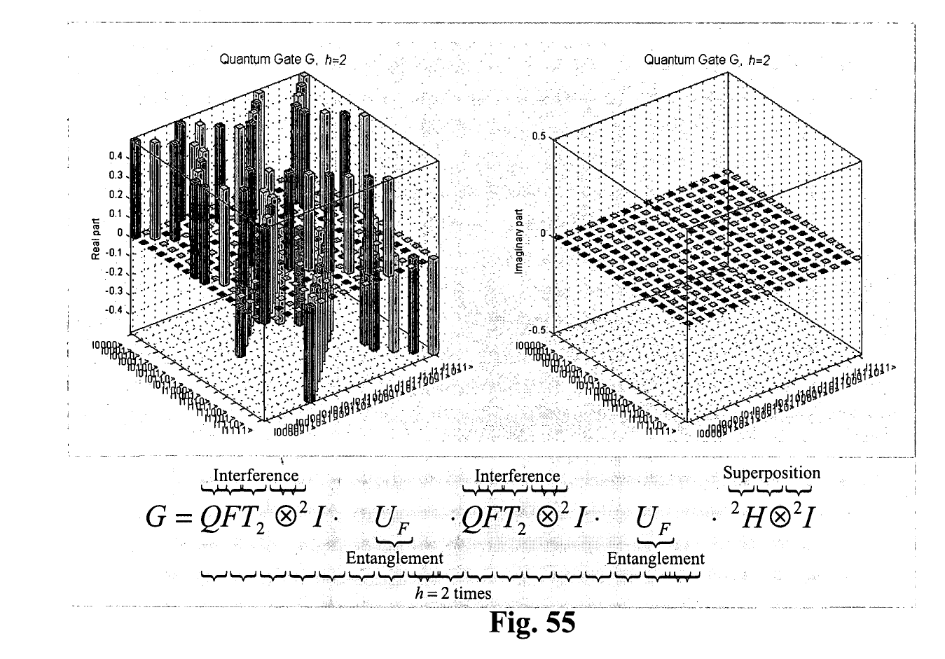

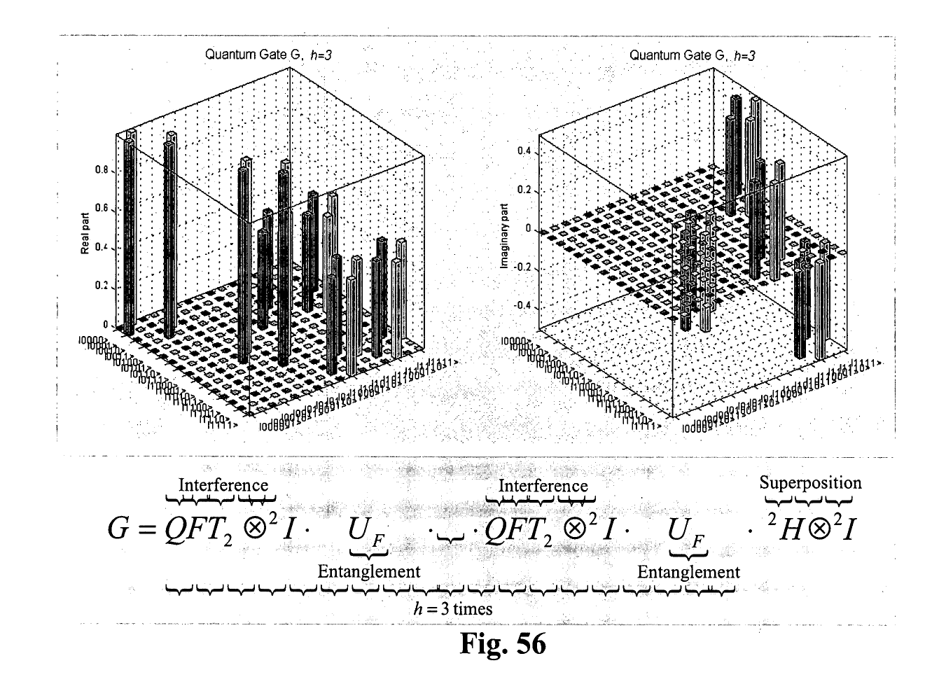

The superposition, entanglement and interference operators are prepared according to step 1 of FIG. 47, as summarized in FIGS. 49 to 52 by way of an example. The corresponding Shor's quantum gate is illustrated in FIGS. 53 to 56.

B. ENTANGLEMENT METHOD In this section considerations for the Entanglement block of Shor's algorithm are presented. Being f: {0,1}ⁿ→{0,1}ⁿ, the size of each block of U_{F} increases with n, becoming each time different and not immediately predictable in its structure. However, some interesting comments may help us in passing from f directly to output of U_{F}.

The general form of f in Shor's algorithm is the following:

f(x)=a^{x}modN

where N is the number to factorize, a is one of its coprimes and x can assume values from 0 to N−1. Number of qubits is n=[log₂N]+1. Each block Mᵢ of U_{F} results from n tensor products among I or C. So for n=2 the four possible blocks are I [symbol] I, I [symbol] C C [symbol] I C [symbol] C, and for n=3, the eight possible blocks are I [symbol] I, I [symbol] C, I [symbol] I, I [symbol] C, C [symbol] I, C [symbol] C, C [symbol] I, C [symbol] C and so on. These sequences are related with the binary representation of f(x), if we associate each “0” with I and each “1” with C. This fact allows the use of a 2ⁿ×2ⁿ matrices instead of a 2²ⁿ×2²ⁿ that is the size U_{F}. Moreover, Mᵢ are symmetric and unitary, so a lot of space can be spared in hardware storage.

Another comment relates to the particular form of superposition that have nonzero element in a predictable position. This means that we can obtain output of Entanglement G=U_{F}·Y without the calculated matrix product, but only with knowledge of a corresponding row of diagonal U_{F} matrix. More in detail, we observe that only a first row of each 2ⁿ×2ⁿ block of entanglement contribute to this output vector meaning a strong reduction of computation complexity. In addition we can easily calculate this rows that have the only nonzero element of each block in position f(xⱼ)+1. Finally we can write output vector G:

$${g}_{i} = \{ \begin{matrix}\frac{1}{{2}^{n / 2}} & if i = f ( {x}_{j} ) + 1 + {2}^{n} ( j - 1 ) \\ 0 & elsewhere\end{matrix} \\ with j = 1 … {2}^{n} , i = 1 … {2}^{2 n} {x}_{j} = j .$$

C. INTERFERENCE METHOD A more difficult task is to deal with interference. In fact, different from Entanglement, vectors are not composed by elements having only two possible values. Moreover, the presence of tensor products, whose number increases dramatically with the dimensions, constitutes an important point at this step. In the European patent application EP 1 429 284 a suitable input-output relation is found by exploiting some particular properties of matrix QFTₙ [symbol] ⁿI.

Unlike the other quantum algorithms, the interference in the Shor's algorithm is carried out using Quantum Fourier Transformation (QFT). As all other quantum operators, QFT is a unitary operator, acting on the complex vectors of the Hilbert space. QFT transforms each input vector into a superposition of the basis vectors of the same amplitude, but with the shifted phase.

Let us consider the output G of the entanglement block.

G=└g₁,g₂, . . . , gᵢ, . . . , g₂_{²ⁿ}┘

The Interference matrix QFTₙ [symbol] ⁿI has several nonzero elements. More exactly, it has 2ⁿ(2ⁿ−1) zeros on each column. In order to avoid trivial products, some modification can be made. Y is the interference output vector, its elements yᵢ are:

$$Re [ {y}_{i} ] = {\sum }_{j = 1}^{{2}^{n}} {g}_{( i mod {2}^{n} ) + {2}^{n} ( j - 1 ) + 1} cos ( 2 π \frac{( j - 1 ) ( int ( ( i - 1 ) / {2}^{n} ) )}{{2}^{n}} )$$

$$Im [ {y}_{i} ] = {\sum }_{j = 1}^{{2}^{n}} {g}_{( i mod {2}^{n} ) + {2}^{n} ( j - 1 ) + 1} sin ( 2 π \frac{( j - 1 ) ( int ( ( i - 1 ) / {2}^{n} ) )}{{2}^{n}} ) ,$$

where int(.) is a function returning the integer part of a real number. The final output vector is therefore the following: Y=[Re[yᵢ]+jIm[yᵢ]].

4.4. Grover's Algorithm Grover's algorithm is described here as a variation on Deutsch-Jozsa's algorithm introduced above. Grover's problem is so stated:

| | |
|---|---|
| Input | A function f: {0, 1}ⁿ→{0, 1} such |
| | that |
| | [symbol] xε{0, 1}ⁿ: |
| | (f(x) = 1 [symbol] ∀yε{0, 1}ⁿ:x ≠ y [symbol] f(y) = 0) |
| Problem | Find x |

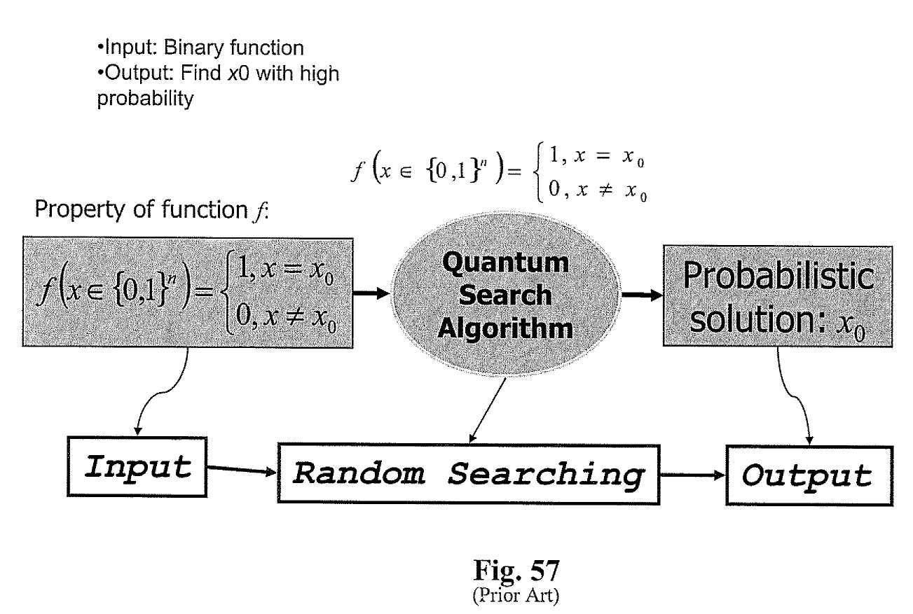

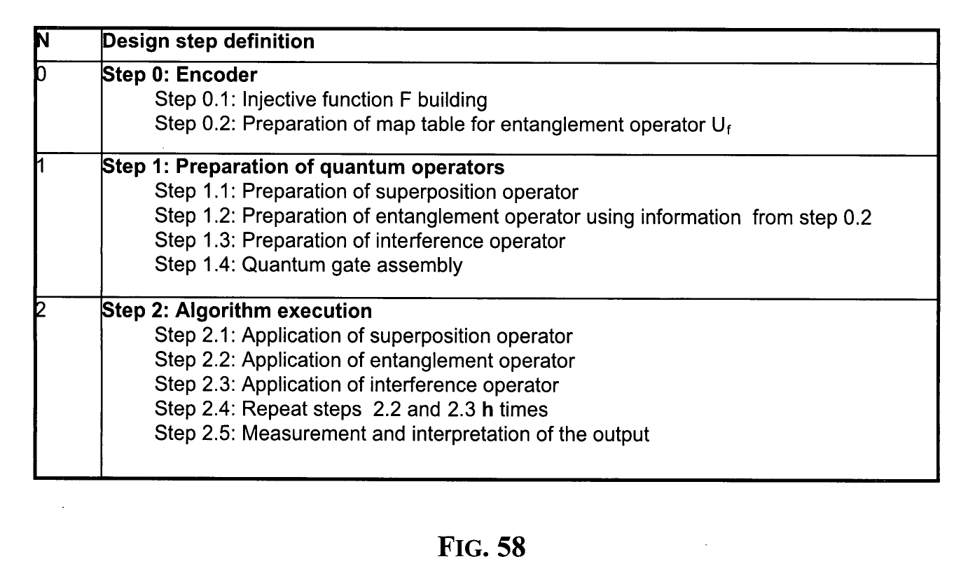

FIG. 57 shows the definition of the Grover's problem.

In Deutsch-Jozsa's algorithm we distinguished two classes of input functions and we were supposed to decide what class the input function belonged to. In this case, the problem is in some sense identical in its form even if it is harder because now we are dealing with 2ⁿ classes of input functions (each function of the kind described constitutes a class).

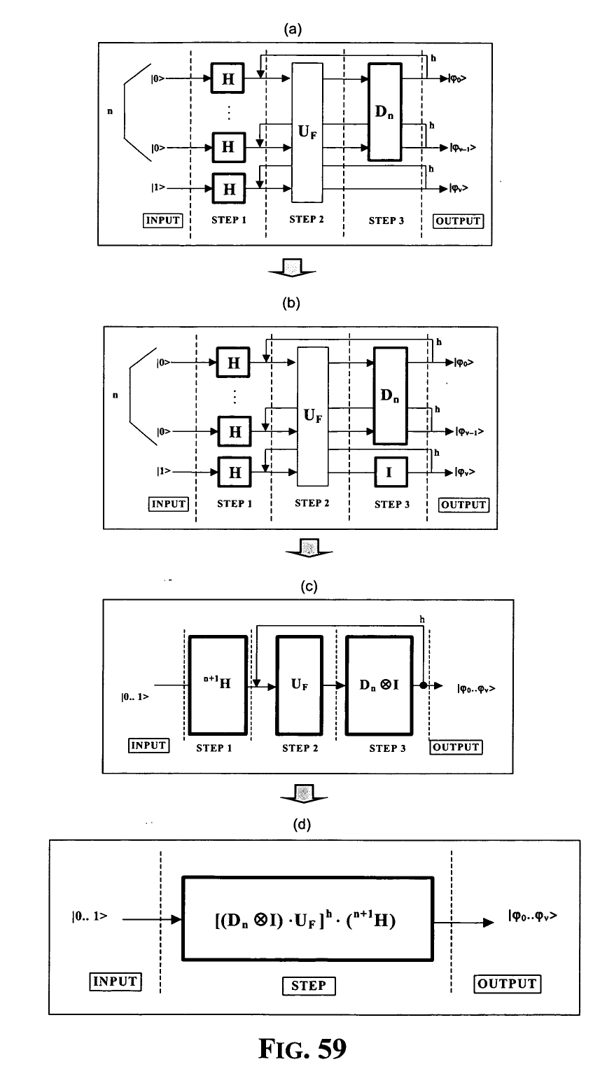

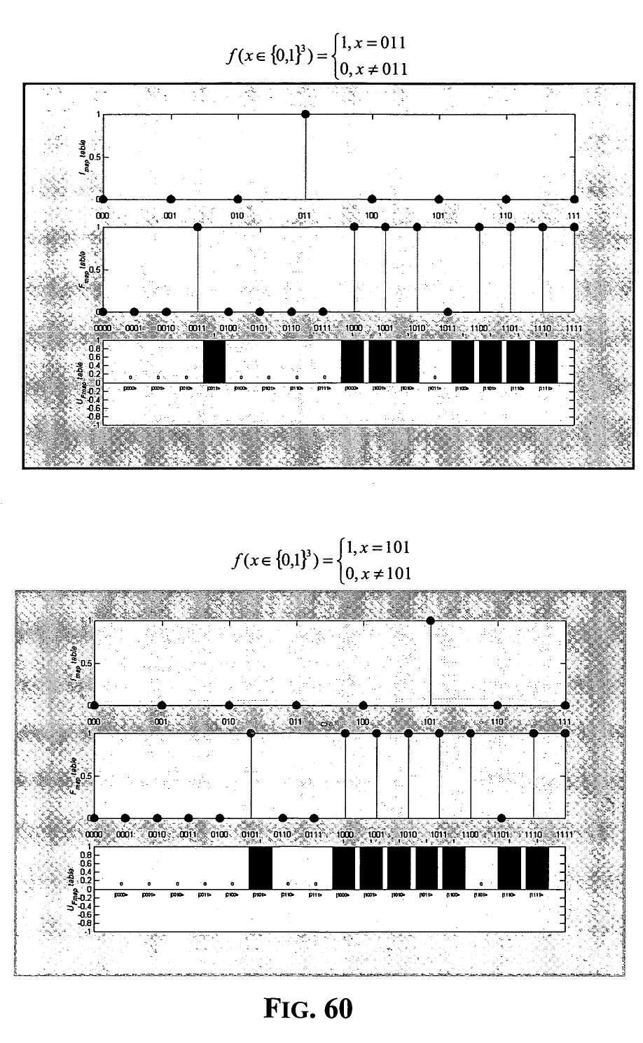

FIG. 58 shows step design definitions in Grover's QA according to the method of this invention, and FIG. 59 shows how to obtain the corresponding gate. Grover's algorithm is well known in the art and thus it will not be described herein. A thorough presentation of the Grover's algorithm may be found in WO1/67186, EP 1 267 304, EP 1 380 991 and EP 1 383 078.

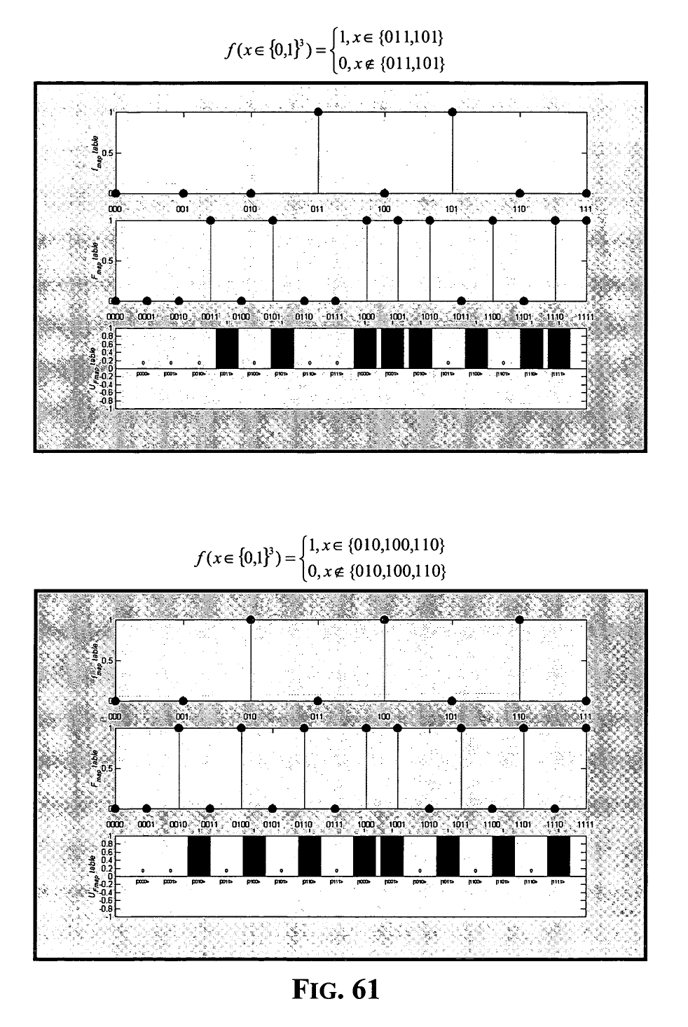

4.4.1. Computer design process of Grover's quantum algorithm gate (Gr-QAG) and simulation results Let us consider the design process of Gr-QAG according to steps represented in FIG. 58. Step 0 as encoding process for the case of order n=3 and answer search 1 in FIG. 60 is described. For comparison the similar results for the cases of order n=3 and answer search 2 and 3 in FIG. 61 is shown.

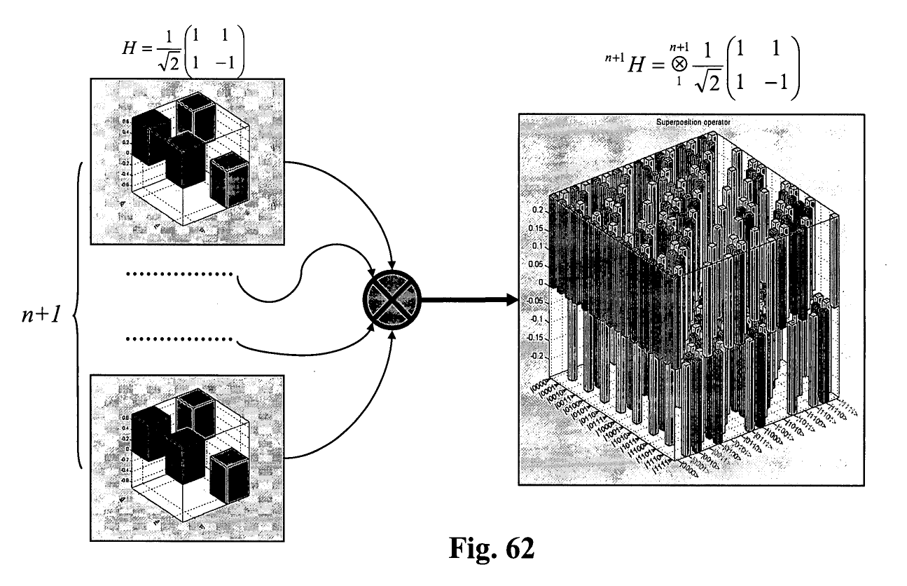

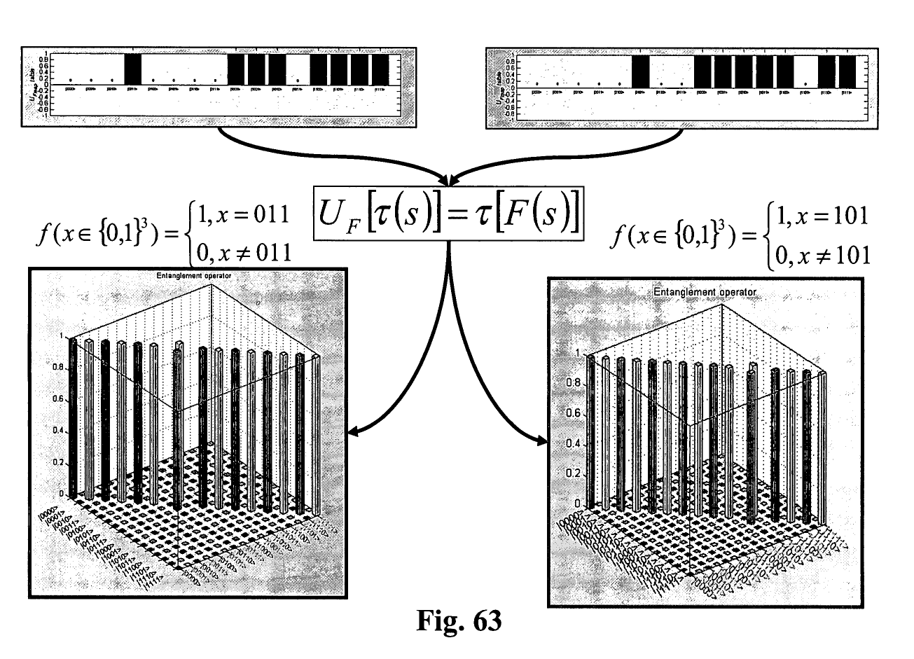

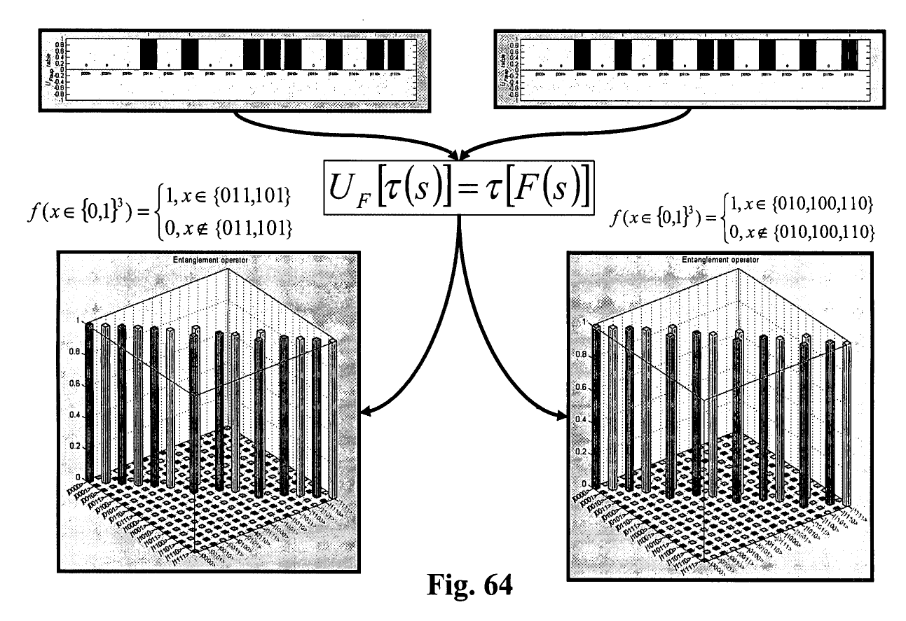

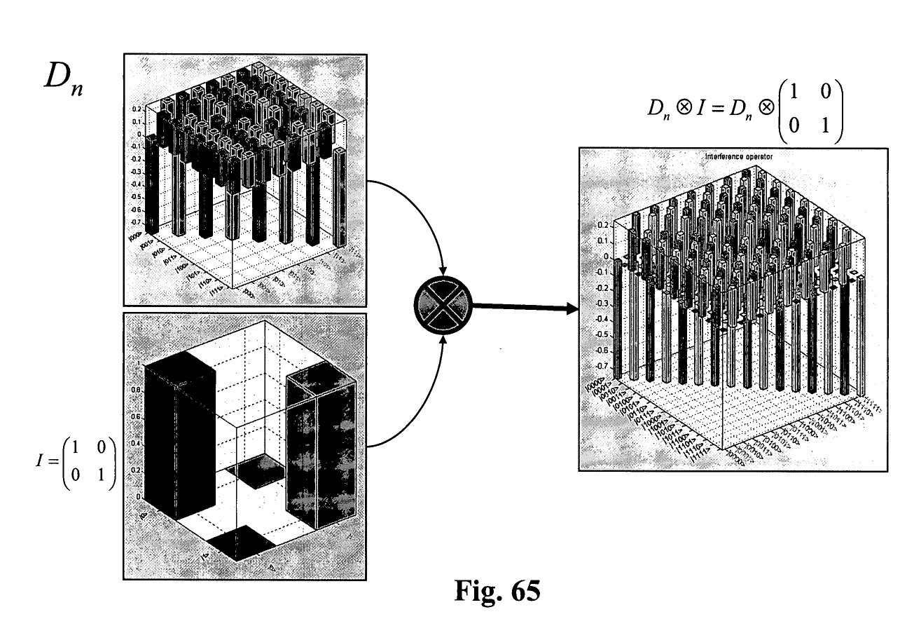

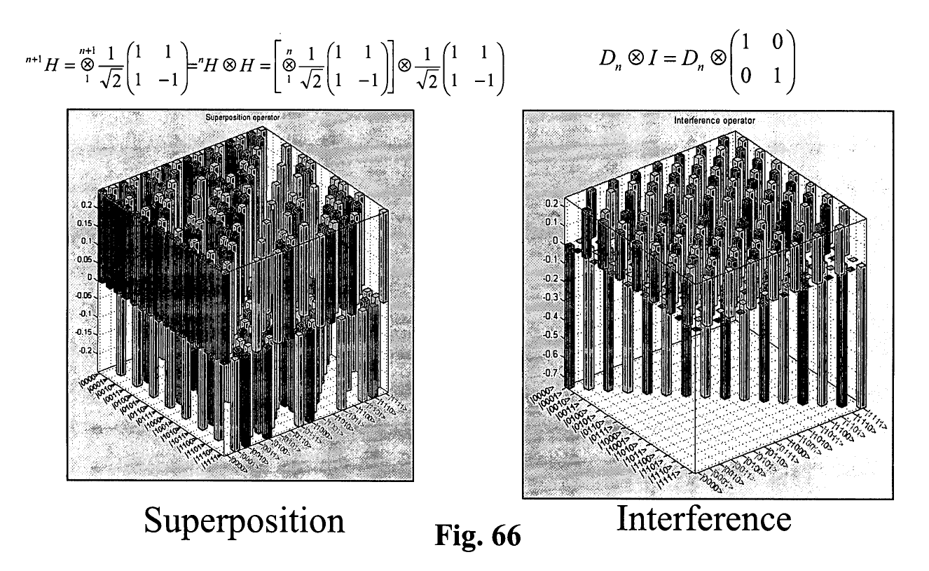

Step 1.1 (from FIG. 58) for design of superposition operator in FIG. 62 is shown. Preparation of quantum entanglement (step 1.2) for the one answer search is shown in FIG. 63. The cases for 2 and 3 answer search the preparation of entanglement operator in FIG. 64 is shown. FIG. 65 shows the result of interference operator design (step 1.3). Comparison between superposition and interference operators in Gr-QAG in FIG. 66 is shown.

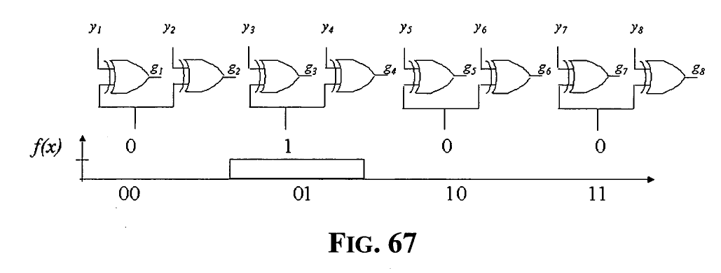

The superposition, entanglement and interference operators are assembled as shown hereinbefore for the Deutsch-Jozsa's quantum algorithm. Similarly for the Deutsch-Jozsa's quantum algorithm, also the entanglement operation of a Grover's quantum algorithm may be implemented by means of XOR logic gates, as shown in FIG. 67.

4.4.2. Interpretation of measurement results in simulation of Grover's QSA-QG. In the case of Grover's QSA, this task is achieved (according to the results of this section) by preparing the ancilla qubit of the oracle of the transformation:

U_{f}:|x,a [symbol] [symbol] x,f(x)⊕a

[symbol]

in the state

$$\vert {a}_{0} 〉 = \frac{1}{\sqrt{2}} ( \vert 0 〉 - \vert 1 〉 ) .$$

In this case the operator I_{|x}₀ [symbol] is computationally equivalent to U_{f}:

$$\begin{matrix}{U}_{f} [ \vert x 〉 ⊗ \frac{1}{\sqrt{2}} ( \vert 0 〉 - \vert 1 〉 ) ] = [ {I}_{\vert {x}_{0} 〉} ( \vert x 〉 ) ] ⊗ \frac{1}{\sqrt{2}} ( \vert 0 〉 - \vert 1 〉 ) \\ = \frac{1}{\sqrt{2}} \underbrace{[ {I}_{\vert {x}_{0} 〉} ( \vert x 〉 ) ]}_{Computation Result} \underbrace{\vert 0 〉}_{Measurement} - \\ \frac{1}{\sqrt{2}} \underbrace{[ {I}_{\vert {x}_{0} 〉} ( \vert x 〉 ) ]}_{Computation Result} \underbrace{\vert 1 〉}_{Measurement}\end{matrix}$$

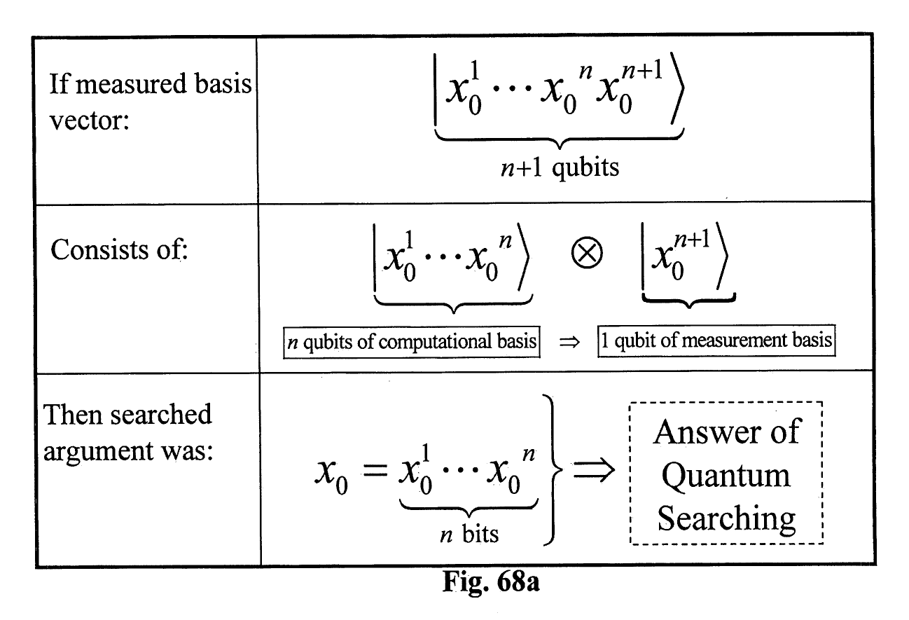

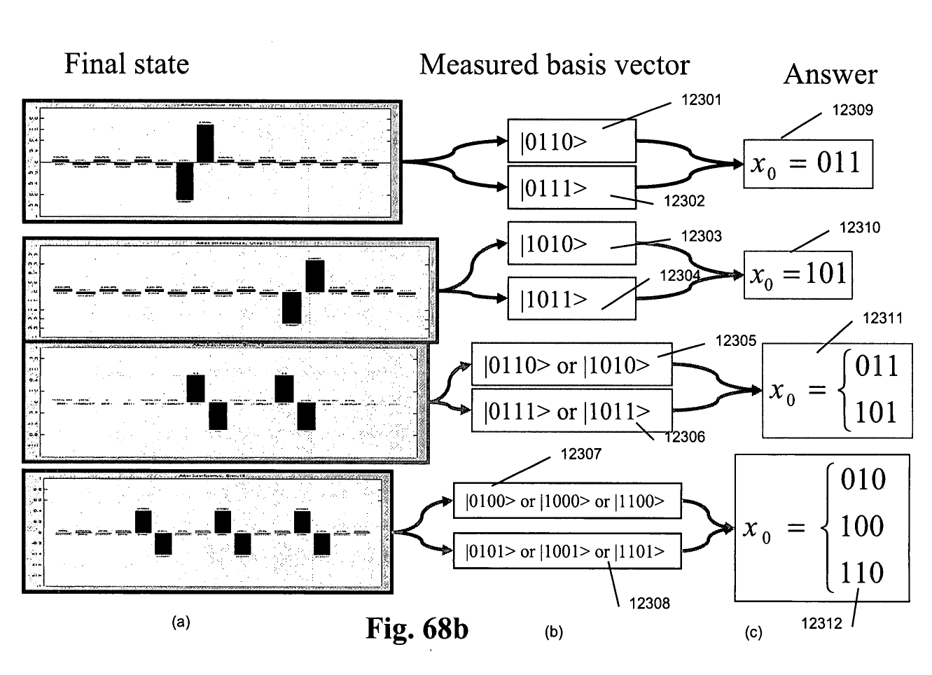

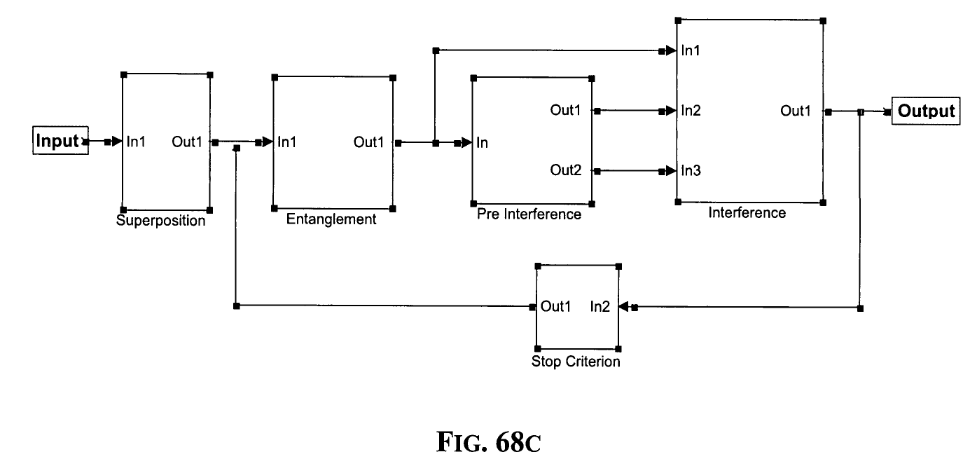

and the operator U_{f} is constructed from a controlled I_{|x}_{₀} [symbol] and two one qubit Hadamard transformations. The result interpretation for the Gr-QAG according to general approach in FIG. 68a is shown.

A measured basis vector comprises the tensor product between the computation qubit results and the ancilla measurement qubit. In Grover's searching process, ancilla qubit do not change during the quantum computing.

As abovementioned, operator U_{f}, comprises two Hadamard transformations. The Hadamard transformation H (that modeling the constructive interference) applied on the state of the standard computational basis can be seen as implementing a fair coin tossing. It means that if the matrix

$$H = \frac{1}{\sqrt{2}} ( \begin{matrix}1 & 1 \\ 1 & - 1\end{matrix} )$$

is applied to the states of the standard basis, then H²|0 [symbol] =−|1 [symbol] , H²|1 [symbol] =|0 [symbol] , and therefore H² acts in measurement process of computational result as a NOT-operation, up to the phase sign. In this case the measurement basis separated with the computational basis (according to tensor product). The results of simulation are shown in FIG. 68b. Boxes 12301-12308 are shown the results of computation on classical computer with Gr-QAG.

Example In boxes 12301 and 12302 we obtain two possibilities:

$$\{ \vert 0110 〉 = \underbrace{\vert 011 〉}_{Result} ⊗ \underbrace{\vert 0 〉}_{measurement qubit} \}$$

$$and$$

$$\{ \vert 0111 〉 = \underbrace{\vert 011 〉}_{Result} \underbrace{\vert 1 〉}_{measurement qubit} \} .$$

Boxes 12305 and 12306 demonstrated two searching marked states:

$$\{ \vert 0110 〉 = \vert 0 \; 11 〉 ⊗ \underbrace{\vert 0 〉}_{measurement qubit} or \vert 101 \; 0 〉 = \vert 1 \; 01 〉 ⊗ \underbrace{\vert 0 〉}_{measurement qubit} \}$$

$$and$$

$$

$$\{ \vert 0111 〉 = \vert 011 〉 ⊗ \underbrace{\vert 1 〉}_{measurement qubit} or \vert 1011 〉 = \vert 101 〉 ⊗ \underbrace{\vert 1 〉}_{measurement qubit} \}$$

Using a simple random measurement strategy as a fair coin tossing in measurement basis {|0 [symbol] ,|1 [symbol] } we can independently from the measurement basis result received with the certainty the searching marked states. Boxes 12309-12312 show accurate results of searching corresponding marked states.

Final result of interpretation for Gr-QAG application in FIG. 68a is shown. The measurement results of Gr-QAG application in computation basis {|0 [symbol] ,|1 [symbol] } with implementing a fair coin tossing of measurement in FIG. 68b is shown. FIG. 68b shows that for both possibilities in implementing a fair coin tossing of measurement process the search of answer is successful.

4.4.3. Hardware implementations of the Grover's algorithm are disclosed in EP 1 267 304, EP 1 383 078 and EP 1 380 991. A general scheme of hardware implementing a Grover's quantum algorithm is depicted in FIG. 68c. This scheme is clear to skilled persons and will not describe further.

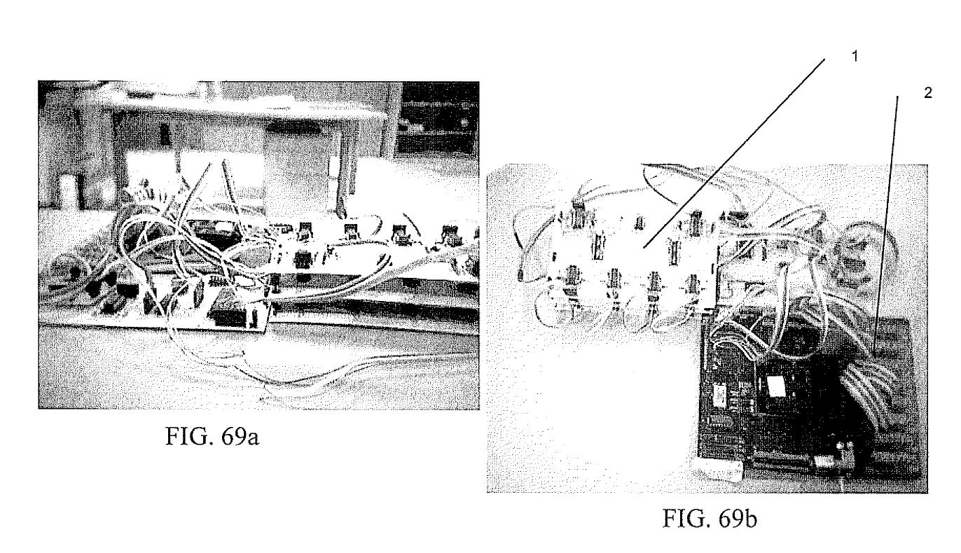

As contemplated by the method of this invention, a hardware quantum gate for any number of qubits may be obtained simply by connecting in parallel a plurality of gates for 2 qubits. As already disclosed in the above mentioned European patent applications and shown in FIG. 69, which depicts a hardware device implementation of a 3-qubit version of Grover's QSA, such a hardware device may be obtained by stacking three identical modules, labeled with the numeral 1 in FIG. 69b and visible in FIG. 69a, and a control board 2.

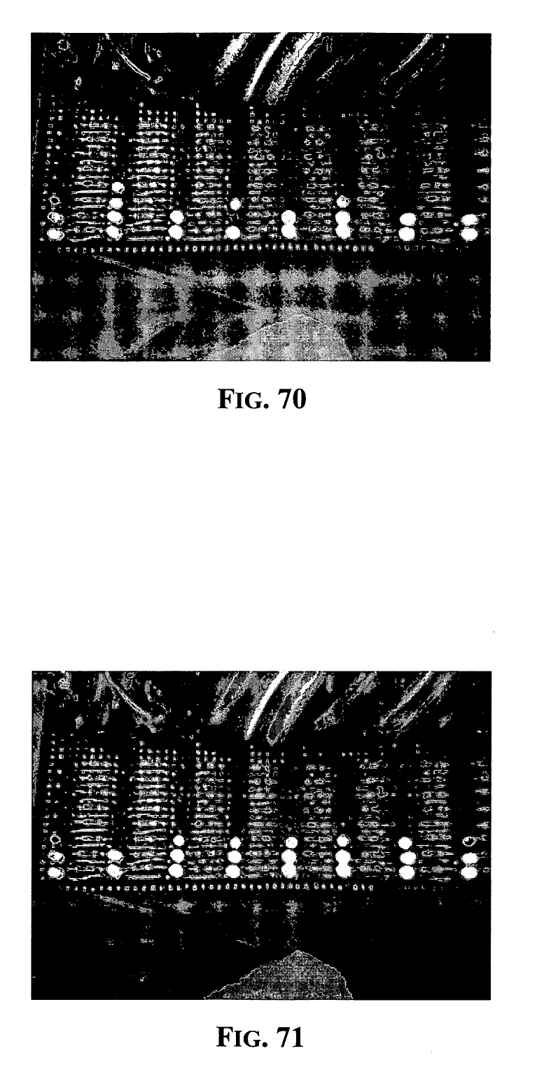

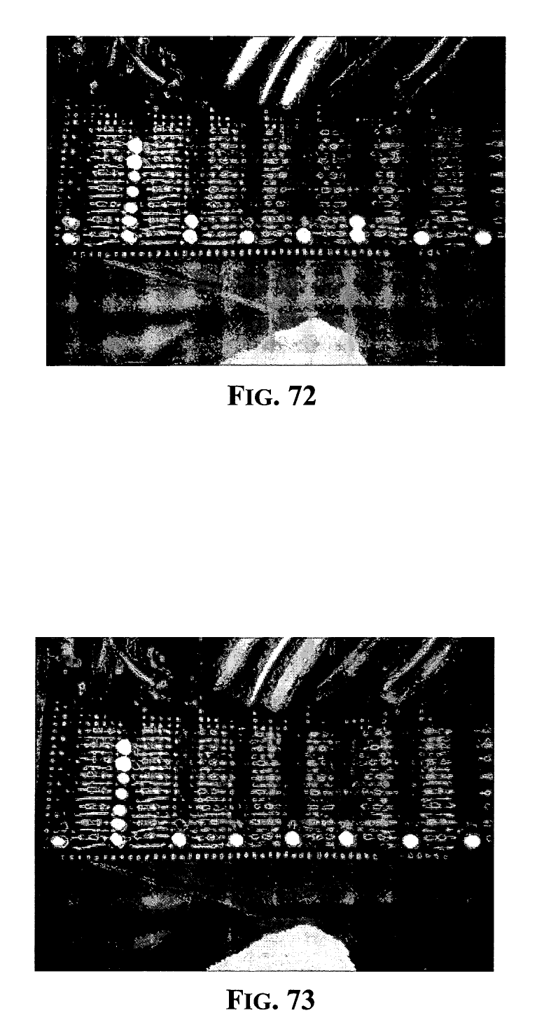

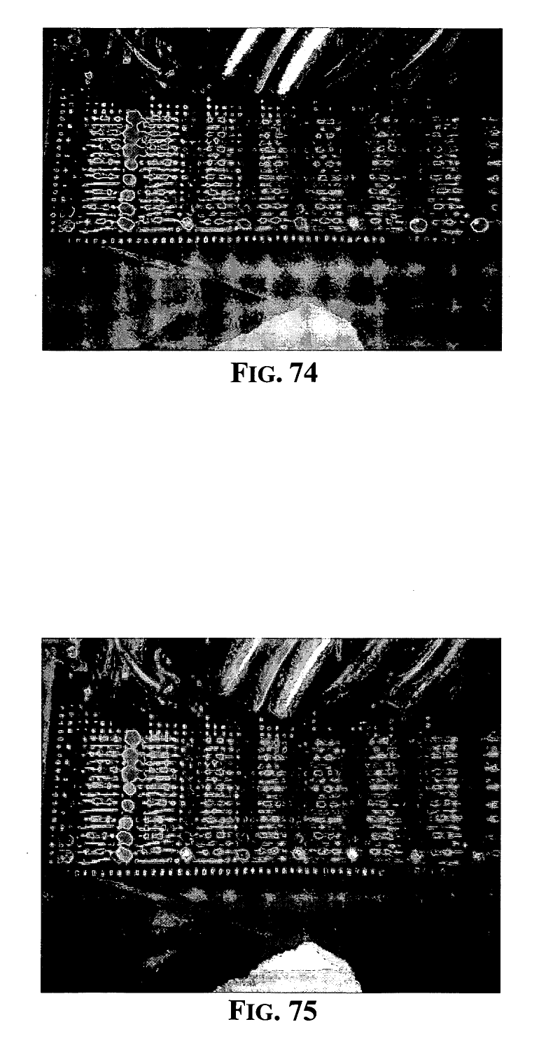

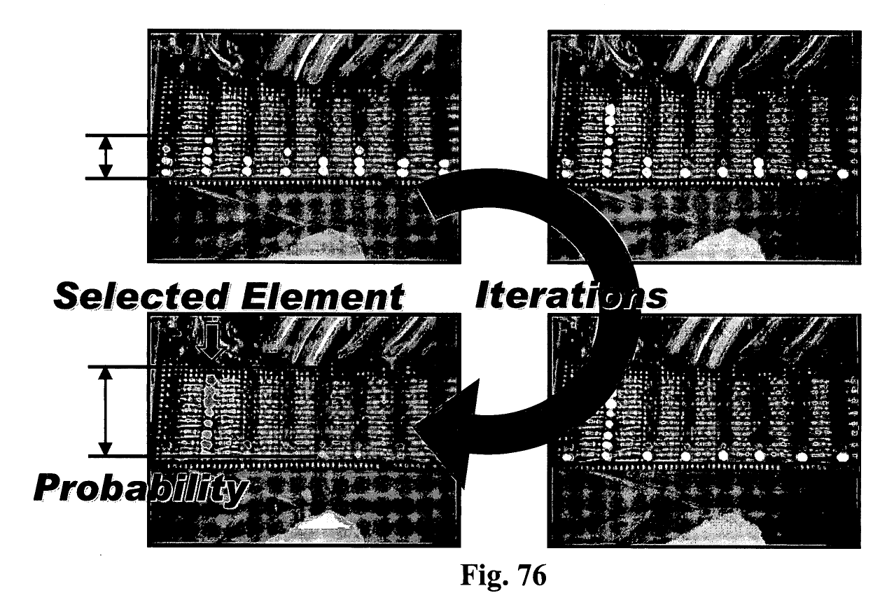

FIGS. 70 to 75 shows the results obtained with the prototype hardware device of FIG. 69. It is evident how the probability of finding a desired item (corresponding to the second column at left in figure) in a database increases at each iteration of the Grover's algorithm. FIG. 76 summarizes the evolution of the state of the device of FIG. 69.

1-39. (canceled)

40. A method for performing a quantum algorithm comprising:
carrying out a superposition operation defined by a superposition operator over initial vectors for generating superposition vectors;
carrying out an entanglement operation defined by an entanglement operator over a combination of the superposition vectors and interference vectors for generating entanglement vectors;
generating third vectors as a function of the entanglement vectors and the interference vectors;
carrying out an interference operation defined by an interference operator over the third vectors for generating the interference vectors;
carrying out a measurement operation over the interference vectors, and repeating the entanglement operation when an algorithm termination condition is met, in which case a result of the quantum algorithm is generated; and
determining at least one item of the group comprising the superposition operator, entanglement operator, interference operator, and third vectors for performing selection operations, crossover operations, and mutation operations according to at least one genetic algorithm for optimizing at least one fitness function.

41. The method according to claim 40 wherein generating the third vectors comprises:
generating fourth vectors by combining the interference vectors with the entanglement vectors; and
processing the fourth vectors with the at least one genetic algorithm.

42. The method according to claim 41 wherein the at least one fitness function is a difference between a Shannon's entropy associated with the third vectors and a Von Neumann's entropy associated with the interference vectors.

43. The method according to claim 40 wherein the at least one genetic algorithm comprises first and second genetic algorithms, and the at least one fitness function comprises first and second fitness functions; and wherein the superposition operators, entanglement operators, and interference operators are determined based upon the first genetic algorithm for optimizing the first fitness function, while the third vectors are generated based upon the second genetic algorithm for optimizing the second fitness function.

44. The method according to claim 41 wherein the fourth vectors are generated by subtracting the interference vectors from the entanglement vectors.

45. The method according to claim 40 wherein the interference operation comprises a Quantum Fast Fourier Transform.

46. The method according to claim 40 further comprising modifying at least one of the superposition operators, entanglement operators, and interference operators based upon the at least one genetic algorithm after a corresponding operation has been performed.

47. The method according to claim 45 further comprising performing a quantum genetic search algorithm over a set of initial vectors by performing the following:
choosing the at least one fitness function;
defining properties of the at least one fitness function with a look-up table; and
generating an initial set of vectors by coding the properties of the at least one fitness function with vectors.

48. The method according to claim 40 further comprising performing the quantum algorithm to generate a control signal for producing a corresponding output signal by performing the following:
generating the control signal for the process as a function of a difference between a reference signal and the output signal, and as a function of a parameter adjustment signal;
generating a control information signal with a quantum soft computing optimization algorithm over the output signal; and
generating a parameter setting signal according to a fuzzy control algorithm as a function of the control information signal and a difference between the reference signal and the output signal.

49. The method according to claim 48 further comprising supplying the process with a random signal.

50. The method according to claim 40 wherein the superposition operation or the interference operation defined by a certain superposition matrix or interference matrix, respectively, of a quantum algorithm over a first set of vectors for generating a corresponding second set of vectors are carried out by the following:
for each vector of a first set, applying a Walsh Hadamard operator or an identity operator to pairs of qubits of the vector to generate a corresponding pair of qubits; and
generating a vector of a second set by combining generated pairs of qubits of the vector of the second set according to a tensor product rule for obtaining the superposition matrix or interference matrix as a function of the Walsh-Hadamard operator and identity operator.

51. A hardware quantum gate for performing a quantum algorithm comprising:
a superposition subsystem for carrying out a superposition operation defined by a superposition operator over initial signals for generating superposition signals;
an entanglement subsystem for carrying out an entanglement operation defined by an entanglement operator over a combination of the superposition signals and interference signals of the quantum gate for generating corresponding entanglement signals;
a circuit for generating third signals as a function of the entanglement signals and of the interference signals;
an interference subsystem for carrying out an interference operation defined by an interference operator, over the third signals for generating the interference signals;
a measurement subsystem for carrying out a measurement operation over the interference signals according to the quantum algorithm, and for repeating the entanglement operation when an algorithm termination condition is met, in which case an output signal is generated; and
a fifth subsystem for determining at least one item of the group comprising the superposition operator, entanglement operator, interference operator, and third signals for performing selection operations, crossover operations, and mutation operations according to at least one genetic algorithm for optimizing at least one fitness function.

52. The hardware quantum gate according to claim 51 wherein the at least one genetic algorithm comprises first and genetic second algorithms, and the at least one fitness function comprises first and second fitness functions; and wherein the fifth subsystem comprises a wise controller being input with signals representing a difference between the entanglement signals and the interference signals for generating the third signals with the second genetic algorithm.

53. The hardware quantum gate according to claim 52 wherein the fifth subsystem modifies according to at least one of the first and second genetic algorithms at least one of the superposition operators, entanglement operators, and interference operators after a corresponding operation has been performed.

54. The hardware quantum gate according to claim 51 wherein the interference subsystem performs a Quantum Fast Fourier Transform.

55. The hardware quantum gate according to claim 54 further comprising:
a first subsystem for choosing the at least one fitness function;
a look-up table for defining properties of the at least one fitness function;
a second subsystem for generating initial signals by coding properties of the at least one fitness function; and
an input for receiving the initial signals for generating a result signal corresponding to a result of a quantum genetic search algorithm.

56. The hardware quantum gate according to claim 55 further comprising:
a control device of a process driven by a control signal for producing a corresponding output signal;
a classical controller for generating the control signal as a function of a signal representing a difference between a reference signal and an output signal of the process, and as a function of a parameter adjustment signal;
a quantum soft computing optimizer for generating a control information signal with a quantum soft computing optimization algorithm over the output signal;
a fuzzy controller being input with the control information signal and the signal representing a difference between the reference signal and the output signal to generate the parameter adjustment signal according to a fuzzy control algorithm; and
said quantum soft computing optimizer comprising a neural network being input with a teaching signal to generate the control information signal, and being input with the output signal and performing a quantum genetic search algorithm over the output signal to generate a teaching signal for a neural network.

57. The hardware quantum gate according to claim 52 wherein at least one of the superposition subsystem and interference subsystem for performing a superposition or interference operation defined by a certain superposition matrix or interference matrix, respectively, of a quantum algorithm over input signals representing first vectors for generating output signals of corresponding second vectors comprises:
at least a Walsh-Hadamard gate and an identity gate for performing the Walsh-Hadamard operator and the identity operator, respectively, over signals representing a pair of qubits of the first vector to generate third signals corresponding to a respective pair of qubits of the second vector; and
said Walsh-Hadamard and identity gates being interconnected to combine the third signals corresponding to a respective pair of qubits for obtaining signals representing the second vector according to a tensor product rule for obtaining the superposition matrix or interference matrix as a function of the Walsh-Hadamard operator and the identity operator.

58. The hardware quantum gate according to claim 57 further comprising a digital subsystem being input with the interference signals, and outputting a signal representing a result of the quantum algorithm when a termination condition is met, or directing the interference signals as an input to the entanglement subsystem when the termination condition is met.

59. A method for performing a genetic algorithm comprising:
choosing a fitness function to be maximized or minimized;
defining a condition for stopping the genetic algorithm when verified;
choosing an initial set of bit-strings;
iteratively performing the following
calculating the fitness function for each bit-string of a current set,
checking whether the stopping condition is verified and in that case stopping the genetic algorithm, otherwise carrying out selection, crossover and mutation operations over a subset of the current set of bit-strings for generating a new set of bit-strings to be processed;
encoding each bit-string of the current set with a corresponding tensor product of qubits;
performing the selection, crossover and mutation operations using the superposition, entanglement and interference operators of the quantum algorithm as defined by the following
the superposition operation defined by a superposition operator over initial vectors for generating superposition vectors,
the entanglement operation defined by an entanglement operator over a combination of the superposition vectors and interference vectors for generating entanglement vectors, and
the interference operation defined by an interference operator over the third vectors generating the interference vectors, with the third vectors being generated as a function of the entanglement vectors and the interference vectors;
the operation of calculating the fitness function for each bit-string being performed by carrying out a measurement operation according to the quantum algorithm; and
the stopping condition being defined by a corresponding condition for terminating the quantum algorithm.

60. The method according to claim 59 wherein each of the bit-strings is encoded in a corresponding tensor product of qubits by performing the following:
encoding each bit of a bit-string with a vector representing a superposition of two qubits; and
generating the corresponding tensor product of qubits by calculating the tensor product of all the vectors encoding the bits of the bit-string.

61. The method according to claim 60 wherein a bit 0 is encoded with a vector corresponding to
$$\frac{1}{\sqrt{2}} ( \vert 0 〉 + \vert 1 〉 )$$
and a bit 1 with a vector corresponding to
$$\frac{1}{\sqrt{2}} ( \vert 0 〉 - \vert 1 〉 ) .$$

62. The method according to claim 61 wherein the mutation operation comprises:
selecting one of the tensor product of qubits;
randomly selecting one of the qubits of the tensor product of qubits; and
exchanging between them the pair of probability amplitude of the chosen qubit.

63. The method according to claim 59 wherein the crossover operation comprises:
randomly selecting two bit-strings of the set;
exchanging between them their fitness functions;
updating the two bit-strings according to their new fitness functions at least once; and
exchanging back their fitness functions.

64. The method according to claim 59 further comprising:
encoding each bit-string with a tensor product of a first quantum individual and a null qubit;
applying unitary operators to the tensor product for generating an initial population of qubits for the genetic algorithm;
applying a unitary operator encoding the fitness function to the initial population, generating a set of tensor products between one of the quantum individual and a second quantum individual that encodes a corresponding value of the fitness function;
performing the measurement operation for calculating the value of the fitness function; and
selecting a subset of the tensor products depending on the corresponding values of the fitness function.

65. A method for performing a superposition or interference operation defined by a certain superposition or interference matrix, respectively, of a quantum algorithm over a first set of vectors for generating a corresponding second set of vectors, the method comprising:
for each vector of the first set, applying a Walsh-Hadamard operator or an identity operator to pairs of qubits of the vector for generating a corresponding pair of qubits; and
generating a vector of the second set by combining the generated pairs of qubits of the vector of the second set according to the tensor product rule for obtaining the superposition or interference matrix as a function of the Walsh-Hadamard and identity operators.

66. A hardware subsystem of a quantum gate for performing a superposition or interference operation defined by a certain superposition or interference matrix, respectively, of a quantum algorithm over input signals representing a first set of vectors for generating output signals of a corresponding second set of vectors, the hardware subsystem comprising:
at least a Walsh-Hadamard gate and an identity gate for performing the Walsh-Hadamard and the identity operators, respectively, over signals representing a pair of qubits of a vector of the first set for generating third signals corresponding to a respective pair of qubits of a vector of the second set; and
said Walsh-Hadamard and identity gates being interconnected to combine the third signals corresponding to a respective pair of qubits for obtaining signals representing a vector of the second set according to a tensor product rule for obtaining the superposition or interference matrices as a function of the Walsh-Hadamard and identity operators.

67. A quantum gate for running quantum algorithms using a certain binary function defined on a space having a basis of vectors of n of qubits and encoded into a unitary matrix, comprising:
a superposition subsystem carrying out a superposition operation over components of input vectors for generating components of linear superposition vectors referred on a second basis of vectors of n+1 qubits;
an entanglement subsystem carrying out an entanglement operation over components of the linear superposition vectors for generating components of entanglement vectors; and
an interference subsystem carrying out an interference operation over components of the entanglement vectors for generating components of output vectors;
said entanglement subsystem comprising
a PROM memory being input with signals representing components of a linear superposition vector that are referred to vectors of the second basis having the first n qubits in common, outputting, for each superposition vector, corresponding signals representing components of an entanglement vector, and
said PROM memory comprising cells organized in a square matrix having a number of rows equal to a number of components of a superposition vector, only the cells of said PROM corresponding to non-zero components of the unitary matrix being programmed, said PROM memory generating the signals representing components of an entanglement vector by leaving unchanged or by flipping pairs of signals representing components of a linear superposition vector.

68. A method for performing a genetic algorithm comprising:
choosing an initial population ({ψⱼ⁽⁰⁾(x)}) comprising a pre-established number of wave functions;
choosing a certain fitness function (E[ψⱼ^{(i)]}) to be maximized or minimized;
defining a condition for stopping the algorithm when verified;
iteratively performing the following operations:
a) calculating the fitness function of all the wave functions;
b) checking whether the stopping condition is verified and in that case stopping the algorithm, otherwise creating a new population of wave functions by carrying out selection, crossover and mutation operations over a subset of the current population of wave functions and restarting from step a).

69. The method according to claim 68 wherein the selection operation is performed by using as a fitness function the following expectation function:
$$E [ ψ ] = \frac{〈 ψ \vert \hat{H} \vert ψ 〉}{〈 ψ \vert ψ 〉}$$
wherein ψ(x) is a wave function of the initial population and Ĥ is a Hamiltonian appropriate to perform a desired selection operation.

70. The method according to claim 68 wherein the wave functions are Gaussian-like functions.

71. The method according to claim 68 wherein the crossover operator is defined by the following equations:
ψ₁⁽ⁿ⁺¹⁾(x)=ψ₁⁽ⁿ⁾(x)·St(x)·St(x)+ψ₂⁽ⁿ⁾(x)·(1−St(x))
ψ₂⁽ⁿ⁺¹⁾(x)=ψ₂⁽ⁿ⁾(x)·St(x)+ψ₁⁽ⁿ⁾(x)·(1−St(x))
where St(x) is a smooth step function, ψⱼ⁽ⁿ⁾(x) is a generic wave function at a step n of the genetic algorithm and ψⱼ⁽ⁿ⁺¹⁾(x) is a generic wave function at a step n+1;
the mutation operator being defined by the following equation:
ψ₁⁽ⁿ⁺¹⁾(x)=ψ₁⁽ⁿ⁾(x)+ψᵣ(x)
wherein ψᵣ(x) is a random wave function; and further comprising normalizing every newly generated wave function.
